(19) United States
(12) Patent Application Publication
(10) Pub. No.: US 2006/0252073 A1
(43) Pub. Date: Nov. 9, 2006

(54) Compositions and methods for the treatment of cancer

(75) Inventors: Omer H. Yilmaz, Ann Arbor, MI (US); Sean J. Morrison, Ann Arbor, MI (US)

Correspondence Address: Medlen & Carroll, LLP;Suite 350, 101 Howard Street, San Francisco, CA, 94105, US

(73) Assignee: Regents of the University of Michigan, Ann Arbor, MI (US)

(21) Appl. No.: 11/397,974

(22) Filed: Apr. 5, 2006

Related U.S. Application Data
(60) Provisional application No. 60/672,446, filed on Apr. 18, 2005.
(60) Provisional application No. 60/741,731, filed on Dec. 2, 2005.

(51) Int. Cl. C40B 30/06

(52) U.S. Cl. 435/6; 435/7.23

(57) ABSTRACT

The present invention relates to cancer diagnostics and to compositions and methods for the identification of cancer therapeutics. In particular, the present invention provides compositions and methods for identifying therapeutic compounds that alter (e.g., eliminate or inhibit growth of) cancer stem cells without harming (e.g., that maintain (e.g., push into quiescence)) normal stem cells (e.g., in the same tissues). The present invention also provides compositions and methods for killing cancer stem cells and cancer cells.

This application claims priority to U.S. Provisional Patent Application Nos. 60/672,446, filed Apr. 18, 2005, and 60/741,731, filed Dec. 2, 2005, each of which is hereby incorporated by reference in its entirety.

### FIELD OF THE INVENTION

The present invention relates to cancer diagnostics and to compositions and methods for the identification of cancer therapeutics. In particular, the present invention provides compositions and methods for identifying therapeutic compounds that alter (e.g., eliminate or inhibit growth of) cancer stem cells without harming (e.g., that maintain (e.g., push into quiescence)) normal stem cells (e.g., in the same tissues). The present invention also provides compositions and methods for killing cancer stem cells and cancer cells.

### BACKGROUND OF THE INVENTION

Cancer remains the number two cause of mortality in the United States, resulting in over 500,000 deaths per year. Despite advances in detection and treatment, cancer mortality remains high. Furthermore, even with the remarkable progress in understanding the molecular basis of cancer, this knowledge has yet to be translated into effective therapeutic strategies.

A new area of research has emerged around cancer stem cells. Cancer stem cell self-renewal appears to be regulated by similar pathways as normal stem cells (e.g., Bmi-1 promotes the self-renewal of both normal and cancer stem cells, while p16Ink4a inhibits both). Therefore, although the hope exists to identify therapeutic targets in cancer stem cells, there exists great concern that anything that will treat (e.g., kill or inhibit growth of) a cancer stem cell will have the same effect on normal stem cells from the same tissue (e.g., causing harm to a subject). This is particularly important in tissues in which normal stem cell activity is acutely required for survival. For example, the destruction of normal hematopoietic stem cells leads to the death of patients within weeks.

Traditional modes of cancer therapy (radiation therapy, chemotherapy, and hormonal therapy) have been limited by the emergence of treatment-resistant cancer cells. Thus, new approaches are needed to identify targets for treating cancer (e.g., leukemia, lymphomas and solid tumor cancers). Specifically, therapeutic agents are needed that are capable of targeting (e.g., killing or inhibiting growth of) cancer stem cells without detriment to the compartment of normal stem cells. Additionally, assays that target the differences between cancer stem cells and normal stem cells are needed that can identify new families of anti-cancer drugs.

### SUMMARY OF THE INVENTION

The present invention relates to cancer diagnostics and to compositions and methods for the identification of cancer therapeutics. In particular, the present invention provides compositions and methods for identifying therapeutic compounds that alter (e.g., eliminate or inhibit growth of) cancer stem cells without harming (e.g., that maintain (e.g., push into quiescence)) normal stem cells (e.g., in the same tissues). The present invention also provides compositions and methods for killing cancer stem cells and cancer cells.

Accordingly, in some embodiments, the present invention provides a method of identifying a test compound useful for treating cancer comprising providing cancer stem cells and normal hematopoietic stem cells (HSCs); administering a test compound to the stem cells; monitoring the response of the stem cells to the test compound; and identifying a test compound that alters cancer stem cells without harming normal HSCs. In some embodiments, altering the cancer stem cells comprises inhibiting proliferation of the cancer stem cells. In some embodiments, altering cancer stem cells comprises inhibiting survival of the cancer stem cells. In some embodiments, monitoring the response of the stem cells comprises monitoring growth of the stem cells. In some embodiments, monitoring the response of the stem cells comprises monitoring stem cell activity. In some embodiments, monitoring the response of the stem cells comprises monitoring gene expression in the stem cells. In some embodiments, monitoring gene expression identifies a cancer stem cell biomarker. In some embodiments, monitoring gene expression comprises use of a microarray. In some embodiments, monitoring gene expression comprises measuring mRNA. In some embodiments, monitoring the response of the stem cells comprises monitoring protein expression and/or activity in the stem cells. In some embodiments, monitoring protein expression and/or activity in the stem cells comprises use of an antibody. In some embodiments, monitoring the response of the stem cells comprises monitoring cellular pathways. In some embodiments, monitoring cellular pathways comprises measuring the activity of the pathways. In some embodiments, the growth of the stem cells is monitored in vitro. In some embodiments, the growth of the stem cells is monitored in vivo in a subject. The present invention is not limited by the type of subject or sample (e.g., harvested cancer stem cells) monitored. Indeed, a variety of subjects are contemplated for monitoring in the present invention including, but not limited to, humans, non-human primates, rodents, and the like. In some embodiments, the test compound is one of a library of test compounds. The present invention is not limited by the type of test compound assayed. Indeed a variety of test compounds can be analyzed by the present invention including, but not limited to, any chemical entity, pharmaceutical, drug, known and potential therapeutic compounds, small molecule inhibitors, pharmaceuticals, a test compound from a combinatorial library (e.g., a biological library; peptoid library, spatially addressable parallel solid phase or solution phase library; synthetic library (e.g., using deconvolution or affinity chromatography selection), and the like. Examples of test compounds useful in the present invention include, but are not limited to, carbohydrates, monosaccharides, oligosaccharides, polysaccharides, amino acids, peptides, oligopeptides, polypeptides, proteins, nucleosides, nucleotides, oligonucleotides, polynucleotides, including DNA and DNA fragments, RNA and RNA fragments and the like, lipids, retinoids, steroids, glycopeptides, glycoproteins, proteoglycans and the like, and synthetic analogues or derivatives thereof, including peptidomimetics, small molecule organic compounds and the like, and mixtures thereof.

In some embodiments, the cancer stem cells and the hematopoietic stem cells are present within the same tissue.

The present invention also provides a method of identifying a test compound with anti-cancer properties comprising monitoring the test compound's ability to alter hematopoietic stem cell cycle progression. In some embodiments, the test compound induces hematopoietic stem cells to enter the G0 phase of the cell cycle.

The present invention also provides an anti-cancer therapeutic that promotes the maintenance of normal stem cells via inhibiting pathways that promote transition from G0 to G1 phase of the cell cycle.

The present invention also provides a method of treating a subject comprising administering to the subject a composition that eliminates cancer stem cells while concurrently inhibiting the proliferation of hematopoietic stem cells.

The present invention also provides a method of identifying a test compound useful for treating cancer comprising: providing cancer cells (e.g., tumorigenic cells, leukemogenic cells, cancer stem cells, or cancer cells that are not tumorigenic, leukemogenic or cancer stem cells (e.g., stromal cells)), and normal stem cells; administering the test compound to the cancer cells and normal stem cells; monitoring the response of the cells to the test compound; and identifying a test compound that alters the cancer cells without harming the normal stem cells. In some embodiments, altering the cancer cells comprises inhibiting proliferation of the cancer cells. In some embodiments, altering the cancer cells comprises inhibiting survival of the cancer cells. In some embodiments, monitoring the response of the stem cells comprises monitoring the proliferation of the stem cells. In some embodiments, monitoring the response of the cells comprises monitoring the survival of the stem cells. In some embodiments, monitoring the response of the cells comprises monitoring the cell cycle status of the normal stem cells. In some embodiments, monitoring the response of the cells comprises monitoring gene expression in the cancer cells. In some embodiments, monitoring gene expression identifies a cancer stem cell biomarker. In some embodiments, the cancer cells are tumorigenic cancer cells. In some embodiments, the cancer cells are leukemogenic cancer cells. In some embodiments, the cancer cells are cancer stem cells.

The present invention also provides a method of identifying a test compound useful for treating cancer comprising: providing cancer stem cells and normal stem cells; administering the test compound to the cancer stem cells and normal stem cells; monitoring the response of the cells to the test compound; and identifying a test compound that alters cancer stem cells without harming normal stem cells.

The present invention also provides a method of identifying a test compound useful for treating cancer comprising: providing normal adult stem cells; administering the test compound to the normal adult stem cells; monitoring the response of the cells to the test compound; and identifying a test compound that inhibits the ability of the adult stem cells to exit G0 phase of the cell cycle. In some embodiments, the test compound also inhibits the proliferation and/or survival of cancer stem cells. In some embodiments, the test compound inhibits signaling through a mitogenic pathway. In some embodiments, the test compound inhibits signaling through the PI-3 kinase pathway. In some embodiments, the test compound inhibits signaling by mTor. In some embodiments, the test compound is rapamycin. In some embodiments, the test compound is a rapamycin analogue.

The present invention also provides a method of identifying a test compound useful for treating cancer comprising: providing cancer stem cells and normal stem cells; administering the test compound to the cancer stem cells and normal stem cells; monitoring the response of the cells to the test compound; and identifying a test compound that alters cancer stem cells without harming normal stem cells.

The present invention also provides a method of identifying a test compound useful for treating cancer comprising: providing normal adult stem cells; administering the test compound to the normal adult stem cells; monitoring the response of the cells to the test compound; and identifying a test compound that inhibits the ability of the adult stem cells to exit G0 phase of the cell cycle. In some embodiments, the test compound also inhibits the proliferation and/or survival of cancer stem cells. In some embodiments, the test compound inhibits signaling through a mitogenic pathway. In some embodiments, the test compound inhibits signaling through the PI-3 kinase pathway. In some embodiments, the test compound inhibits signaling by mTor. In some embodiments, the test compound is rapamycin. In some embodiments, the test compound is a rapamycin analogue.

### DESCRIPTION OF THE DRAWINGS

FIG. 1 shows two models of solid tumor heterogeneity. In the classic model (FIG. 1A), mutations or environmental differences cause tumor cells to adopt a variety of different phenotypes. Many cells with a variety of different phenotypes are thought to have the potential to proliferate extensively and form new tumors. The cancer stem cell model (FIG. 1B) is distinguished by having only a minor population of cancer cells that are tumorigenic. These cancer stem cells are characterized by indefinite proliferative potential, the ability to form new tumors, the ability to self-renew (generating expanded numbers of cancer stem cells), and the ability to give rise to heterogeneous non-tumorigenic cancer cells that typically form the bulk of a tumor.

FIG. 2 shows Pten conditionally deleted from 6-8 week old Pten^{fl/fl} Mx-1-Cre mice.

FIG. 3 shows that Pten deletion leads to myeloproliferative disease and leukemia.

FIG. 4 shows that Pten deletion leads to myeloproliferative disease and leukemia.

FIG. 5 shows the transplantation of whole bone marrow cells, whole splenocytes, Flk-2⁻Sca-1⁺Lin⁻CD48⁻ckit⁺ HSCs, Mac-1⁺B220⁻CD3⁻ myeloid cells, or CD3⁺Mac-1⁻/B220⁺Mac-1⁻ lymphoid cells into recipient mice.

FIG. 6 shows that HSCs proliferate after Pten deletion, then become depleted.

FIG. 7 shows that Pten is required cell-autonomously for HSC maintenance.

FIG. 8 shows that recipients of^{fl/fl} Mx-1-Cre bone marrow cells began dying with AML and ALL starting at 6 weeks after transplantation.

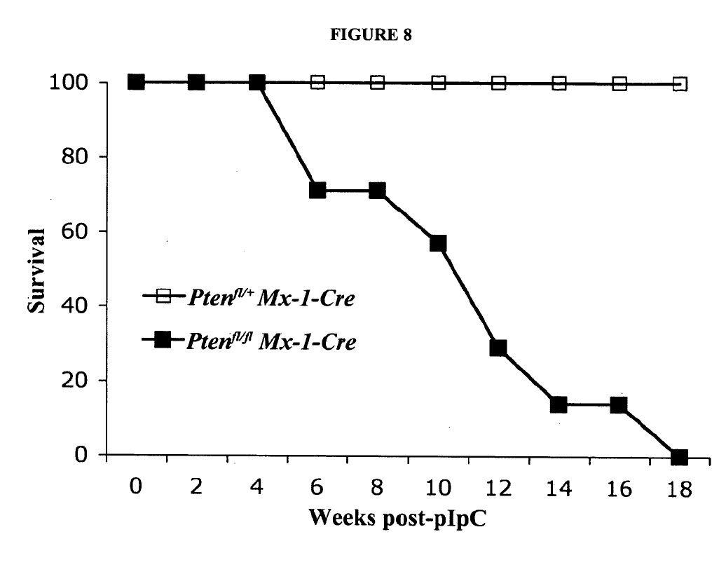

FIG. 9 shows that rapamycin depletes leukemia-initiating cells.

FIG. 10 shows that rapamycin reduced the frequency of AML blast cells that formed colonies in methylcellulose, the size of those colonies, and the percentage of cultured blast cells in S phase of the cell cycle.

FIG. 11 shows that rapamycin rescues normal HSC function after Pten deletion.

FIG. 12 shows that an increase in cell death by Annexin V or activated caspase-3 staining was not detected in either whole bone marrow cells or Flk2⁻Sca-1⁺Lin⁻c-kit⁺CD48⁻ cells from Pten^{fl/fl}Mx-1-Cre mice four weeks after pIpC treatment.

FIG. 13 shows that approximately 90% of single Flk2⁻Sca-1⁺Lin⁻c-kit⁺CD48⁻ cells from either Pten-deleted mice or control mice formed colonies in methylcellulose whether they were isolated 5 days or 4 weeks after pIpC treatment.

### DEFINITIONS

As used herein, the term “immunoglobulin” or “antibody” refer to proteins that bind a specific antigen. Immunoglobulins include, but are not limited to, polyclonal, monoclonal, chimeric, and humanized antibodies, Fab fragments, F(ab′)₂ fragments, and includes immunoglobulins of the following classes: IgG, IgA, IgM, IgD, IbE, and secreted immunoglobulins (sIg). Immunoglobulins generally comprise two identical heavy chains and two light chains. However, the terms “antibody” and “immunoglobulin” also encompass single chain antibodies and two chain antibodies.

As used herein, the term “antigen binding protein” refers to proteins that bind to a specific antigen. “Antigen binding proteins” include, but are not limited to, immunoglobulins, including polyclonal, monoclonal, chimeric, and humanized antibodies; Fab fragments, F(ab′)₂ fragments, and Fab expression libraries; and single chain antibodies.

The term “epitope” as used herein refers to that portion of an antigen that makes contact with a particular immunoglobulin.

When a protein or fragment of a protein is used to immunize a host animal, numerous regions of the protein may induce the production of antibodies which bind specifically to a given region or three-dimensional structure on the protein; these regions or structures are referred to as “antigenic determinants”. An antigenic determinant may compete with the intact antigen (i.e., the “immunogen” used to elicit the immune response) for binding to an antibody.

The terms “specific binding” or “specifically binding” when used in reference to the interaction of an antibody and a protein or peptide means that the interaction is dependent upon the presence of a particular structure (i.e., the antigenic determinant or epitope) on the protein; in other words the antibody is recognizing and binding to a specific protein structure rather than to proteins in general. For example, if an antibody is specific for epitope “A,” the presence of a protein containing epitope A (or free, unlabelled A) in a reaction containing labeled “A” and the antibody will reduce the amount of labeled A bound to the antibody.

As used herein, the terms “non-specific binding” and “background binding” when used in reference to the interaction of an antibody and a protein or peptide refer to an interaction that is not dependent on the presence of a particular structure (i.e., the antibody is binding to proteins in general rather than a particular structure such as an epitope).

As used herein, the term “subject” refers to any animal (e.g., a mammal), including, but not limited to, humans, non-human primates, rodents, and the like (e.g., which is to be the recipient of a particular treatment, or from whom cancer stem cells are harvested). Typically, the terms “subject” and “patient” are used interchangeably, unless indicated otherwise herein.

As used herein, the term “subject is suspected of having cancer” refers to a subject that presents one or more signs or symptoms indicative of a cancer (e.g., a noticeable lump or mass) or is being screened for a cancer (e.g., during a routine physical). A subject suspected of having cancer may also have one or more risk factors. A subject suspected of having cancer has generally not been tested for cancer. However, a “subject suspected of having cancer” encompasses an individual who has received a preliminary diagnosis (e.g., a CT scan showing a mass) but for whom a confirmatory test (e.g., biopsy and/or histology) has not been done or for whom the stage of cancer is not known. The term further includes people who once had cancer (e.g., an individual in remission). A “subject suspected of having cancer” is sometimes diagnosed with cancer and is sometimes found to not have cancer.

As used herein, the term “subject diagnosed with a cancer” refers to a subject who has been tested and found to have cancerous cells. The cancer may be diagnosed using any suitable method, including but not limited to, biopsy, x-ray, blood test, and the diagnostic methods of the present invention. A “preliminary diagnosis” is one based only on visual (e.g., CT scan or the presence of a lump) and antigen tests.

As used herein, the term “initial diagnosis” refers to a test result of initial cancer diagnosis that reveals the presence or absence of cancerous cells (e.g., using a biopsy and histology). An initial diagnosis does not include information about the stage of the cancer or the risk of metastasis.

As used herein, the term “post surgical tumor tissue” refers to cancerous tissue (e.g., from a tissue or organ) that has been removed from a subject (e.g., during surgery).

As used herein, the term “identifying the risk of said tumor metastasizing” refers to the relative risk (e.g., the percent chance or a relative score) of a tumor (e.g., solid tumor tissue) metastasizing.

As used herein, the term “identifying the risk of said tumor recurring” refers to the relative risk (e.g., the percent chance or a relative score) of a tumor (e.g., solid tumor tissue) recurring in the same tissue or location (e.g., organ) as the original tumor (e.g., tissue or organ).

As used herein, the term “subject at risk for cancer” refers to a subject with one or more risk factors for developing a specific cancer. Risk factors include, but are not limited to, gender, age, genetic predisposition, environmental expose, and previous incidents of cancer, preexisting non-cancer diseases, and lifestyle.

As used herein, the term “characterizing cancer in subject” refers to the identification of one or more properties of a cancer sample in a subject, including but not limited to, the presence of benign, pre-cancerous or cancerous tissue and the stage of the cancer. Cancers may be characterized by characterizing cancer stem cells of a subject.

As used herein, the term “cancer cells” refers to individual cells of a cancer. Such cells may include, for example, tumorigenic cells (e.g., capable of generating a tumor), leukemogenic cells (e.g., capable of generating leukemia), cancer stem cells (e.g., capable of forming new tumors or transferring disease upon transplantation into an immunocompromised host), as well as cells that are not tumorigenic, leukemogenic or that are capable of forming new tumors or transferring disease upon transplantation (e.g., mesenchymal and endothelial cells).

As used herein, the term “characterizing cancer stem cells” refers to the identification of one or more properties of cancer stem cells. In some embodiments, cancer stem cells are characterized as a population of cells that is enriched (relative to the unfractionated cancer cell population) for the ability to form new tumors or to transfer disease, such as upon transplantation into immunocompromised mice. In other embodiments, cancer stem cells are characterized by the expression of specific combinations of surface markers that are associated with increased tumorigenic potential, and which are often shared by normal stem cells in the same tissue. In other embodiments cancer stem cells are further characterized by carcinogenic mutations which confer tumorigenic potential, such as Pten deletion.

As used herein, the term “characterizing tissue in a subject” refers to the identification of one or more properties of a tissue sample (e.g., including but not limited to, the presence of cancer stem cells in the tissue).

As used herein, the term “providing a prognosis” refers to providing information regarding the impact of the presence of cancer (e.g., as determined by the diagnostic methods of the present invention) on a subject's future health (e.g., expected morbidity or mortality, the likelihood of getting cancer, and the risk of metastasis).

As used herein, the term “non-human animals” refers to all non-human animals including, but are not limited to, vertebrates such as rodents, non-human primates, ovines, bovines, ruminants, lagomorphs, porcines, caprines, equines, canines, felines, aves, etc.

As used herein, the term “effective amount” refers to the amount of a composition (e.g., a compound that regulate G0/G1 cell cycle transition) sufficient to effect beneficial or desired results. An effective amount can be administered in one or more administrations, applications or dosages and is not intended to be limited to a particular formulation or administration route.

As used herein, the term “administration” refers to the act of giving a drug, prodrug, or other agent, or therapeutic treatment (e.g., compositions of the present invention) to a subject (e.g., a subject or in vivo, in vitro, or ex vivo cells, tissues, and organs). Exemplary routes of administration to the human body can be through the eyes (ophthalmic), mouth (oral), skin (transdermal), nose (nasal), lungs (inhalant), oral mucosa (buccal), ear, by injection (e.g., intravenously, subcutaneously, intratumorally, intraperitoneally, etc.) and the like.

As used herein, the term “co-administration” refers to the administration of at least two agent(s) (e.g., a compound that regulate G0/G1 cell cycle transition and one or more other agents) or therapies to a subject. In some embodiments, the co-administration of two or more agents or therapies is concurrent. In other embodiments, a first agent/therapy is administered prior to a second agent/therapy. Those of skill in the art understand that the formulations and/or routes of administration of the various agents or therapies used may vary. The appropriate dosage for co-administration can be readily determined by one skilled in the art. In some embodiments, when agents or therapies are co-administered, the respective agents or therapies are administered at lower dosages than appropriate for their administration alone. Thus, co-administration is especially desirable in embodiments where the co-administration of the agents or therapies lowers the requisite dosage of a potentially harmful (e.g., toxic) agent(s).

As used herein, the term “toxic” refers to any detrimental or harmful effects on a subject, a cell, or a tissue as compared to the same cell or tissue prior to the administration of the toxicant.

As used herein, the term “pharmaceutical composition” refers to the combination of an active agent (e.g., a compound that regulate G0/G1 cell cycle transition) with a carrier, inert or active, making the composition especially suitable for diagnostic or therapeutic use in vitro, in vivo or ex vivo.

The terms “pharmaceutically acceptable” or “pharmacologically acceptable,” as used herein, refer to compositions that do not substantially produce adverse reactions, e.g., toxic, allergic, or immunological reactions, when administered to a subject.

As used herein, the term “topically” refers to application of the compositions of the present invention to the surface of the skin and mucosal cells and tissues (e.g., alveolar, buccal, lingual, masticatory, or nasal mucosa, and other tissues and cells that line hollow organs or body cavities).

As used herein, the term “pharmaceutically acceptable carrier” refers to any of the standard pharmaceutical carriers including, but not limited to, phosphate buffered saline solution, water, emulsions (e.g., such as an oil/water or water/oil emulsions), and various types of wetting agents, any and all solvents, dispersion media, coatings, sodium lauryl sulfate, isotonic and absorption delaying agents, disintrigrants (e.g., potato starch or sodium starch glycolate), and the like. The compositions also can include stabilizers and preservatives. For examples of carriers, stabilizers and adjuvants. (See e.g., Martin, Remington's Pharmaceutical Sciences, 15th Ed., Mack Publ. Co., Easton, Pa. (1975), incorporated herein by reference).

As used herein, the term “pharmaceutically acceptable salt” refers to any salt (e.g., obtained by reaction with an acid or a base) of a compound of the present invention that is physiologically tolerated in the target subject (e.g., a mammalian subject, and/or in vivo or ex vivo, cells, tissues, or organs). “Salts” of the compounds of the present invention may be derived from inorganic or organic acids and bases. Examples of acids include, but are not limited to, hydrochloric, hydrobromic, sulfuric, nitric, perchloric, fumaric, maleic, phosphoric, glycolic, lactic, salicylic, succinic, toluene-p-sulfonic, tartaric, acetic, citric, methanesulfonic, ethanesulfonic, formic, benzoic, malonic, sulfonic, naphthalene-2-sulfonic, benzenesulfonic acid, and the like. Other acids, such as oxalic, while not in themselves pharmaceutically acceptable, may be employed in the preparation of salts useful as intermediates in obtaining the compounds of the invention and their pharmaceutically acceptable acid addition salts.

Examples of bases include, but are not limited to, alkali metal (e.g., sodium) hydroxides, alkaline earth metal (e.g., magnesium) hydroxides, ammonia, and compounds of formula NW₄+, wherein W is C₁₋₄ alkyl, and the like.

Examples of salts include, but are not limited to: acetate, adipate, alginate, aspartate, benzoate, benzenesulfonate, bisulfate, butyrate, citrate, camphorate, camphorsulfonate, cyclopentanepropionate, digluconate, dodecylsulfate, ethanesulfonate, fumarate, flucoheptanoate, glycerophosphate, hemisulfate, heptanoate, hexanoate, chloride, bromide, iodide, 2-hydroxyethanesulfonate, lactate, maleate, methanesulfonate, 2-naphthalenesulfonate, nicotinate, oxalate, palmoate, pectinate, persulfate, phenylpropionate, picrate, pivalate, propionate, succinate, tartrate, thiocyanate, tosylate, undecanoate, and the like. Other examples of salts include anions of the compounds of the present invention compounded with a suitable cation such as Na⁺, NH₄⁺, and NW₄⁺ (wherein W is a C₁₋₄ alkyl group), and the like. For therapeutic use, salts of the compounds of the present invention are contemplated as being pharmaceutically acceptable. However, salts of acids and bases that are non-pharmaceutically acceptable may also find use, for example, in the preparation or purification of a pharmaceutically acceptable compound.

For therapeutic use, salts of the compounds of the present invention are contemplated as being pharmaceutically acceptable. However, salts of acids and bases that are non-pharmaceutically acceptable may also find use, for example, in the preparation or purification of a pharmaceutically acceptable compound.

As used herein, the term “gene transfer system” refers to any means of delivering a composition comprising a nucleic acid sequence to a cell or tissue. For example, gene transfer systems include, but are not limited to, vectors (e.g., retroviral, adenoviral, adeno-associated viral, and other nucleic acid-based delivery systems), microinjection of naked nucleic acid, polymer-based delivery systems (e.g., liposome-based and metallic particle-based systems), biolistic injection, and the like. As used herein, the term “viral gene transfer system” refers to gene transfer systems comprising viral elements (e.g., intact viruses, modified viruses and viral components such as nucleic acids or proteins) to facilitate delivery of the sample to a desired cell or tissue. As used herein, the term “adenovirus gene transfer system” refers to gene transfer systems comprising intact or altered viruses belonging to the family Adenoviridae.

As used herein, the term “site-specific recombination target sequences” refers to nucleic acid sequences that provide recognition sequences for recombination factors and the location where recombination takes place.

As used herein, the term “nucleic acid molecule” refers to any nucleic acid containing molecule, including but not limited to, DNA or RNA. The term encompasses sequences that include any of the known base analogs of DNA and RNA including, but not limited to, 4-acetylcytosine, 8-hydroxy-N-6-methyladenosine, aziridinylcytosine, pseudoisocytosine, 5-(carboxyhydroxylmethyl) uracil, 5-fluorouracil, 5-bromouracil, 5-carboxymethylaminomethyl-2-thiouracil, 5-carboxymethylaminomethyluracil, dihydrouracil, inosine, N6-isopentenyladenine, 1-methyladenine, 1-methylpseudouracil, 1-methylguanine, 1-methylinosine, 2,2-dimethylguanine, 2-methyladenine, 2-methylguanine, 3-methylcytosine, 5-methylcytosine, N6-methyladenine, 7-methylguanine, 5-methylaminomethyluracil, 5-methoxyaminomethyl-2-thiouracil, beta-D-mannosylqueosine, 5′-methoxycarbonylmethyluracil, 5-methoxyuracil, 2-methylthio-N-6-isopentenyladenine, uracil-5-oxyacetic acid methylester, uracil-5-oxyacetic acid, oxybutoxosine, pseudouracil, queosine, 2-thiocytosine, 5-methyl-2-thiouracil, 2-thiouracil, 4-thiouracil, 5-methyluracil, N-uracil-5-oxyacetic acid methylester, uracil-5-oxyacetic acid, pseudouracil, queosine, 2-thiocytosine, and 2,6-diaminopurine.

The term “gene” refers to a nucleic acid (e.g., DNA) sequence that comprises coding sequences necessary for the production of a polypeptide, precursor, or RNA (e.g., rRNA, tRNA). The polypeptide can be encoded by a full length coding sequence or by any portion of the coding sequence so long as the desired activity or functional properties (e.g., enzymatic activity, ligand binding, signal transduction, immunogenicity, etc.) of the full-length or fragment are retained. The term also encompasses the coding region of a structural gene and the sequences located adjacent to the coding region on both the 5′ and 3′ ends for a distance of about 1 kb or more on either end such that the gene corresponds to the length of the full-length mRNA. Sequences located 5′ of the coding region and present on the mRNA are referred to as 5′ non-translated sequences. Sequences located 3′ or downstream of the coding region and present on the mRNA are referred to as 3′ non-translated sequences. The term “gene” encompasses both cDNA and genomic forms of a gene. A genomic form or clone of a gene contains the coding region interrupted with non-coding sequences termed “introns” or “intervening regions” or “intervening sequences.” Introns are segments of a gene that are transcribed into nuclear RNA (hnRNA); introns may contain regulatory elements such as enhancers. Introns are removed or “spliced out” from the nuclear or primary transcript; introns therefore are absent in the messenger RNA (mRNA) transcript. The mRNA functions during translation to specify the sequence or order of amino acids in a nascent polypeptide.

As used herein, the term “heterologous gene” refers to a gene that is not in its natural environment. For example, a heterologous gene includes a gene from one species introduced into another species. A heterologous gene also includes a gene native to an organism that has been altered in some way (e.g., mutated, added in multiple copies, linked to non-native regulatory sequences, etc). Heterologous genes are distinguished from endogenous genes in that the heterologous gene sequences are typically joined to DNA sequences that are not found naturally associated with the gene sequences in the chromosome or are associated with portions of the chromosome not found in nature (e.g., genes expressed in loci where the gene is not normally expressed).

As used herein, the term “transgene” refers to a heterologous gene that is integrated into the genome of an organism (e.g., a non-human animal) and that is transmitted to progeny of the organism during sexual reproduction.

As used herein, the term “transgenic organism” refers to an organism (e.g., a non-human animal) that has a transgene integrated into its genome and that transmits the transgene to its progeny during sexual reproduction.

As used herein, the term “gene expression” refers to the process of converting genetic information encoded in a gene into RNA (e.g., mRNA, rRNA, tRNA, or snRNA) through “transcription” of the gene (i.e., via the enzymatic action of an RNA polymerase), and for protein encoding genes, into protein through “translation” of mRNA. Gene expression can be regulated at many stages in the process. “Up-regulation” or “activation” refers to regulation that increases the production of gene expression products (i.e., RNA or protein), while “down-regulation” or “repression” refers to regulation that decrease production. Molecules (e.g., transcription factors) that are involved in up-regulation or down-regulation are often called “activators” and “repressors,” respectively.

In addition to containing introns, genomic forms of a gene may also include sequences located on both the 5′ and 3′ end of the sequences that are present on the RNA transcript. These sequences are referred to as “flanking” sequences or regions (these flanking sequences are located 5′ or 3′ to the non-translated sequences present on the mRNA transcript). The 5′ flanking region may contain regulatory sequences such as promoters and enhancers that control or influence the transcription of the gene. The 3′ flanking region may contain sequences that direct the termination of transcription, post-transcriptional cleavage and polyadenylation.

The term “wild-type” refers to a gene or gene product isolated from a naturally occurring source. A wild-type gene is that which is most frequently observed in a population and is thus arbitrarily designed the “normal” or “wild-type” form of the gene. In contrast, the term “modified” or “mutant” refers to a gene or gene product that displays modifications in sequence and or functional properties (i.e., altered characteristics) when compared to the wild-type gene or gene product. It is noted that naturally occurring mutants can be isolated; these are identified by the fact that they have altered characteristics (including altered nucleic acid sequences) when compared to the wild-type gene or gene product.

As used herein, the terms “nucleic acid molecule encoding,” “DNA sequence encoding,” and “DNA encoding” refer to the order or sequence of deoxyribonucleotides along a strand of deoxyribonucleic acid. The order of these deoxyribonucleotides determines the order of amino acids along the polypeptide (protein) chain. The DNA sequence thus codes for the amino acid sequence.

As used herein, the terms “an oligonucleotide having a nucleotide sequence encoding a gene” and “polynucleotide having a nucleotide sequence encoding a gene,” means a nucleic acid sequence comprising the coding region of a gene or in other words the nucleic acid sequence that encodes a gene product. The coding region may be present in a cDNA, genomic DNA or RNA form. When present in a DNA form, the oligonucleotide or polynucleotide may be single-stranded (i.e., the sense strand) or double-stranded. Suitable control elements such as enhancers/promoters, splice junctions, polyadenylation signals, etc. may be placed in close proximity to the coding region of the gene if needed to permit proper initiation of transcription and/or correct processing of the primary RNA transcript. Alternatively, the coding region utilized in the expression vectors of the present invention may contain endogenous enhancers/promoters, splice junctions, intervening sequences, polyadenylation signals, etc. or a combination of both endogenous and exogenous control elements.

As used herein, the term “oligonucleotide,” refers to a short length of single-stranded polynucleotide chain. Oligonucleotides are typically less than 200 residues long (e.g., between 15 and 100), however, as used herein, the term is also intended to encompass longer polynucleotide chains. Oligonucleotides are often referred to by their length. For example a 24 residue oligonucleotide is referred to as a “24-mer”. Oligonucleotides can form secondary and tertiary structures by self-hybridizing or by hybridizing to other polynucleotides. Such structures can include, but are not limited to, duplexes, hairpins, cruciforms, bends, and triplexes.

As used herein, the terms “complementary” or “complementarity” are used in reference to polynucleotides (i.e., a sequence of nucleotides) related by the base-pairing rules. For example, for the sequence “5′-A-G-T-3′,” is complementary to the sequence “3′-T-C-A-5′.” Complementarity may be “partial,” in which only some of the nucleic acids' bases are matched according to the base pairing rules. Or, there may be “complete” or “total” complementarity between the nucleic acids. The degree of complementarity between nucleic acid strands' has significant effects on the efficiency and strength of hybridization between nucleic acid strands. This is of particular importance in amplification reactions, as well as detection methods that depend upon binding between nucleic acids.

The term “homology” refers to a degree of complementarity. There may be partial homology or complete homology (i.e., identity). A partially complementary sequence is a nucleic acid molecule that at least partially inhibits a completely complementary nucleic acid molecule from hybridizing to a target nucleic acid is “substantially homologous.” The inhibition of hybridization of the completely complementary sequence to the target sequence may be examined using a hybridization assay (Southern or Northern blot, solution hybridization and the like) under conditions of low stringency. A substantially homologous sequence or probe will compete for and inhibit the binding (i.e., the hybridization) of a completely homologous nucleic acid molecule to a target under conditions of low stringency. This is not to say that conditions of low stringency are such that non-specific binding is permitted; low stringency conditions require that the binding of two sequences to one another be a specific (i.e., selective) interaction. The absence of non-specific binding may be tested by the use of a second target that is substantially non-complementary (e.g., less than about 30% identity); in the absence of non-specific binding the probe will not hybridize to the second non-complementary target.

When used in reference to a double-stranded nucleic acid sequence such as a cDNA or genomic clone, the term “substantially homologous” refers to any probe that can hybridize to either or both strands of the double-stranded nucleic acid sequence under conditions of low stringency as described above.

A gene may produce multiple RNA species that are generated by differential splicing of the primary RNA transcript. cDNAs that are splice variants of the same gene will contain regions of sequence identity or complete homology (representing the presence of the same exon or portion of the same exon on both cDNAs) and regions of complete non-identity (for example, representing the presence of exon “A” on cDNA 1 wherein cDNA 2 contains exon “B” instead). Because the two cDNAs contain regions of sequence identity they will both hybridize to a probe derived from the entire gene or portions of the gene containing sequences found on both cDNAs; the two splice variants are therefore substantially homologous to such a probe and to each other.

When used in reference to a single-stranded nucleic acid sequence, the term “substantially homologous” refers to any probe that can hybridize (i.e., it is the complement of) the single-stranded nucleic acid sequence under conditions of low stringency as described above.

As used herein, the term “hybridization” is used in reference to the pairing of complementary nucleic acids. Hybridization and the strength of hybridization (i.e., the strength of the association between the nucleic acids) is impacted by such factors as the degree of complementary between the nucleic acids, stringency of the conditions involved, the Tₘ of the formed hybrid, and the G:C ratio within the nucleic acids. A single molecule that contains pairing of complementary nucleic acids within its structure is said to be “self-hybridized.”

As used herein, the term “Tₘ” is used in reference to the “melting temperature.” The melting temperature is the temperature at which a population of double-stranded nucleic acid molecules becomes half dissociated into single strands. The equation for calculating the Tₘ of nucleic acids is well known in the art. As indicated by standard references, a simple estimate of the Tₘ value may be calculated by the equation: Tₘ=81.5+0.41(% G+C), when a nucleic acid is in aqueous solution at 1 M NaCl (See e.g., Anderson and Young, Quantitative Filter Hybridization, in Nucleic Acid Hybridization (1985)). Other references include more sophisticated computations that take structural as well as sequence characteristics into account for the calculation of Tₘ.

As used herein the term “stringency” is used in reference to the conditions of temperature, ionic strength, and the presence of other compounds such as organic solvents, under which nucleic acid hybridizations are conducted. Under “low stringency conditions” a nucleic acid sequence of interest will hybridize to its exact complement, sequences with single base mismatches, closely related sequences (e.g., sequences with 90% or greater homology), and sequences having only partial homology (e.g., sequences with 50-90% homology). Under “medium stringency conditions,” a nucleic acid sequence of interest will hybridize only to its exact complement, sequences with single base mismatches, and closely relation sequences (e.g., 90% or greater homology). Under “high stringency conditions,” a nucleic acid sequence of interest will hybridize only to its exact complement, and (depending on conditions such a temperature) sequences with single base mismatches. In other words, under conditions of high stringency the temperature can be raised so as to exclude hybridization to sequences with single base mismatches.

“High stringency conditions” when used in reference to nucleic acid hybridization comprise conditions equivalent to binding or hybridization at 42° C. in a solution consisting of 5×SSPE (43.8 g/l NaCl, 6.9 g/l NaH₂PO₄.H₂O and 1.85 g/l EDTA, pH adjusted to 7.4 with NaOH), 0.5% SDS, 5× Denhardt's reagent and 100 μg/ml denatured salmon sperm DNA followed by washing in a solution comprising 0.1×SSPE, 1.0% SDS at 42° C. when a probe of about 500 nucleotides in length is employed.

“Medium stringency conditions” when used in reference to nucleic acid hybridization comprise conditions equivalent to binding or hybridization at 42° C. in a solution consisting of 5×SSPE (43.8 g/l NaCl, 6.9 g/l NaH₂PO₄.H₂O and 1.85 g/l EDTA, pH adjusted to 7.4 with NaOH), 0.5% SDS, 5× Denhardt's reagent and 100 μg/ml denatured salmon sperm DNA followed by washing in a solution comprising 1.0×SSPE, 1.0% SDS at 42° C. when a probe of about 500 nucleotides in length is employed.

“Low stringency conditions” comprise conditions equivalent to binding or hybridization at 42° C. in a solution consisting of 5×SSPE (43.8 g/l NaCl, 6.9 g/l NaH₂PO₄.H₂O and 1.85 g/l EDTA, pH adjusted to 7.4 with NaOH), 0.1% SDS, 5× Denhardt's reagent (50× Denhardt's contains per 500 ml: 5 g Ficoll (Type 400, Pharamcia), 5 g BSA (Fraction V; Sigma)) and 100 μg/ml denatured salmon sperm DNA followed by washing in a solution comprising 5×SSPE, 0.1% SDS at 42° C. when a probe of about 500 nucleotides in length is employed.

The art knows well that numerous equivalent conditions may be employed to comprise low stringency conditions; factors such as the length and nature (DNA, RNA, base composition) of the probe and nature of the target (DNA, RNA, base composition, present in solution or immobilized, etc.) and the concentration of the salts and other components (e.g., the presence or absence of formamide, dextran sulfate, polyethylene glycol) are considered and the hybridization solution may be varied to generate conditions of low stringency hybridization different from, but equivalent to, the above listed conditions. In addition, the art knows conditions that promote hybridization under conditions of high stringency (e.g., increasing the temperature of the hybridization and/or wash steps, the use of formamide in the hybridization solution, etc.) (see definition above for “stringency”).

As used herein, the term “probe” refers to an oligonucleotide (i.e., a sequence of nucleotides), whether occurring naturally as in a purified restriction digest or produced synthetically, recombinantly or by PCR amplification, that is capable of hybridizing to another oligonucleotide of interest. A probe may be single-stranded or double-stranded. Probes are useful in the detection, identification and isolation of particular gene sequences. It is contemplated that any probe used in the present invention will be labeled with any “reporter molecule,” so that is detectable in any detection system, including, but not limited to enzyme (e.g., ELISA, as well as enzyme-based histochemical assays), fluorescent, radioactive, and luminescent systems. It is not intended that the present invention be limited to any particular detection system or label.

The terms “in operable combination,” “in operable order,” and “operably linked” as used herein refer to the linkage of nucleic acid sequences in such a manner that a nucleic acid molecule capable of directing the transcription of a given gene and/or the synthesis of a desired protein molecule is produced. The term also refers to the linkage of amino acid sequences in such a manner so that a functional protein is produced.

The term “isolated” when used in relation to a nucleic acid, as in “an isolated oligonucleotide” or “isolated polynucleotide” refers to a nucleic acid sequence that is identified and separated from at least one component or contaminant with which it is ordinarily associated in its natural source. Isolated nucleic acid is such present in a form or setting that is different from that in which it is found in nature. In contrast, non-isolated nucleic acids as nucleic acids such as DNA and RNA found in the state they exist in nature. For example, a given DNA sequence (e.g., a gene) is found on the host cell chromosome in proximity to neighboring genes; RNA sequences, such as a specific mRNA sequence encoding a specific protein, are found in the cell as a mixture with numerous other mRNAs that encode a multitude of proteins. However, isolated nucleic acid encoding a given protein includes, by way of example, such nucleic acid in cells ordinarily expressing the given protein where the nucleic acid is in a chromosomal location different from that of natural cells, or is otherwise flanked by a different nucleic acid sequence than that found in nature. The isolated nucleic acid, oligonucleotide, or polynucleotide may be present in single-stranded or double-stranded form. When an isolated nucleic acid, oligonucleotide or polynucleotide is to be utilized to express a protein, the oligonucleotide or polynucleotide will contain at a minimum the sense or coding strand (i.e., the oligonucleotide or polynucleotide may be single-stranded), but may contain both the sense and anti-sense strands (i.e., the oligonucleotide or polynucleotide may be double-stranded).

The term “isolated” when used in reference to a cell refers to a cell that is removed from its natural environment (e.g., a solid tumor) and that is separated (e.g., is at least about 75% free, and most preferably about 90% free), from other cells with which it is naturally present, but that lack the marker based on which the cells were isolated.

As used herein, the term “purified” or “to purify” refers to the removal of components (e.g., contaminants) from a sample. For example, antibodies are purified by removal of contaminating non-immunoglobulin proteins; they are also purified by the removal of immunoglobulin that does not bind to the target molecule. The removal of non-immunoglobulin proteins and/or the removal of immunoglobulins that do not bind to the target molecule results in an increase in the percent of target-reactive immunoglobulins in the sample. In another example, recombinant polypeptides are expressed in bacterial host cells and the polypeptides are purified by the removal of host cell proteins; the percent of recombinant polypeptides is thereby increased in the sample.

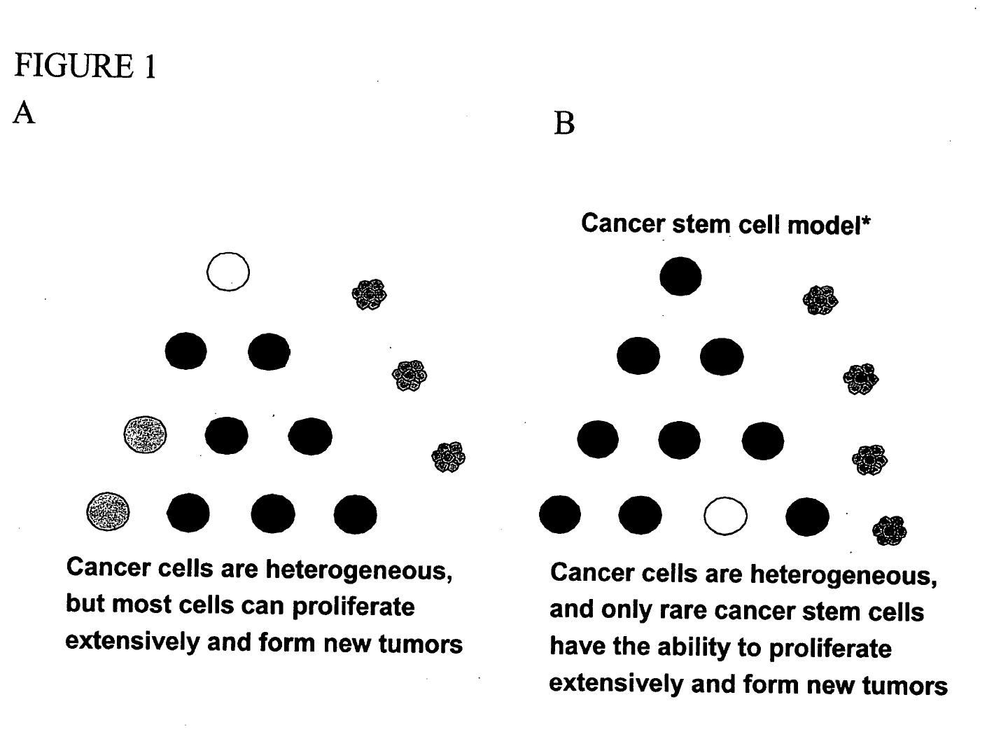

“Enriched”, as in an enriched population of cells, can be defined based upon the increased number of cells having a particular marker in a fractionated set of cells as compared with the number of cells having the marker in the unfractionated set of cells. However, the term “enriched” can also be defined by tumorigenic function as the minimum number of cells that generate a cancer (e.g., a tumor) at a limited dilution frequency (e.g., in a mouse model). For example, if 500 cancer stem cells form tumors in 63% of test animals, but 5000 unfractionated tumor cells are required to form tumors in 63% of test animals, then the cancer stem cell population is 10-fold enriched for tumorigenic activity. The cancer stem cell model (See, e.g., FIG. 1A) provides the linkage between these two definitions of (phenotypic and functional) enrichment.

“Amino acid sequence” and terms such as “polypeptide” or “protein” are not meant to limit the amino acid sequence to the complete, native amino acid sequence associated with the recited protein molecule.

The term “native protein” as used herein to indicate that a protein does not contain amino acid residues encoded by vector sequences; that is, the native protein contains only those amino acids found in the protein as it occurs in nature. A native protein may be produced by recombinant means or may be isolated from a naturally occurring source.

As used herein the term “portion” when in reference to a protein (as in “a portion of a given protein”) refers to fragments of that protein. The fragments may range in size from four amino acid residues to the entire amino acid sequence minus one amino acid.

As used herein, the term “vector” is used in reference to nucleic acid molecules that transfer DNA segment(s) from one cell to another. The term “vehicle” is sometimes used interchangeably with “vector.” Vectors are often derived from plasmids, bacteriophages, or plant or animal viruses.

The term “expression vector” as used herein refers to a recombinant DNA molecule containing a desired coding sequence and appropriate nucleic acid sequences necessary for the expression of the operably linked coding sequence in a particular host organism. Nucleic acid sequences necessary for expression in prokaryotes usually include a promoter, an operator (optional), and a ribosome binding site, often along with other sequences. Eukaryotic cells are known to utilize promoters, enhancers, and termination and polyadenylation signals.

The terms “overexpression” and “overexpressing” and grammatical equivalents, are used in reference to levels of mRNA to indicate a level of expression approximately 3-fold higher (or greater) than that observed in a given tissue in a control or non-transgenic animal. Levels of mRNA are measured using any of a number of techniques known to those skilled in the art including, but not limited to Northern blot analysis. Appropriate controls are included on the Northern blot to control for differences in the amount of RNA loaded from each tissue analyzed (e.g., the amount of 28S rRNA, an abundant RNA transcript present at essentially the same amount in all tissues, present in each sample can be used as a means of normalizing or standardizing the mRNA-specific signal observed on Northern blots). The amount of mRNA present in the band corresponding in size to the correctly spliced transgene RNA is quantified; other minor species of RNA which hybridize to the transgene probe are not considered in the quantification of the expression of the transgenic mRNA.

The term “transfection” as used herein refers to the introduction of foreign DNA into eukaryotic cells. Transfection may be accomplished by a variety of means known to the art including calcium phosphate-DNA co-precipitation, DEAE-dextran-mediated transfection, polybrene-mediated transfection, electroporation, microinjection, liposome fusion, lipofection, protoplast fusion, retroviral infection, and biolistics.

The term “stable transfection” or “stably transfected” refers to the introduction and integration of foreign DNA into the genome of the transfected cell. The term “stable transfectant” refers to a cell that has stably integrated foreign DNA into the genomic DNA.

The term “transient transfection” or “transiently transfected” refers to the introduction of foreign DNA into a cell where the foreign DNA fails to integrate into the genome of the transfected cell. The foreign DNA persists in the nucleus of the transfected cell for several days. During this time the foreign DNA is subject to the regulatory controls that govern the expression of endogenous genes in the chromosomes. The term “transient transfectant” refers to cells that have taken up foreign DNA but have failed to integrate this DNA.

As used herein, the term “selectable marker” refers to the use of a gene that encodes an enzymatic activity that confers the ability to grow in medium lacking what would otherwise be an essential nutrient (e.g. the HIS3 gene in yeast cells); in addition, a selectable marker may confer resistance to an antibiotic or drug upon the cell in which the selectable marker is expressed. Selectable markers may be “dominant”; a dominant selectable marker encodes an enzymatic activity that can be detected in any eukaryotic cell line. Examples of dominant selectable markers include the bacterial aminoglycoside 3′ phosphotransferase gene (also referred to as the neo gene) that confers resistance to the drug G418 in mammalian cells, the bacterial hygromycin G phosphotransferase (hyg) gene that confers resistance to the antibiotic hygromycin and the bacterial xanthine-guanine phosphoribosyl transferase gene (also referred to as the gpt gene) that confers the ability to grow in the presence of mycophenolic acid. Other selectable markers are not dominant in that their use must be in conjunction with a cell line that lacks the relevant enzyme activity. Examples of non-dominant selectable markers include the thymidine kinase (tk) gene that is used in conjunction with tk⁻ cell lines, the CAD gene that is used in conjunction with CAD-deficient cells and the mammalian hypoxanthine-guanine phosphoribosyl transferase (hprt) gene that is used in conjunction with hprt⁻ cell lines. A review of the use of selectable markers in mammalian cell lines is provided in Sambrook, J. et al., Molecular Cloning: A Laboratory Manual, 2nd ed., Cold Spring Harbor Laboratory Press, New York (1989) pp. 16.9-16.15.

As used herein, the term “cell culture” refers to any in vitro culture of cells. Included within this term are continuous cell lines (e.g., with an immortal phenotype (e.g., cancer stem cells)), primary cell cultures, transformed cell lines (e.g., genetically modified cancer stem cells), finite cell lines (e.g., non-transformed cells), and any other cell population maintained in vitro.

As used herein, the term “eukaryote” refers to organisms distinguishable from “prokaryotes.” It is intended that the term encompass all organisms with cells that exhibit the usual characteristics of eukaryotes, such as the presence of a true nucleus bounded by a nuclear membrane, within which lie the chromosomes, the presence of membrane-bound organelles, and other characteristics commonly observed in eukaryotic organisms. Thus, the term includes, but is not limited to such organisms as fungi, protozoa, and animals (e.g., humans).

As used herein, the term “in vitro” refers to an artificial environment and to processes or reactions that occur within an artificial environment. In vitro environments can consist of, but are not limited to, test tubes and cell culture. The term “in vivo” refers to the natural environment (e.g., an animal or a cell) and to processes or reactions that occur within a natural environment.

The terms “test compound” and “candidate compound” refer to any chemical entity, pharmaceutical, drug, and the like that is a candidate for use to treat or prevent a disease, illness, sickness, or disorder of bodily function (e.g., cancer (e.g., tumorigenic cells, leukemogenic cells or cancer stem cells)). Test compounds comprise both known and potential therapeutic compounds. A test compound can be determined to be therapeutic by screening using the screening methods of the present invention. Examples of test compounds include, but are not limited to, carbohydrates, monosaccharides, oligosaccharides, polysaccharides, amino acids, peptides, oligopeptides, polypeptides, proteins, nucleosides, nucleotides, oligonucleotides, polynucleotides, including DNA and DNA fragments, RNA and RNA fragments and the like, lipids, retinoids, steroids, drug, antibody, prodrug, glycopeptides, glycoproteins, proteoglycans and the like, and synthetic analogues or derivatives thereof, including peptidomimetics, small molecule organic compounds and the like, and mixtures thereof (e.g., that is a candidate for use to treat or prevent a disease, illness, sickness, or disorder of bodily function (e.g., cancer (e.g., tumorigenic cells, leukemogenic cells or cancer stem cell growth)). Test compounds comprise both known and potential therapeutic compounds. A test compound can be determined to be therapeutic by screening using the screening methods of the present invention. A “known therapeutic compound” refers to a therapeutic compound that has been shown (e.g., through animal trials or prior experience with administration to humans) to be effective in such treatment or prevention. In preferred embodiments, “test compounds” are anticancer agents. In particularly preferred embodiments, “test compounds” are anticancer agents that induce apoptosis in cells.

As used herein, the term “test compound library” refers to a mixture or collection of one or more compounds generated or obtained in any manner. Preferably, the library contains more than one compound or member. The test compound libraries employed in this invention may be prepared or obtained by any means including, but not limited to, combinatorial chemistry techniques, fermentation methods, plant and cellular extraction procedures and the like. Methods for making combinatorial libraries are well-known in the art (See, for example, E. R. Felder, Chimia 1994, 48, 512-541; Gallop et al., J. Med. Chem. 1994, 37, 1233-1251; R. A. Houghten, Trends Genet. 1993, 9, 235-239; Houghten et al., Nature 1991, 354, 84-86; Lam et al., Nature 1991, 354, 82-84; Carell et al., Chem. Biol. 1995, 3, 171-183; Madden et al., Perspectives in Drug Discovery and Design 2, 269-282; Cwirla et al., Biochemistry 1990, 87, 6378-6382; Brenner et al., Proc. Natl. Acad. Sci. USA 1992, 89, 5381-5383; Gordon et al., J. Med. Chem. 1994, 37, 1385-1401; Lebl et al., Biopolymers 1995, 37 177-198; and references cited therein. Each of these references is incorporated herein by reference in its entirety).

The term “synthetic small molecule organic compounds” refers to organic compounds generally having a molecular weight less than about 1000, preferably less than about 500, which are prepared by synthetic organic techniques, such as by combinatorial chemistry techniques.

As used herein the term “prodrug” refers to a pharmacologically inactive derivative of a parent “drug” molecule that requires biotransformation (e.g., either spontaneous or enzymatic) within the target physiological system to release, or to convert (e.g., enzymatically, mechanically, electromagnetically, etc.) the “prodrug” into the active “drug.” “Prodrugs” are designed to overcome problems associated with stability, toxicity, lack of specificity, or limited bioavailability. Exemplary “prodrugs” comprise an active “drug” molecule itself and a chemical masking group (e.g., a group that reversibly suppresses the activity of the “drug”). Some preferred “prodrugs” are variations or derivatives of compounds that have groups cleavable under metabolic conditions. Exemplary “prodrugs” become pharmaceutically active in vivo or in vitro when they undergo solvolysis under physiological conditions or undergo enzymatic degradation or other biochemical transformation (e.g., phosphorylation, hydrogenation, dehydrogenation, glycosylation, etc.). Prodrugs often offer advantages of solubility, tissue compatibility, or delayed release in the mammalian organism. (See e.g., Bundgard, Design of Prodrugs, pp. 7-9, 21-24, Elsevier, Amsterdam (1985); and Silverman, The Organic Chemistry of Drug Design and Drug Action, pp. 352-401, Academic Press, San Diego, Calif. (1992)). Common “prodrugs” include acid derivatives such as esters prepared by reaction of parent acids with a suitable alcohol (e.g., a lower alkanol), amides prepared by reaction of the parent acid compound with an amine (e.g., as described above), or basic groups reacted to form an acylated base derivative (e.g., a lower alkylamide).

As used herein, the terms “drug” and “chemotherapeutic agent” refer to pharmacologically active molecules that are used to diagnose, treat, or prevent diseases or pathological conditions in a physiological system (e.g., a subject, or in vivo, in vitro, or ex vivo cells, tissues, and organs). Drugs act by altering the physiology of a living organism, tissue, cell, or in vitro system to which the drug has been administered. It is intended that the terms “drug” and “chemotherapeutic agent” encompass anti-hyperproliferative and antineoplastic compounds as well as other biologically therapeutic compounds.

As used herein, the term “sample” is used in its broadest sense. In one sense, it is meant to include a specimen or culture obtained from any source, as well as biological and environmental samples. Biological samples may be obtained from animals (including humans) and encompass fluids, solids, tissues, and gases. Biological samples include blood products, such as plasma, serum and the like. Environmental samples include environmental material such as surface matter, soil, water, crystals and industrial samples. Such examples are not however to be construed as limiting the sample types applicable to the present invention.

### DETAILED DESCRIPTION OF THE INVENTION

Cancers are composed of heterogeneous cell populations. For example, breast cancers are a mixture of cancer cells and normal cells, including mesenchymal (stromal) cells, inflammatory cells, and endothelial cells. Classic models hold that phenotypically distinct cancer cell populations all have the capacity to proliferate and give rise to a new tumor (FIG. 1A). In the classical model, tumor cell heterogeneity results from environmental factors as well as ongoing mutation within cancer cells resulting in diverse populations of tumorigenic cells with all populations of cells having similar tumorigenic potential (See, e.g., Pandis et al., Genes, Chromosomes & Cancer 12:122-129 (1998); Kuukasjrvi et al., Cancer Res. 57: 1597-1604 (1997); Bonsing et al., Cancer 71: 382-391 (1993); Bonsing et al., Genes Chromosomes & Cancer 82: 173-183 (2000); Beerman H et al., Cytometry. 12(2): 147-54 (1991); Aubele M & Werner M, Analyt. Cell. Path. 19: 53 (1999); Shen L et al., Cancer Res. 60: 3884 (2000)).

The present invention embodies methods to kill or inhibit the proliferation of cancer cells (e.g., malignant (e.g., tumorigenic or leukemogenic) cells). In some cancers, these malignant (e.g., tumorigenic and/or leukemogenic) cells may compose the majority of cancer cells. In other cancers (e.g., leukemia, lymphoma, or solid tumor), tumor growth and progression may be driven by “cancer stem cells” that comprise a minority of cancer cells. These “cancer stem cells” give rise to additional cancer stem cells as well as to the majority of cells in the tumor (e.g., cancer cells that have lost the capacity for extensive proliferation and the ability to give rise to new tumors). Thus, cancer cell heterogeneity reflects the presence of a variety of tumor cell types that arise from a cancer stem cell. Whether the tumorigenic and/or leukemogenic cells comprise the majority of cells within a cancer, or whether they follow a cancer stem cell model and comprise a minority of cells, the present invention provides methods to kill or inhibit the proliferation of these cells.

Accordingly, one embodiment of the present invention relates to cancer (e.g., leukemic and solid tumor) stem cells (See, e.g., U.S. Pat. Publ. Nos. 20020119565, 20040037815, 20050089518, 20050232927 and WO 05/005601, each of which is herein incorporated by reference in its entirety). Recent studies have demonstrated striking phenotypic and mechanistic similarities between normal stem cells and cancer cells in the same tissues (See, e.g., Reya et al., Nature 414, 105-111 (2001); Pardal et al., Nature Cancer Reviews 3, 895-902 (2003); Al-Hajj et al., Proc Natl Acad Sci USA 100, 3983-3988 (2003); Singh et al., Cancer Res 63, 5821-8 (2003)). The most exhaustively documented example comes from acute myeloid leukemia (AML) which is sustained by cancer (e.g., leukemic) stem cells (See, e.g., Lapidot et al., Nature 17, 645-648 (1994); Bonnet and Dick, Nature Medicine 3, 730-737 (1997)). Cancer (e.g., leukemic) stem cells express markers similar to normal hematopoietic stem cells (HSCs) and can transfer disease upon transplantation into irradiated mice (See, e.g., Lapidot et al., Nature 17, 645-648 (1994); Bonnet and Dick, Nature Medicine 3, 730-737 (1997)). Moreover, cancer (e.g., leukemic and solid tumor) cells depend on similar mechanisms as normal HSCs for self-renewal. For example, both HSCs and AMLs can form in the absence of the transcriptional repressor Bmi-1, but require Bmi-1 for their maintenance (See, e.g., Park et al., Nature 423, 302-305 (2003); Lessard and Sauvageau, Nature 423, 255-260 (2003)).

Cancer cells often inherit or acquire properties similar to stem cells, including mechanisms that regulate proliferation. The hedgehog, Wnt, and Notch pathways that promote cancer cell proliferation also promote normal stem cell self-renewal in the same tissues (See, e.g., Reya et al., Nature 414, 105-111 (2001); Pardal et al., Nature Cancer Reviews 3, 895-902 (2003); Molofsky et al., Current Opinions in Cell Biology 16, 700-7 (2004); Taipale and Beachy, Nature 411, 349-354 (2001)). Conversely, gate-keeping tumor suppressors such as p53, p16^{lnk4a}, and p19^{Arf} that inhibit cancer cell proliferation, also inhibit stem cell self-renewal (See, e.g., Molofsky et al., Current Opinions in Cell Biology 16, 700-7 (2004); Molofsky et al., Genes & Development 19, 1432-1437 (2005); Lowe and Sherr, Current Opinion in Genetics & Development 13, 77-83 (2003)). The identification and/or generation of therapeutic compounds that eliminate cancer cells (e.g., cancer stem cells, tumorigenic cells, and/or leukemogenic cells) without eliminating normal HSCs provides a tremendous benefit to a subject undergoing cancer therapy as cancer therapeutics that kill normal stem cells in addition to cancer cells can cause death, serious morbidity, or permanent disability. Thus, what is needed is the ability to identify therapeutics that kill tumorigenic cancer cells without killing normal stem cells.

Accordingly, in some embodiments, the present invention relates to cancer diagnostics and to compositions and methods for the identification of cancer therapeutics, as well as compositions and methods employing identified compounds for therapeutic and research applications. In particular, the present invention provides compositions and methods for identifying therapeutic compounds that eliminate cancer stem cells without eliminating normal stem cells (e.g., in the same tissues). For example, the present invention illustrates this capability with detailed information regarding the effect of Pten deletion on leukemogenesis and normal HSC self-renewal.

PTEN is a phosphatase that negatively regulates proliferation by inhibiting signaling through the PI-3kinase pathway (See, e.g., Maehama and Dixon, J Biol Chem 273, 13375-8 (1998); Stiles et al., Dev Biol 273, 175-84 (2004)). Pten is commonly deleted or otherwise inactivated in diverse cancers (See, e.g., Di Cristofano and Pandolfi, Cell 100, 387-390 (2000)) including hematopoietic malignancies (See, e.g., Aggerholm et al., Eur J Haematol 65, 109-13 (2000); Roman-Gomez et al., Blood 104, 2492-8 (2004); Dahia et al., Hum Mol Genet 8, 185-93 (1999); Cheong et al., Br J Haematol 122, 454-6 (2003)). The present invention demonstrates that whereas Pten deletion promotes leukemogenesis and the generation of leukemic stem cells it leads to the depletion of normal HSCs. Thus, the present invention identifies a mechanistic difference between stem cell self-renewal and cancer cell proliferation in the same tissue. In some embodiments, the present invention provides compositions and methods for eliminating cancer stem cells while concurrently leaving unharmed (e.g., maintaining or restoring) normal HSCs. For example, in some embodiments, inhibition of mTor (e.g., with rapamycin or a similar agent) depletes leukemic cells, including leukemic stem cells, and restores normal HSC function (e.g., including the ability of HSC to long-term multilineage reconstitute irradiated mice). Thus, by therapeutically targeting pathways that have distinct effects on stem cell self-renewal and cancer cell proliferation, the present invention provides the ability to deplete cancer cells without damaging normal stem cells.

The present invention demonstrates that normal stem cells and cancer (e.g., leukemia) stem cells respond differently to alterations (e.g., Pten deletion) in the P13 kinase signaling pathway (For a review of the P13 signaling pathway, See, e.g., Sansal and Seller, J Clin Oncol 22, 2954-2963 (2004); Hay and Sononberg, Genes and Development 18, 1926-1945 (2004)). Although an understanding of the mechanism is not necessary to practice the present invention and the present invention is not limited to any particular mechanism of action, in some embodiments, the persistent activation of the PI-3kinase pathway in normal stem cells leads to the induction of a senescence response, which leads to their depletion. This is consistent with the initial proliferation of HSCs, followed by their depletion and their inability to reconstitute irradiated mice (See Examples 4 and 5). Furthermore, this explains in part the opposite response of cancer (e.g., leukemia) stem cells to Pten deletion. Although an understanding of the mechanism is not necessary to practice the present invention and the present invention is not limited to any particular mechanism of action, in some embodiments, cancer stem cells acquire secondary mutations that inactivate a senescence response to Pten deletion. Additionally, the present invention provides the ability to maintain HSCs (e.g., maintain the reconstituting activity of Pten-deficient HSCs) by treating normal HSCs (e.g., in vitro, ex vivo, or in vivo) with an inhibitor of mTor (e.g., rapamycin or similar agent) (See Example 6). Thus, the present invention demonstrates that normal HSC senescence is induced as a consequence of persistent mitogenic pathway (e.g., mTor) activation.

A wide variety of persistent mitogenic stimuli are contemplated to be capable of leading to the depletion of normal stem cells in a variety of tissues. These persistent mitogenic stimuli might arise via mutations that constitutively activate oncogenic pathways, or by chronic tissue damage that leads to constitutive stem cell activation. Therefore, the present invention provides methods of identifying diverse compounds that kill or inhibit the proliferation of tumorigenic cancer cells in diverse tissues without harming the normal stem cells in the same tissues. Moreover, the ability of these compounds to promote stem cell quiescence or to inhibit senescence responses are contemplated to prolong the replicative lifespan or regenerative capacity of normal stem cells.

Although an understanding of the mechanism is not necessary to practice the present invention and the present invention is not limited to any particular mechanism of action, normal stem cells induce a pathway that causes stem cell depletion in response to persistent activation of mitogenic pathways (e.g., explaining the phenotypes of other mutations that cause initial stem cell expansion followed by a long-term depletion of stem cells). Thus, the present invention demonstrates that compounds that promote stem cell quiescence consistently have different effects on stem cell self-renewal as compared to cancer cell (e.g., cancer stem cell) proliferation by virtue of their ability to promote the maintenance of normal stem cells while depleting cancer cells. Accordingly, the present invention provides compositions and methods (e.g., test compound (e.g., drug) screening methods)) for identifying new anti-cancer agents (e.g., from a library of test compounds) that inhibit (e.g., kill) cancer stem cell proliferation and promote the maintenance (e.g. quiescence) of normal HSCs.

Surprisingly, the depletion of adult HSCs after conditional deletion of Pten is the opposite of what was observed after Pten deletion in fetal stem cells. Conditional Pten deletion in the fetal central nervous system increases the self-renewal and frequency of neural stem cells (See, e.g., Groszer et al., Science 294, 2186-2189 (2001)). The present invention provides that an opposite response in HSCs represents a general difference between fetal and adult stem cells, rather than a difference between tissues. For example, although an understanding of the mechanism is not necessary to practice the present invention and the present invention is not limited to any particular mechanism of action, because the depletion of HSCs after Pten deletion is caused by the activation of senescence pathways, these pathways are not competent to be induced in fetal cells. There is evidence that senescence pathways are more readily activated in adult cells as compared to fetal cells. For example, Bmi-1-deficiency is sufficient to induce p16^{lnk4a} and p19^{Arf} expression in adult tissues in vivo, but not in fetal tissues in vivo (See, e.g., Molofsky et al., Genes & Development 19, 1432-1437 (2005); Molofsky et al., Nature 425, 962-7 (2003)). The relative balance of proto-oncogenes and tumor suppressors that regulate stem cell self-renewal appears to change between embryonic, fetal, and adult life as the organogenic demand decreases and the risk of cancer increases (See, e.g., Molofsky et al., Current Opinions in Cell Biology 16, 700-7 (2004)).

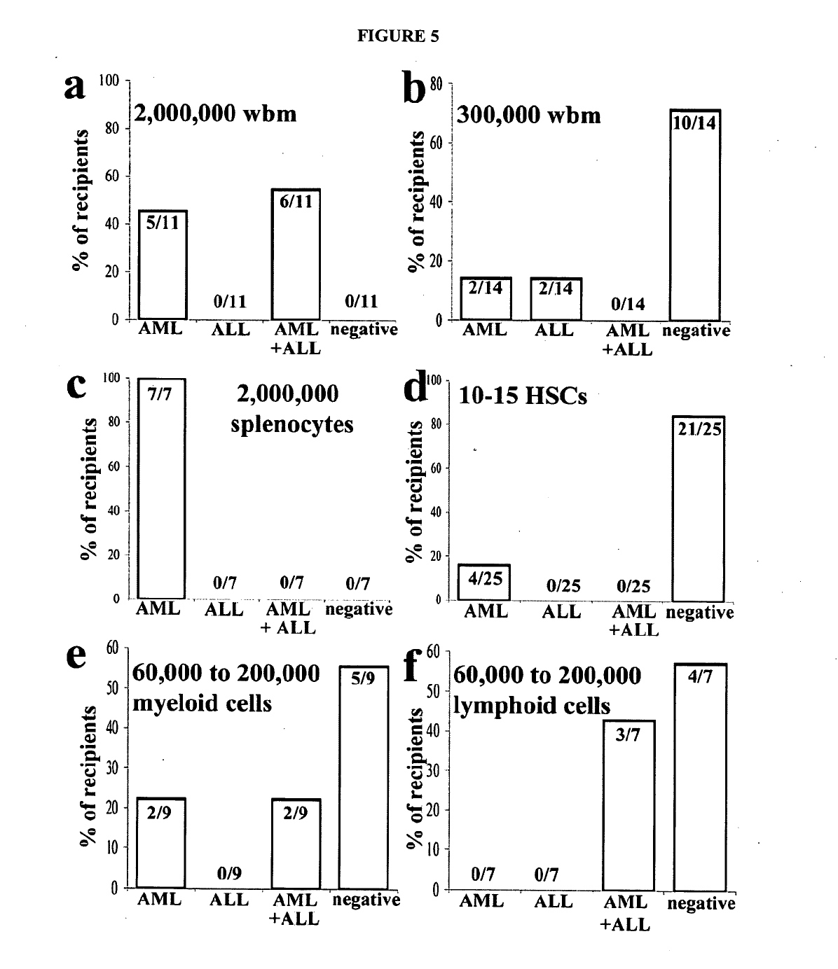

Leukemias that arise after Pten deletion may or may not follow a clear leukemic stem cell model (characterized by the presence of a single phenotypically defined subset of cells capable of transferring disease). The present invention provides that multiple cell populations, some expressing markers of immature cells and others expressing markers of mature cells, were enriched for the ability to transfer disease to irradiated mice (See FIG. 5). Thus, leukemias that arise in the absence of Pten may not follow a cancer stem cell model, as diverse leukemic cells may have sufficient clonogenicity to transfer disease. In keeping with this, the present invention provides methods of identifying anti-cancer compounds that are effective in killing or inhibiting the proliferation of tumorigenic or leukemogenic cancer cells, whether or not they arise from a cancer that abides by a hierarchical cancer stem cell model.

Irrespective of the cellular hierarchy associated with the leukemias, or their cells-of-origin, the present invention demonstrates that it is possible to identify and successfully target genes, proteins and pathways that have distinct effects on normal stem cells and cancer cells (See Examples 3-6). This is important because it has been hypothesized that a key feature of oncogenic mutations is their ability to confer self-renewal potential by activating pathways used by normal stem cells, irrespective of whether the mutations occur in stem cells, restricted progenitors, or differentiated cells (See, e.g., Reya et al., Nature 414, 105-111 (2001); Pardal et al., Nature Cancer Reviews 3, 895-902 (2003); Taipale and Beachy, Nature 411, 349-354 (2001)). Thus, the present invention demonstrates that by comparing the mechanisms that regulate stem cell self-renewal and cancer cell proliferation, one can identify differences (e.g., between normal HSCs and cancer stem cells) that lead to the design of new therapies, and the more effective use of existing therapies.

The previous failure of cancer therapies to significantly improve outcome has been due in part to the failure of these therapies to target the cancer stem cells within a cancer (e.g., leukemia, lymphoma or solid tumor) that have the capacity for extensive proliferation and the ability to give rise to all other cancer cell types. The present invention provides the ability for anti-cancer therapies to be directed, both generally, and now specifically directed, against cancer stem cells. Directed anti-cancer therapies of the present invention are therefore capable of providing more effective and robust therapeutic responses (e.g., as compared to heretofore existing therapies).

In particular, the present invention provides methods of identifying anti-cancer agents based, in part, on the agents ability to promote the quiescence of adult stem cells (e.g. increasing the proportion of stem cells in G0 phase of the cell cycle). Additionally, the invention provides methods of treating (e.g., killing or neutralizing (e.g., inhibiting growth of)) tumorigenic/leukemogenic cancer cells (e.g., including cancer (e.g., leukemia, lymphoma or solid tumor) stem cells) while concurrently preserving (e.g., displaying no detrimental effect towards) normal stem cells. For example, in some embodiments, the present invention provides methods of treating (e.g., killing or inhibiting growth of) cancer stem cells and/or promoting renewal of normal stem cells. In some embodiments, treating cancer stem cells and/or promoting renewal of normal stem cells comprises using agents (e.g., PTEN or agents that mimic PTEN function) that inhibit signaling pathways (e.g., the P13 kinase pathway (e.g., mTor inhibitors (e.g., rapamycin, or similar agents)) or PTEN pathway).

The present invention demonstrates that rapamycin and rapamycin analogues like CCI-779 and RAD-001 (See, e.g., Sawyers et al. Nature Medicine, 2004) can kill or inhibit the proliferation of leukemic stem cells while restoring the normal function of Pten-deficient HSCs, and without harming normal wild-type HSCs. Although an understanding of the mechanism is not necessary to practice the present invention and the present invention is not limited to any particular mechanism of action, in some embodiments, based upon data generated during the development of the present invention, other agents that inhibit the G0-G1 transition of normal stem cells by inhibiting signaling through mitogenic pathways are contemplated to have similar effects in the context of cancers that arise due to inappropriate activation of said mitogenic pathways. This includes other pharmacological inhibitors of the PI-3 kinase pathway and it's downstream effectors as well as inhibitors of other mitogenic pathways that are capable of promoting the G0-G1 transition in adult stem cells. Depending on the tissue, these other pathways may include the Wnt pathway, the sonic hedgehog pathway, the Notch pathway, the Ras signaling pathway, and others.

The present invention also provides in vivo, ex vivo and in vitro assays of cancer stem cell (e.g., leukemia, lymphoma or solid tumor stem cell) function and growth, and response of the same to treatment (e.g., the administration of therapeutic agents (e.g., test compounds, agents comprising PTEN or agents that mimic PTEN function)). Additionally, the present invention provides methods for using the various populations of cells isolated from a cancer (e.g., a population of cells enriched for cancer (e.g., leukemia, lymphoma or solid tumor) stem cells) to identify factors influencing cancer stem cell proliferation, to analyze populations of cells isolated from a cancer (e.g., a leukemia, lymphoma or solid tumor) for gene expression patterns or protein expression patterns, to identify new anti-cancer drug targets, to predict the sensitivity of a cancer (e.g., a leukemia, lymphoma or solid tumor) from an individual patient to existing anti-cancer treatment regimens (e.g., for diagnostic purposes), to model anti-cancer treatment, to test new therapeutic compounds, to identify and test new diagnostic markers (e.g., cancer stem cell biomarkers), to treat cancers, to produce genetically modified cancer (e.g., a leukemia, lymphoma or solid tumor) stem cells, and to prepare cDNA libraries and microarrays of polynucleotides and polypeptides from cancer (e.g., a leukemia, lymphoma or solid tumor) stem cells.

In its several aspects, the present invention provides methods for screening for anti-cancer agents; for the testing of anti-cancer therapies; for the development of drugs targeting pathways (e.g., the PI3 kinase pathway or novel pathways); for the identification of new anti-cancer therapeutic targets (e.g., cancer stem cell targets); the identification and diagnosis of cancerous (e.g., malignant) cells in pathology specimens; for the testing and assaying of cancer (e.g., a leukemia, lymphoma or solid tumor) stem cell drug sensitivity; for the measurement of specific factors that predict drug sensitivity; and for the screening (e.g., diagnostic screening) of patients (e.g., in combination with other diagnostic methods (e.g., mammography)). The present invention can be used as a model to diagnose or test the sensitivity of a patient's cancer (e.g., a leukemia, lymphoma or solid tumor) to known therapies; as a model for identification of new therapeutic targets for cancer treatment; as a system to establish a tumor bank for testing new therapeutic agents for treatment of cancer; and as a system to identify tumorigenic cancer cells (e.g., cancer stem cells). Also, the present invention provides compositions and methods that can be used in combination with existing compositions and methods (e.g., cancer databases (e.g., genomic databases of solid tumors (e.g., breast cancer tumors) or leukemias or lymphomas)), for improved discovery of anti-cancer agents.

The present invention is based, in part, upon an alternative model of cancer cell heterogeneity, in which a cancer (e.g., a leukemia, lymphoma or solid tumor) results from a “cancer stem cell” (e.g., a leukemia stem cell, lymphoma stem cell or solid tumor stem cell) and/or the chaotic development of the cancer stem cell. In this stem cell model (See FIG. 1B), a cancer (e.g., a leukemia, lymphoma or solid tumor) contains a distinct, limited (or possibly rare) subset of cells that share many properties of normal “stem cells.” For example, cancer stem cells may be characterized as cancer cells that proliferate extensively or indefinitely and/or that give rise to additional cancer stem cells. For example, within an established cancer, most cells do not possess the ability to proliferate extensively or to form new cancer (e.g., new tumors). However, cancer stem cells possess the ability to proliferate extensively and to give rise to additional cancer stem cells as well as other cancer cells (e.g., those that do not possess tumorigenic potential). In this model, it is the cancer stem cell population that proliferates and is responsible for morbidity and mortality.

The ability to isolate and analyze cell populations within a cancer (e.g., a leukemia, lymphoma or solid tumor) based upon features (e.g., cell surface, structural, gene expression or activation (e.g., of a signaling pathway) status features) of cancer stem cells described herein, allows one (e.g., one skilled in the art of oncology, stem cell biology molecular biology or other field related to the present invention) to distinguish between various cancer models (e.g., the two models shown in FIGS. 1A and 1B). In some embodiments, the present invention provides cancer (e.g., a leukemia, lymphoma or solid tumor) stem cells and isolated cell populations from cancers (e.g., that can be used for drug screening, expression, diagnostic, and other assays). As demonstrated herein, cancer stem cells are responsible for clonogenic expansion found in cancers. Furthermore, the present invention demonstrates that altering (e.g., inhibiting) cell signaling pathways (e.g., the PI3 kinase pathway) and altering (e.g., inhibiting) component parts of pathways (e.g., mTOR) inhibits (e.g., eradicates or inhibits growth of) cancer stem cells while concurrently having no detrimental effect on (e.g., does not kill or inhibit growth of and/or promotes growth of) normal stem cells (See Example 6).

During development, most cells (e.g., cells of most tissues, blood cells, etc) are derived from normal precursors, called stem cells (See, e.g., Morrison et al., Cell 88(3): 287-98 (1997); Morrison et al., Curr. Opin. Immunol. 9(2): 216-21 (1997); Morrison et al., Annu. Rev. Cell. Dev. Biol. 11: 35-71 (1995)). The term “stem cell” is known in the art to mean (1) that the cell is a cell capable of generating one or more kinds of progeny with reduced proliferative or developmental potential; (2) that the cell has extensive proliferative capacity; and/or (3) that the cell is capable of self-renewal or self-maintenance (See, e.g., Potten et al., Development 110: 1001 (1990); U.S. Pat. Nos. 5,750,376, 5,851,832, 5,753,506, 5,589,376, 5,824,489, 5,654,183, 5,693,482, 5,672,499, and 5,849,553, each of which is herein incorporated by reference in its entirety). In adult animals, some cells (e.g., cells of the blood, gut epithelium, breast ductal system, and skin) are constantly replenished from a small population of stem cells in each tissue. Thus, the maintenance of cells and tissues (e.g., during normal life or in response to injury and disease) depends upon the replenishing of the cells and tissues from precursor cells in response to specific developmental signals.

One of the best characterized examples of adult cell renewal by the differentiation of stem cells is the hematopoietic system (See, e.g., U.S. Pat. Nos. 5,061,620, 5,087,570, 5,643,741, 5,821,108, 5,914,108, each of which is herein incorporated by reference in its entirety). Developmentally immature precursors (e.g., hematopoietic stem and progenitor cells) respond to molecular signals to gradually form the varied blood and lymphoid cell types. Stem cells are also found in other tissues, including epithelial tissues (See, e.g., Slack, Science 287: 1431 (2000)) and mesenchymal tissues. (See, e.g., U.S. Pat. No. 5,942,225; herein incorporated by reference in its entirety). Stem cells found in various tissues give rise to various progeny cells. For example, in normal breast development, a normal stem cell gives rise to differentiated progeny to form a normal ductal system (See, e.g., Kordon and Smith, Development 125: 1921-1930 (1998); U.S. Pat. Nos. 5,814,511 and 5,650,317, each of which is herein incorporated by reference in its entirety).

The principles of normal stem cell biology have been applied to isolate and characterize cancer stem cells. Examples of cancers from which cancer stem cells can be isolated or enriched for according to the present invention include, but are not limited to, lymphomas (e.g., Hodgkin's disease and non-Hodgkin's disease), leukemias (e.g., acute leukemia, acute lymphocytic leukemia, acute myelocytic leukemia, myeloblastic, promyelocytic, myelomonocytic, monocytic, erythroleukemia, chronic leukemia, chronic myelocytic, (granulocytic) leukemia, and chronic lymphocytic leukemia), and sarcomas and carcinomas (e.g., fibrosarcoma, myxosarcoma, liposarcoma, chondrosarcoma, osteogenic sarcoma, chordoma, angiosarcoma, endotheliosarcoma, lymphangiosarcoma, lymphangioendotheliosarcoma, synovioma, mesothelioma, Ewing's tumor, leiomyosarcoma, rhabdomyosarcoma, colon carcinoma, pancreatic cancer, breast cancer, ovarian cancer, prostate cancer, squamous cell carcinoma, basal cell carcinoma, adenocarcinoma, sweat gland carcinoma, sebaceous gland carcinoma, papillary carcinoma, papillary adenocarcinomas, cystadenocarcinoma, medullary carcinoma, bronchogenic carcinoma, renal cell carcinoma, hepatoma, bile duct carcinoma, choriocarcinoma, seminoma, embryonal carcinoma, Wilms' tumor, cervical cancer, testicular tumor, lung carcinoma, small cell lung carcinoma, bladder carcinoma, epithelial carcinoma, glioma, astrocytoma, medulloblastoma, craniopharyngioma, ependymoma, pinealoma, hemangioblastoma, acoustic neuroma, oligodendroglioma, meningioma, melanoma, neuroblastoma, and retinoblastoma). The invention is also applicable to sarcomas and epithelial cancers, such as ovarian cancers and breast cancers, as well as to all solid tumors.

Cancer stem cells are defined structurally and functionally as described herein (e.g., using methods and assays described herein). Because cancer cells are known to evolve phenotypically and functionally over time as additional genetic mutations occur, cancer stem cells may change phenotypically and functionally over time in an individual patient. Nonetheless, one can use a method of the present invention (e.g., employing one or more markers disclosed or identified by the methods described herein) for consistently isolating or identifying cancer (e.g., solid tumor, lymphoma or leukemia) stem cells (e.g., using a panel of biomarkers to identify, isolate or enrich a population of cells (e.g., Flk-2⁻Sca-1⁺Lin⁻CD48⁻ckit⁺ cells, or Mac-1⁺B220⁻CD3⁻ myeloid cells or CD3⁺Mac-1⁻/B220⁺Mac-1⁻ lymphoid cells) (See Examples 1 and 3). In some embodiments, the present invention provides a cancer stem cell biomarker or a panel of biomarkers for identification of stem cells. In some embodiments, the presence or absence of a cancer stem cell biomarker of the present invention is used to identify or characterize a cancer in a subject. In some embodiments, a cancer stem cell biomarker of the present invention is used in combination with one or more other markers to identify or characterize a cancer in a subject.

Methods of identifying, isolating and enriching for cancer (e.g., leukemia or lymphoma) stem cells using biomarkers of the present invention can be carried out according to methods described in U.S. Pat. App. Nos. 20050158857, 20050089518, 20040037815, and WO 05/005601, each of which is hereby incorporated by reference in its entirety for all purposes.

In some embodiments, the present invention provides compositions and methods utilizing markers identified by the methods of the present invention for the treatment and/or prevention of cancer. For example, in some embodiments, Pten expression is restored (e.g., via therapeutic agents comprising PTEN or agents that mimic PTEN function) in a host resulting in the killing of cancerous (e.g., leukemic) stem cells, or, alternatively, in neutralizing the rapid growth of these cells.

Although an understanding of the mechanism is not necessary to practice the present invention and the present invention is not limited to any particular mechanism of action, it is contemplated that cancer stem cells undergo “self-renewal” and “differentiation” in a chaotic development to form a cancer (e.g., a tumor), give rise to abnormal cell types, and may change over time as additional mutations occur. Functional features of the cancer stem cells identified and characterized by the present invention comprise being tumorigenic, the ability to give rise to additional tumorigenic cells (“self-renew”), and the ability to give rise to non-tumorigenic cells (“differentiation”).

The developmental origin of cancer stem cells can vary between different types of cancers. For example, although an understanding of the mechanism is not necessary to practice the present invention and the present invention is not limited to any particular mechanism of action, cancer stem cells may arise as a result of genetic damage that deregulates the proliferation and differentiation of normal stem cells (See, e.g., Lapidot et al., Nature 367: 645-648 (1994)) or by the dysregulated proliferation of a normal restricted progenitor or a normal differentiated cell type.

By contrast, a non-tumorigenic cell from a cancer (e.g., a solid tumor or leukemic cell population) is a cell from a population that fails to form a cancer (e.g., a hematopoietic malignancy or a palpable tumor) upon transplantation into an immunocompromised mouse, wherein if the same number of unfractionated, dissociated cancer cells were transplanted under the same circumstances, the cancer stem cells would form a cancer (e.g., a leukemia or palpable tumor) in the same period of time. Thus non-tumorigenic cells are depleted for cancer (e.g., tumor) forming activity in an animal model;

Because the carcinogenic changes are intrinsic to cancer stem cells, even after they have been removed from their normal environment (e.g., from within a tumor), the invention provides several novel uses, for example:
(1) by identifying genes, proteins and pathways (e.g., PTEN or PI3 kinase pathway) expressed or activated by or within cancer stem cells it is possible to identify genes, proteins and pathways whose function is important (e.g., necessary) for carcinogenesis and therefore represent novel drug targets;
(2) by purifying cancer stem cells based on phenotypic markers (e.g., cancer stem cell biomarker) it is possible to study cancer stem cell gene expression patterns and functional properties much more directly and efficiently;
(3) by developing in vitro and in vivo assays of cancer stem cell function it is possible to more effectively test the effects of potential therapeutic compounds (e.g., existing compounds (e.g., compounds in a library of compounds), compounds in clinical trials, etc.);
(4) by identifying biomarkers of cancer stem cells it is possible to more effectively diagnose (e.g., identify) and/or characterize a cancer (e.g., malignant cells (e.g., those that do not depend on rare environmental characteristics for their ability to make tumors)); and
(5) by isolating cancer stem cells from individual patients and transplanting them into in vitro and in vivo functional assays it is possible to test the effectiveness of different drug regimens against them (e.g., it is possible to predict drug sensitivity and drug resistance).

One of the major problems in identifying new cancer therapeutic agents is determining which of the myriad of genes identified in large scale sequencing projects are the most clinically important drug targets. This is made especially difficult since cancers (e.g., solid tumors) comprise of a mixture of a many types of normal cells and a heterogeneous population of tumor cells. One way to reduce the complexity is to make cDNA from cancerous tissue (e.g., after microdissection of solid tumors) to enrich for cancer cells. This technique is based on the assumption that the pathologist dissecting cancers (e.g., tumor cells) can predict which cells are carcinogenic based upon appearance. However, cells can be morphologically similar and yet remain functionally heterogeneous. Moreover, cells obtained by microdissection are not viable and therefore the functional properties of such cells cannot be tested or verified.

Instead, according to the methods of the present invention, one can use assays (e.g., flow cytometry (e.g., fluorescent activated cell sorting (FACS)) and other methods (e.g., transplanting (e.g., xenografting))) to enrich for specific cancer cell populations (e.g. cancer stem cells, See Examples 1-2). These techniques have the advantage of being able to simultaneously isolate phenotypically pure populations of viable normal and tumor cells for molecular analysis. Thus, methods of the present invention allows testing of the functions of cell populations and use of the cell populations in biological assays in addition to studying cell population gene expression profiles. Furthermore, specific cell populations can be characterized in biological assays. For example, mesenchymal (e.g., stromal) cells can be analyzed for production of growth factors, matrix proteins and proteases, endothelial cells can be analyzed for production of specific factors involved in solid tumor growth support (e.g., tested for expression of neo-vascularization agents), and different subsets of cancer cells can be isolated and analyzed for tumorigenicity, drug resistance and metastatic potential.

Purification (e.g., enrichment or isolation) of subsets of cancer cells (e.g., from a solid tumor) allows one to distinguish between classic models of cancers and the cancer stem cell models shown in FIG. 1. For example, if a minority of cancer cells have stem cell properties then it would be possible to efficiently identify the genes necessary for tumor proliferation and drug resistance (e.g., the genomic expression of the minority of cancer cells that possess stem cell properties could be focused on (e.g., the cancer stem cell population)). If, however, screening methods (e.g., genomic and therapeutic methods) are targeted to the bulk population (e.g., rather than to the minority population of cancer stem cells), then the most promising drug targets may be obscured or lost (e.g., in a sea of other genes expressed by the other cells within a cancer (e.g., a tumor) that do not have the capacity for extensive proliferation).

Focusing on the individual populations of cells within a cancer (e.g., in a solid tumor) enables an understanding of how to focus the generation of new cancer treatments and how to identify novel targets for drug discovery. In addition, the purification of cancer stem cells provided by the present invention provides compositions (e.g., cancer stem cells) for screening for drug sensitivity and identifying markers that predict tumorigenicity or metastatic potential.

In some embodiments, the present invention provides the in vivo proliferation of cancer stem cells. The in vivo proliferation of cancer stem cells can be accomplished by injection of cancer stem cells into animals, preferably mammals, more preferably in rodents such as mice (e.g., into C57BL/Ka-CD45.1:Thy-1.2 mice described in Example 1), or into immunocompromised mice, such as SCID mice, Beige/SCID mice or NOD/SCID mice. Mice can be injected with a varying number of cells and observed for cancer (e.g., tumor) formation (See, e.g., Examples 3, 4 and 6). The injection can be by any method known in the art.

Subjects (e.g., the mice described above) can be injected with cancer stem cells and observed for cancer formation (e.g., leukemia, lymphoma or solid tumors (See, e.g., U.S. Pat. App. No. 20040037815, herein incorporated by reference in its entirety for all purposes). Any cancers (e.g., tumors or myoproliferative disease) that form can be analyzed (e.g., tumors can be removed for pathologic examination and FACS analysis, or by using criteria summarized in Table 1 of Example 2). Tests can be repeated (e.g., about 3, 5, 7, 10 or more times) to confirm the results. The phenotypes of the tumorigenic cells can thus be determined.

Other general techniques for formulation and injection of cells may be found in Remington's Pharmaceutical Sciences, 20th ed. (Mack Publishing Co., Easton, Pa.). Suitable routes may include parenteral delivery, including intramuscular, subcutaneous, intramedullary injections, as well as intrathecal, direct intraventricular, intravenous, intraperitoneal, intranasal, or intraocular injections, just to name a few. For injection, the agents of the invention may be formulated in aqueous solutions, preferably in physiologically compatible buffers such as Hanks's solution, Ringer's solution, or physiological saline buffer. For such transmucosal administration, penetrants appropriate to the barrier to be permeated are used in the formulation. Such penetrants are generally known in the art.

A subject's (e.g., a particular cancer patient's) cancer stem cells (e.g., once isolated and allowed to proliferate in vitro), can be analyzed and screened. For example, in some embodiments, analyzing a subject's cancer stem cells is used as a diagnostic for the subject (e.g., the identification of biomarkers present within the cancer cells can be used to provide to the subject a prognosis (e.g., of morbidity or mortality associated with the cancer, or, the likelihood of the cancer to respond to a therapeutic treatment).

Thus, in some embodiments, the present invention provides methods for detection of expression of cancer stem cell biomarkers In some embodiments, expression is measured directly (e.g., at the nucleic acid or protein level). In some embodiments, expression is detected in tissue samples (e.g., biopsy tissue). In other embodiments, expression is detected in bodily fluids (e.g., including but not limited to, plasma, serum, whole blood, mucus, and urine). The present invention further provides panels and kits for the detection of biomarkers. In preferred embodiments, the presence of a cancer stem cell biomarker is used to provide a prognosis to a subject. For example, the detection of a cancer stem cell biomarker in cancerous tissues may be indicative of a cancer that is or is not likely to metastasize. In addition, the expression level of a cancer stem cell biomarker may be indicative of a transformed cell, cancerous tissue or a cancer likely to metastasize.

The information provided can also be used to direct the course of treatment. For example, if a subject is found to possess or lack a cancer stem cell biomarker that is likely to metastasize, therapies can be chosen to optimize the response to treatment (e.g., for subjects with a high probability of possessing a metastatic cancer more aggressive forms of treatment can be used).

Cancer stem cell biomarkers identified as being up or down-regulated in cancer stem cells using the methods of the present invention are further characterized using microarray (e.g., nucleic acid or tissue microarray), immunohistochemistry, Northern blot analysis, siRNA or antisense RNA inhibition, mutation analysis, investigation of expression with clinical outcome, as well as other methods disclosed herein.

In some embodiments, the present invention provides a panel for the analysis of a plurality of biomarkers. The panel allows for the simultaneous analysis of multiple biomarkers correlating with carcinogenesis, metastasis and/or angiogenesis associated with cancer. For example, a panel may include biomarkers identified as correlating with cancerous tissue, metastatic cancer, localized cancer that is likely to metastasize, pre-cancerous tissue that is likely to become cancerous, pre-cancerous tissue that is not likely to become cancerous, and cancerous tissues or cells likely or not likely to respond to treatment. Depending on the subject, panels may be analyzed alone or in combination in order to provide the best possible diagnosis and prognosis. Markers for inclusion on a panel are selected by screening for their predictive value using any suitable method, including but not limited to, those described in the illustrative examples below.

In other embodiments, the present invention provides an expression profile map comprising expression profiles of cancer stem cells (e.g., of various stages or progeny) or prognoses (e.g., likelihood to respond to treatment or likelihood of future metastasis). Such maps can be used for comparison with patient samples. Any suitable method may be utilized, including but not limited to, by computer comparison of digitized data. The comparison data is used to provide diagnoses and/or prognoses to patients.

In some preferred embodiments, cancer stem cell biomarkers (e.g., including but not limited to, those disclosed herein) are detected by measuring the levels of the cancer stem cell biomarker in cells and tissue (e.g., cancer cells and tissues). For example, in some embodiments, a cancer stem cell biomarker are monitored using antibodies (e.g., antibodies generated according to methods described below) or by detecting a cancer stem cell biomarker protein. In some embodiments, detection is performed on cells or tissue after the cells or tissues are removed from the subject. In other embodiments, detection is performed by visualizing the cancer stem cell biomarker in cells and tissues residing within the subject.

In some preferred embodiments, cancer stem cell biomarker are detected by measuring the expression of corresponding mRNA in a tissue sample (e.g., cancerous tissue).

In some embodiments, RNA is detected by Northern blot analysis. Northern blot analysis involves the separation of RNA and hybridization of a complementary labeled probe.

In still further embodiments, RNA (or corresponding cDNA) is detected by hybridization to a oligonucleotide probe. A variety of hybridization assays using a variety of technologies for hybridization and detection are available. For example, in some embodiments, a TaqMan assay (PE Biosystems, Foster City, Calif.; See e.g., U.S. Pat. Nos. 5,962,233 and 5,538,848, each of which is herein incorporated by reference) is utilized. The assay is performed during a PCR reaction. The TaqMan assay exploits the 5′-3′ exonuclease activity of the AMPLITAQ GOLD DNA polymerase. A probe consisting of an oligonucleotide with a 5′-reporter dye (e.g., a fluorescent dye) and a 3′-quencher dye is included in the PCR reaction. During PCR, if the probe is bound to its target, the 5′-3′ nucleolytic activity of the AMPLITAQ GOLD polymerase cleaves the probe between the reporter and the quencher dye. The separation of the reporter dye from the quencher dye results in an increase of fluorescence. The signal accumulates with each cycle of PCR and can be monitored with a fluorimeter.

In yet other embodiments, reverse-transcriptase PCR (RT-PCR) is used to detect the expression of RNA. In RT-PCR, RNA is enzymatically converted to complementary DNA or “cDNA” using a reverse transcriptase enzyme. The cDNA is then used as a template for a PCR reaction. PCR products can be detected by any suitable method, including but not limited to, gel electrophoresis and staining with a DNA specific stain or hybridization to a labeled probe. In some embodiments, the quantitative reverse transcriptase PCR with standardized mixtures of competitive templates method described in U.S. Pat. Nos. 5,639,606, 5,643,765, and 5,876,978 (each of which is herein incorporated by reference) is utilized.

In other embodiments, gene expression of a cancer stem cell biomarker is detected by measuring the expression of the corresponding protein or polypeptide. Protein expression may be detected by any suitable method. In some embodiments, proteins are detected by immunohistochemistry. In other embodiments, proteins are detected by their binding to an antibody raised against the protein. The generation of antibodies is described below.

Antibody binding is detected by techniques known in the art (e.g., radioimmunoassay, ELISA (enzyme-linked immunosorbant assay), “sandwich” immunoassays, immunoradiometric assays, gel diffusion precipitation reactions, immunodiffusion assays, in situ immunoassays (e.g., using colloidal gold, enzyme or radioisotope labels, for example), Western blots, precipitation reactions, agglutination assays (e.g., gel agglutination assays, hemagglutination assays, etc.), complement fixation assays, immunofluorescence assays, protein A assays, and immunoelectrophoresis assays, etc.

In one embodiment, antibody binding is detected by detecting a label on the primary antibody. In another embodiment, the primary antibody is detected by detecting binding of a secondary antibody or reagent to the primary antibody. In a further embodiment, the secondary antibody is labeled. Many methods are known in the art for detecting binding in an immunoassay and are within the scope of the present invention.

In some embodiments, an automated detection assay is utilized. Methods for the automation of immunoassays include those described in U.S. Pat. Nos. 5,885,530, 4,981,785, 6,159,750, and 5,358,691, each of which is herein incorporated by reference. In some embodiments, the analysis and presentation of results is also automated. For example, in some embodiments, software that generates a prognosis based on the presence or absence of a series of proteins corresponding to cancer markers is utilized.

In other embodiments, the immunoassay described in U.S. Pat. Nos. 5,599,677 and 5,672,480; each of which is herein incorporated by reference.

In yet other embodiments, the present invention provides kits for the detection and characterization of cancer stem cell biomarkers. In some preferred embodiments, the kit contains cancer stem cells. In some embodiments, the kits contain antibodies specific for a cancer stem cell biomarker, in addition to detection reagents and buffers. In other embodiments, the kits contain reagents specific for the detection of mRNA or cDNA (e.g., oligonucleotide probes or primers). In preferred embodiments, the kits contain all of the components necessary to perform a detection assay, including all controls, directions for performing assays, and any necessary software for analysis and presentation of results.

In some embodiments, in vivo imaging techniques are used to visualize the expression of a cancer stem cell biomarker in an animal (e.g., a human or non-human mammal). For example, in some embodiments, a cancer stem cell biomarker mRNA or protein is labeled using an labeled antibody specific for the cancer stem cell biomarker. A specifically bound and labeled antibody can be detected in an individual using an in vivo imaging method, including, but not limited to, radionuclide imaging, positron emission tomography, computerized axial tomography, X-ray or magnetic resonance imaging method, fluorescence detection, and chemiluminescent detection. Methods for generating antibodies to the cancer stem cell biomarkers of the present invention are described herein.

The in vivo imaging methods of the present invention are useful in the diagnosis of cancers that express a cancer stem cell biomarker of the present invention (e.g., cancerous cells or tissue). In vivo imaging is used to visualize the presence of a biomarker indicative of a cancer stem cell. Such techniques allow for diagnosis without the use of a biopsy. The in vivo imaging methods of the present invention are also useful for providing prognoses to cancer patients. For example, the presence of a cancer stem cell biomarker indicative of an aggressive cancer likely to metastasize or likely to respond to a certain treatment can be detected. The in vivo imaging methods of the present invention can further be used to detect a cancer stem cell (e.g., one that has metastasized) in other parts of the body.

In some embodiments, reagents (e.g., antibodies) specific for a cancer stem cell biomarker of the present invention are fluorescently labeled. The labeled antibodies are introduced into a subject (e.g., orally or parenterally). Fluorescently labeled antibodies are detected using any suitable method (e.g., using the apparatus described in U.S. Pat. No. 6,198,107, herein incorporated by reference).

In some embodiments, flow-cytometry is utilized to monitor (e.g., detect) a marker (e.g., a cancer stem cell biomarker of the present invention) (See, e.g., Example 1). The use of flow-cytometry to identify and/or isolate and/or purify cell populations is well known in the art (See, e.g., Givan, Methods Mol Biol 263, 1-32 (2004)).

In other embodiments, antibodies are radioactively labeled. The use of antibodies for in vivo diagnosis is well known in the art. Sumerdon et al., (Nucl. Med. Biol 17:247-254 (1990) have described an optimized antibody-chelator for the radioimmunoscintographic imaging of tumors using Indium-111 as the label. Griffin et al., (J Clin One 9:631-640 (1991)) have described the use of this agent in detecting tumors in patients suspected of having recurrent colorectal cancer. The use of similar agents with paramagnetic ions as labels for magnetic resonance imaging is known in the art (Lauffer, Magnetic Resonance in Medicine 22:339-342 (1991)). The label used will depend on the imaging modality chosen. Radioactive labels such as Indium-111, Technetium-99m, or Iodine-131 can be used for planar scans or single photon emission computed tomography (SPECT). Positron emitting labels such as Fluorine-19 can also be used for positron emission tomography (PET). For MRI, paramagnetic ions such as Gadolinium (III) or Manganese (II) can be used.

Radioactive metals with half-lives ranging from 1 hour to 3.5 days are available for conjugation to antibodies, such as scandium-47 (3.5 days) gallium-67 (2.8 days), gallium-68 (68 minutes), technetiium-99m (6 hours), and indium-111 (3.2 days), of which gallium-67, technetium-99m, and indium-111 are preferable for gamma camera imaging, gallium-68 is preferable for positron emission tomography.

A useful method of labeling antibodies with such radiometals is by means of a bifunctional chelating agent, such as diethylenetriaminepentaacetic acid (DTPA), as described, for example, by Khaw et al. (Science 209:295 (1980)) for In-111 and Tc-99m, and by Scheinberg et al. (Science 215:1511 (1982)). Other chelating agents may also be used, but the 1-(p-carboxymethoxybenzyl) EDTA and the carboxycarbonic anhydride of DTPA are advantageous because their use permits conjugation without affecting the antibody's immunoreactivity substantially.

Another method for coupling DPTA to proteins is by use of the cyclic anhydride of DTPA, as described by Hnatowich et al. (Int. J. Appl. Radiat. Isot. 33:327 (1982)) for labeling of albumin with In-111, but which can be adapted for labeling of antibodies. A suitable method of labeling antibodies with Tc-99m which does not use chelation with DPTA is the pretinning method of Crockford et al., (U.S. Pat. No. 4,323,546, herein incorporated by reference).

A preferred method of labeling immunoglobulins with Tc-99m is that described by Wong et al. (Int. J. Appl. Radiat. Isot., 29:251 (1978)) for plasma protein, and recently applied successfully by Wong et al. (J. Nucl. Med., 23:229 (1981)) for labeling antibodies. In the case of the radiometals conjugated to the specific antibody, it is likewise desirable to introduce as high a proportion of the radiolabel as possible into the antibody molecule without destroying its immunospecificity. A further improvement may be achieved by effecting radiolabeling in the presence of the specific cancer stem cell biomarker of the present invention, to insure that the antigen binding site on the antibody will be protected. The antigen is separated after labeling.

In still further embodiments, in vivo biophotonic imaging (Xenogen, Almeda, Calif.) is utilized for in vivo imaging. This real-time in vivo imaging utilizes luciferase. The luciferase gene is incorporated into cells, microorganisms, and animals (e.g., as a fusion protein with a cancer biomarker of the present invention). When active, it leads to a reaction that emits light. A CCD camera and software is used to capture the image and analyze it.

The present invention provides isolated antibodies. In preferred embodiments, the present invention provides monoclonal antibodies that specifically bind to either an isolated polypeptide comprised of at least five amino acid residues of a cancer stem cell biomarker. These antibodies find use in the diagnostic methods described herein.

An antibody against a biomarker of the present invention may be any monoclonal or polyclonal antibody, as long as it can recognize the cancer stem cell biomarker. Antibodies can be produced by using a cancer stem cell biomarker of the present invention as the antigen according to a conventional antibody or antiserum preparation process.

The present invention contemplates the use of both monoclonal and polyclonal antibodies. Any suitable method may be used to generate the antibodies used in the methods and compositions of the present invention, including but not limited to, those disclosed herein. For example, for preparation of a monoclonal antibody, a cancer stem cell biomarker, as such, or together with a suitable carrier or diluent is administered to an animal (e.g., a mammal) under conditions that permit the production of antibodies. For enhancing the antibody production capability, complete or incomplete Freund's adjuvant may be administered. Normally, the cancer stem cell biomarker is administered once every 2 weeks to 6 weeks, in total, about 2 times to about 10 times. Animals suitable for use in such methods include, but are not limited to, primates, rabbits, dogs, guinea pigs, mice, rats, sheep, goats, etc.

For preparing monoclonal antibody-producing cells, an individual animal whose antibody titer has been confirmed (e.g., a mouse) is selected, and 2 days to 5 days after the final immunization, its spleen or lymph node is harvested and antibody-producing cells contained therein are fused with myeloma cells to prepare the desired monoclonal antibody producer hybridoma. Measurement of the antibody titer in antiserum can be carried out, for example, by reacting the labeled protein, as described hereinafter and antiserum and then measuring the activity of the labeling agent bound to the antibody. The cell fusion can be carried out according to known methods, for example, the method described by Koehler and Milstein (Nature 256:495 (1975)). As a fusion promoter, for example, polyethylene glycol (PEG) or Sendai virus (HVJ), preferably PEG is used.

Examples of myeloma cells include NS-1, P3U1, SP2/0, AP-1 and the like. The proportion of the number of antibody producer cells (spleen cells) and the number of myeloma cells to be used is preferably about 1:1 to about 20:1. PEG (preferably PEG 1000-PEG 6000) is preferably added in concentration of about 10% to about 80%. Cell fusion can be carried out efficiently by incubating a mixture of both cells at about 20° C. to about 40° C., preferably about 30° C. to about 37° C. for about 1 minute to 10 minutes.

Various methods may be used for screening for a hybridoma producing the antibody (e.g., against a cancer stem cell biomarker of the present invention). For example, where a supernatant of the hybridoma is added to a solid phase (e.g., microplate) to which antibody is adsorbed directly or together with a carrier and then an anti-immunoglobulin antibody (if mouse cells are used in cell fusion, anti-mouse immunoglobulin antibody is used) or Protein A labeled with a radioactive substance or an enzyme is added to detect the monoclonal antibody against the protein bound to the solid phase. Alternately, a supernatant of the hybridoma is added to a solid phase to which an anti-immunoglobulin antibody or Protein A is adsorbed and then the protein labeled with a radioactive substance or an enzyme is added to detect the monoclonal antibody against the protein bound to the solid phase.

Selection of the monoclonal antibody can be carried out according to any known method or its modification. Normally, a medium for animal cells to which HAT (hypoxanthine, aminopterin, thymidine) are added is employed. Any selection and growth medium can be employed as long as the hybridoma can grow. For example, RPMI 1640 medium containing 1% to 20%, preferably 10% to 20% fetal bovine serum, GIT medium containing 1% to 10% fetal bovine serum, a serum free medium for cultivation of a hybridoma (SFM-101, Nissui Seiyaku) and the like can be used. Normally, the cultivation is carried out at 20° C. to 40° C., preferably 37° C. for about 5 days to 3 weeks, preferably 1 week to 2 weeks under about 5% CO₂ gas. The antibody titer of the supernatant of a hybridoma culture can be measured according to the same manner as described above with respect to the antibody titer of the anti-protein in the antiserum.

Separation and purification of a monoclonal antibody (e.g., against a cancer stem cell biomarker of the present invention) can be carried out according to the same manner as those of conventional polyclonal antibodies such as separation and purification of immunoglobulins, for example, salting-out, alcoholic precipitation, isoelectric point precipitation, electrophoresis, adsorption and desorption with ion exchangers (e.g., DEAE), ultracentrifugation, gel filtration, or a specific purification method wherein only an antibody is collected with an active adsorbent such as an antigen-binding solid phase, Protein A or Protein G and dissociating the binding to obtain the antibody.

Polyclonal antibodies may be prepared by any known method or modifications of these methods including obtaining antibodies from patients. For example, a complex of an immunogen (an antigen against the protein) and a carrier protein is prepared and an animal is immunized by the complex according to the same manner as that described with respect to the above monoclonal antibody preparation. A material containing the antibody is recovered from the immunized animal and the antibody is separated and purified.

As to the complex of the immunogen and the carrier protein to be used for immunization of an animal, any carrier protein and any mixing proportion of the carrier and a hapten can be employed as long as an antibody against the hapten, which is crosslinked on the carrier and used for immunization, is produced efficiently. For example, bovine serum albumin, bovine cycloglobulin, keyhole limpet hemocyanin, etc. may be coupled to an hapten in a weight ratio of about 0.1 part to about 20 parts, preferably, about 1 part to about 5 parts per 1 part of the hapten.

In addition, various condensing agents can be used for coupling of a hapten and a carrier. For example, glutaraldehyde, carbodiimide, maleimide activated ester, activated ester reagents containing thiol group or dithiopyridyl group, and the like find use with the present invention. The condensation product as such or together with a suitable carrier or diluent is administered to a site of an animal that permits the antibody production. For enhancing the antibody production capability, complete or incomplete Freund's adjuvant may be administered. Normally, the protein is administered once every 2 weeks to 6 weeks, in total, about 3 times to about 10 times.

The polyclonal antibody is recovered from blood, ascites and the like, of an animal immunized by the above method. The antibody titer in the antiserum can be measured according to the same manner as that described above with respect to the supernatant of the hybridoma culture. Separation and purification of the antibody can be carried out according to the same separation and purification method of immunoglobulin as that described with respect to the above monoclonal antibody.

The protein (e.g., cancer stem cell biomarker) used herein as the immunogen is not limited to any particular type of immunogen. For example, a cancer stem cell biomarker of the present invention (further including a gene having a nucleotide sequence partly altered) can be used as the immunogen. Further, fragments of the protein may be used. Fragments may be obtained by any method including, but not limited to expressing a fragment of the gene, enzymatic processing of the protein, chemical synthesis, and the like.

Cancer stem cells proliferated in vitro can also be genetically modified using techniques known in the art (See, e.g., Sambrook et al., Molecular Cloning: A Laboratory Manual (Cold Spring Harbor Press, Cold Spring Harbor, N.Y., 1989); Current Protocols in Molecular Biology, Ausubel et al., eds., (Wiley Interscience, New York, 1993)). For example, in vitro genetic modification may be more desirable in certain circumstances than in vivo genetic modification techniques when more control over the infection with the genetic material is required.

In some embodiments, the present invention provides genetic modification of cancer stem cells and cancer stem cell progeny. In an undifferentiated state, cancer stem cells divide and are therefore excellent targets for genetic modification. As used herein, the terms “genetic modification” or “genetically modified” refer to stable or transient alteration of the genotype of a precursor cell by intentional introduction of exogenous DNA. DNA may be synthetic, or naturally derived, and may contain genes, portions of genes, or other useful DNA sequences. General methods for the genetic modification of eukaryotic cells are known in the art (See, e.g., Sambrook et al., Molecular Cloning: A Laboratory Manual (Cold Spring Harbor Press, Cold Spring Harbor, N.Y., 1989); Current Protocols in Molecular Biology, Ausubel et al., eds., (Wiley Interscience, New York, 1993)).

Many methods for introducing vectors into cells or tissues are available and equally suitable for use with cancer stem cells (e.g., in vivo, in vitro, and ex vivo). It is well known that vectors may be introduced into hematopoietic stem cells taken from a patient and clonally propagated. Thus, in some embodiments, the present invention provides methods of introducing vectors (e.g., expression vectors comprising one or more sequences of interest (e.g., a sequence encoding a gene) into cancer stem cells.

“Transformation,” or “genetically modified” as defined herein, describes a process by which exogenous DNA enters and changes a recipient cell. Transformation may occur under natural or artificial conditions according to various methods well known in the art, and may rely on any known method for the insertion of foreign nucleic acid sequences into a prokaryotic or eukaryotic host cell. The method for transformation is selected based on the type of host cell being transformed and may include, but is not limited to, viral infection, electroporation, heat shock, lipofection, and particle bombardment. The term “transformed” cells includes stably transformed cells in which the inserted DNA is capable of replication either as an autonomously replicating plasmid or as part of the host chromosome, as well as transiently transformed cells which express the inserted DNA or RNA for limited periods of time.

Genetic manipulation of primary tumor cells has been described previously (See,e Patel et al., Human Gene Therapy 5: 577-584 (1994)). Genetic modification of a cell may be accomplished using one or more techniques well known in the gene therapy field (See, e.g., Mulligan R C, Human Gene Therapy 5: 543-563 (1993)). Viral transduction methods may comprise the use of a recombinant DNA or an RNA virus comprising a nucleic acid sequence that drives or inhibits expression of a protein to infect a target cell. A suitable DNA virus for use in the present invention includes but is not limited to an adenovirus (Ad), adeno-associated virus (AAV), herpes virus, vaccinia virus or a polio virus. A suitable RNA virus for use in the present invention includes but is not limited to a retrovirus or Sindbis virus. Several such DNA and RNA viruses exist that may be suitable for use in the present invention.

Adenoviral vectors have proven especially useful for gene transfer into eukaryotic cells for vaccine development (See, e.g., Graham F L & Prevec L, In Vaccines: New Approaches to Immunological Problems, Ellis R V ed., 363-390 (Butterworth-Heinemann, Boston, 1992)).

Specific guidance for the genetic modification of cancer stem cells is provides in U.S. Pat. App. No. 20040037815 (e.g., in EXAMPLE 13 and FIGS. 15-18), herein incorporated by reference in its entirety for all purposes.

“Non-viral” delivery techniques that have been used or proposed for introduction of exogenous nucleic acid into a foreign cell or host and include DNA-ligand complexes, adenovirus-ligand-DNA complexes, direct injection of DNA, CaPO₄ precipitation, gene gun techniques, electroporation, and lipofection (See, e.g., Mulligan R C, Science 260: 926-932 (1993)). Any of these methods are widely available to one skilled in the art and would be suitable for use in the present invention. Other suitable methods are available to one skilled in the art, and it is to be understood that the present invention may be accomplished using any of the available methods of transfection. Lipofection may be accomplished by encapsulating an isolated DNA molecule within a liposomal particle and contacting the liposomal particle with the cell membrane of the target cell. Liposomes are self-assembling, colloidal particles in which a lipid bilayer, composed of amphiphilic molecules such as phosphatidyl serine or phosphatidyl choline, encapsulates a portion of the surrounding media such that the lipid bilayer surrounds a hydrophilic interior. Unilammellar or multilammellar liposomes can be constructed such that the interior contains a desired chemical, drug, or an isolated DNA molecule. Delivery by transfection, by liposome injections, or by polycationic amino polymers may be achieved using methods which are well known in the art (See, e.g., Goldman, C. K. et al. Nature Biotechnology 15:462-466 (1997)).

Two types of modified (e.g., genetically modified) cancer stem cells of particular interest are deletion mutants and over-expression mutants. Deletion mutants are wild-type cells that have been modified genetically so that a single gene, usually a protein-coding gene, is substantially deleted. Deletion mutants also include mutants in which a gene has been disrupted so that usually no detectable mRNA or bioactive protein is expressed from the gene, even though some portion of the genetic material may be present. In addition, in some embodiments, mutants with a deletion or mutation that removes or inactivates one activity of a protein (often corresponding to a protein domain) that has two or more activities, are used and are encompassed in the term “deletion mutants.” Over-expression mutants are wild-type cells that are modified genetically so that at least one gene, most often only one, in the modified cancer stem cell is expressed at a higher level as compared to a cell in which the gene is not modified.

Genetically modified cancer stem cells can be subjected to tissue culture protocols known in the art (See, e.g., U.S. Pat. Nos. 5,750,376 and 5,851,832, Spector et al., Cells: A Laboratory Manual (Cold Spring Harbor Press, Cold Spring Harbor, N.Y., 1998)). Cancer stem cells can be genetically modified in vitro (e.g., in culture) to promote differentiation, cell death, or immunogenicity. For example, cancer stem cells can be modified to enhance expression of products that direct an immune response against the patient's cancer. Alternatively, the cancer stem cells can be subjected to various proliferation protocols in vitro prior to genetic modification. The protocol used depends upon the type of genetically modified cancer stem cell or cancer stem cell progeny desired. Once the cells have been subjected to the differentiation protocol, they can be assayed for expression of the desired protein.

Cancer stem cells and cancer stem cell progeny cultured in vitro or in vivo (e.g., in a recipient subject (e.g., See Examples 5 and 6)) can be used for screening and identifying test compounds (e.g., small molecule inhibitors, pharmaceuticals, etc.) that can be used in or as an anti-cancer therapeutic The ability to assay test compounds in vivo provided by the present invention (See Example 6) provides the ability to monitor the effect of test compounds on both the normal HSC population and cancer stem cell population within a subject. For example, after introduction of cancer stem cells to a recipient mouse, cancer stem cell survival, ability to form tumors, and biochemical and immunological characteristics can be examined.

Test compounds can be applied to cancer stem cells (e.g., in vivo or in vitro) at varying dosages, and the response of these cells monitored (e.g., over various time periods). Physical characteristics of these cells can be analyzed by observing cells by microscopy. The induction of expression of new or increased levels of proteins such as enzymes, receptors and other cell surface molecules can be analyzed with any technique known in the art (See, e.g., Clarke et al., Proc. Natl. Acad. Sci. USA 92: 11024-11028 (1995) that can identify the alteration of the level of such molecules). The techniques and methods described above for detection of cancer stem cell biomarkers find use in detecting gene and protein expression induced by test compound treatment.

Cancer stem cells of the present invention can be used to determine the effect of test compounds (e.g., small molecule inhibitors, pharmaceuticals, biological agents, etc.). Examples of test compounds include, but are not limited to, carbohydrates, monosaccharides, oligosaccharides, polysaccharides, amino acids, peptides, oligopeptides, polypeptides, proteins, nucleosides, nucleotides, oligonucleotides, polynucleotides, including DNA and DNA fragments, RNA and RNA fragments and the like, lipids, retinoids, steroids, drug, antibody, prodrug, glycopeptides, glycoproteins, proteoglycans and the like, and synthetic analogues or derivatives thereof, including peptidomimetics, small molecule organic compounds and the like, and mixtures thereof (e.g., that is a candidate for use to treat or prevent a disease, illness, sickness, or disorder of bodily function (e.g., cancer (e.g., cancer stem cell growth)). Test compounds comprise both known and potential therapeutic compounds. A test compound can be determined to be therapeutic by screening using the screening methods of the present invention.

To determine the effect of a test compound on cancer stem cells, cancer stem cells can be obtained from a subject with cancer (See, e.g., Examples 1-7). Once obtained, cancer stem cells can be cultured in vitro or in vivo (See, e.g., Example 6) and exposed to a test compound.

The ability of test compounds to alter (e.g., increase or decrease) cancer stem cell growth or maintenance, as well as the effect on normal HSCs, can be assayed. For example, in some embodiments, test compounds (e.g., from a library of compounds) are screened for their ability to alter (e.g., eliminate or inhibit growth of) cancer stem cells, while concurrently monitoring the effect on HSCs (e.g., driving HSCs into quiescence). Screening in this way permits the identification of compounds that can be utilized (e.g., independently, in a pharmaceutical composition, or co-administered) for treating cancer (e.g., inhibiting or eliminating cancer stem cells while having no harmful effect on normal HSCs).

In some embodiments, test compounds can be solubilized and added to cancer stem cells (e.g., in vitro (e.g., in the culture medium), or, in vivo (e.g., to a recipient subject that has received a cancer stem cell graft)). In some embodiments, various concentrations of the test compound are utilized to determine an efficacious dose. In some embodiments, administration of the test compound is consistent over a period of time (e.g., administered to a recipient one, two or more times a day, or, added to media in vitro) so as to keep the concentration of the test compound constant.

Alteration (e.g., inhibiting growth or promoting death or permitting maintenance) of cancer stem cells, and normal stem cells, can be monitored in vitro or in vivo. For example, an increase or decrease in the number of cancer cells (e.g., cancer stem cell progeny) that form or an increase or decrease in the size of the foci in vitro, or growth rate of cancer cells (e.g., cancer stem cell progeny can be monitored (See Examples 3-7). The effect of a test compound on cancer stem cells and normal HSCs can be measured by determining the number of cancer stem cells that persist in culture or in vivo after treatment (e.g., administration of the test compound). In addition, cancer stem cell and HSC status (e.g., cell cycle status, cancer stem cell biomarker expression, etc.) can be determined (e.g., using compositions and methods described herein).

Test compounds can be administered in vitro or in vitro at a variety of concentrations. For example, in some embodiments, test compounds are added to culture medium or to a subject so as to achieve a concentration from about 10 pg/ml to 1 μg/ml, or from about 1 ng/ml (or 1 ng/cc of blood) to 100 ng/ml (or 100 ng/cc of blood).

The effects of a test compound can also be identified on the basis of a significant difference relative to a control regarding criteria such as the ratios of expressed phenotypes, cell viability, proliferation rate, number of cancer stem cells, cancer stem cell activity upon transplantation in vivo, cancer stem cell activity upon transplantation in culture, cell cycle distribution of cancer cells, and alterations in gene expression.

The test compounds of the present invention can be obtained using any of the numerous approaches in combinatorial library methods known in the art, including biological libraries; peptoid libraries (libraries of molecules having the functionalities of peptides, but with a novel, non-peptide backbone, which are resistant to enzymatic degradation but which nevertheless remain bioactive (See, e.g., Zuckennann et al., J. Med. Chem. 37: 2678-85 (1994)); spatially addressable parallel solid phase or solution phase libraries; synthetic library methods requiring deconvolution; the ‘one-bead one-compound’ library method; and synthetic library methods using affinity chromatography selection. The biological library and peptoid library approaches are preferred for use with peptide libraries, while the other four approaches are applicable to peptide, non-peptide oligomer or small molecule libraries of compounds (Lam (1997) Anticancer Drug Des. 12:145).

Examples of methods for the synthesis of molecular libraries can be found in the art, for example in: DeWitt et al., Proc. Natl. Acad. Sci. U.S.A. 90:6909 (1993); Erb et al., Proc. Nad. Acad. Sci. USA 91:11422 (1994); Zuckermann et al., J. Med. Chem. 37:2678 (1994); Cho et al., Science 261:1303 (1993); Carrell et al., Angew. Chem. Int. Ed. Engl. 33.2059 (1994); Carell et al., Angew. Chem. Int. Ed. Engl. 33:2061 (1994); and Gallop et al., J. Med. Chem. 37:1233 (1994), each of which is incorporated by reference herein in its entirety.

Alternatively, the test compound libraries employed in this invention may be prepared or obtained by any means including, but not limited to, combinatorial chemistry techniques, fermentation methods, plant and cellular extraction procedures and the like. Methods for making combinatorial libraries are well-known in the art (See, e.g., E. R. Felder, Chimia 1994, 48, 512-541; Gallop et al., J. Med. Chem. 1994, 37, 1233-1251; R. A. Houghten, Trends Genet. 1993, 9, 235-239; Houghten et al., Nature 1991, 354, 84-86; Lam et al., Nature 1991, 354, 82-84; Carell et al., Chem. Biol. 1995, 3, 171-183; Madden et al., Perspectives in Drug Discovery and Design 2, 269-282; Cwirla et al., Biochemistry 1990, 87, 6378-6382; Brenner et al., Proc. Natl. Acad. Sci. USA 1992, 89, 5381-5383; Gordon et al., J. Med. Chem. 1994, 37, 1385-1401; Lebl et al., Biopolymers 1995, 37 177-198; and references cited therein. Each of these references is incorporated herein by reference in its entirety).

Libraries of test compounds may be presented in solution (e.g., Houghten, Biotechniques 13:412-421 (1992)), or on beads (Lam, Nature 354:82-84 (1991)), chips (Fodor, Nature 364:555-556 (1993)), bacteria or spores (U.S. Pat. No. 5,223,409; herein incorporated by reference), plasmids (Cull et al., Proc. Nad. Acad. Sci. USA 89:18651869 (1992)) or on phage (Scott and Smith, Science 249:386-390 (1990); Devlin Science 249:404-406 (1990); Cwirla et al., Proc. NatI. Acad. Sci. 87:6378-6382 (1990); Felici, J. Mol. Biol. 222:301 (1991)).

In addition to active ingredients, test compounds may comprise suitable pharmaceutically acceptable carriers comprising excipients and auxiliaries, that facilitate processing of the active compounds into preparations which can be used pharmaceutically.

In some embodiments, an assay is a cell-based assay in which a cell that expresses or is capable of generating a cancer stem cell biomarker is contacted with a test compound, and the ability of the test compound to modulate a cancer stem cell biomarker's presence, expression or activity is determined. Determining the ability of the test compound to modulate a cancer stem cell biomarker presence, expression or activity can be accomplished by monitoring, for example, changes in enzymatic activity or downstream products of expression.

The ability of the test compound to modulate a cancer stem cell biomarker binding to a compound, e.g., a cancer stem cell biomarker substrate or binding partner, can also be evaluated (e.g. the ability of Pten binding to a substrate). This can be accomplished, for example, by coupling the compound, e.g., the substrate or binding partner, with a radioisotope or enzymatic label such that binding of the compound, e.g., the substrate, to a cancer stem cell biomarker can be determined by detecting the labeled compound, e.g., substrate, in a complex.

Alternatively, a cancer stem cell biomarker can be coupled with a radioisotope or enzymatic label to monitor the ability of a test compound to modulate cancer stem cell biomarker binding to a cancer stem cell biomarker's substrate in a complex. For example, compounds (e.g., substrates) can be labeled with ¹²⁵I, ³⁵S ¹⁴C or ³H, either directly or indirectly, and the radioisotope detected by direct counting of radioemmission or by scintillation counting. Alternatively, compounds can be enzymatically labeled with, for example, horseradish peroxidase, alkaline phosphatase, or luciferase, and the enzymatic label detected by determination of conversion of an appropriate substrate to product.

The ability of a compound (e.g., a cancer stem cell biomarker substrate) to interact with a cancer stem cell biomarker with or without the labeling of any of the interactants can be evaluated. For example, a microphysiometer can be used to detect the interaction of a compound with a cancer stem cell biomarker without the labeling of either the compound or the cancer stem cell biomarker (McConnell et al. Science 257:1906-1912 (1992)). As used herein, a “microphysiometer” (e.g., Cytosensor) is an analytical instrument that measures the rate at which a cell acidifies its environment using a light-addressable potentiometric sensor (LAPS). Changes in this acidification rate can be used as an indicator of the interaction between a compound and a cancer stem cell biomarker.

In yet another embodiment, a cell-free assay is provided in which a cancer stem cell biomarker protein, or biologically active portion thereof, or nucleic acid is contacted with a test compound and the ability of the test compound to bind to the cancer stem cell biomarker protein, or biologically active portion thereof, or nucleic acid is evaluated. Preferred biologically active portions of the cancer stem cell biomarker proteins to be used in assays of the present invention include fragments that participate in interactions with substrates or other proteins, e.g., fragments with high surface probability scores.

Cell-free assays involve preparing a reaction mixture of the target gene protein and the test compound under conditions and for a time sufficient to allow the two components to interact and bind, thus forming a complex that can be removed and/or detected.

The interaction between two molecules (e.g., a cancer stem cell biomarker protein and a compound) can also be detected, e.g., using fluorescence energy transfer (FRET) (see, for example, Lakowicz et al., U.S. Pat. No. 5,631,169; Stavrianopoulos et al., U.S. Pat. No. 4,968,103; each of which is herein incorporated by reference). A fluorophore label is selected such that a first donor molecule's emitted fluorescent energy will be absorbed by a fluorescent label on a second, ‘acceptor’ molecule, which in turn is able to fluoresce due to the absorbed energy.

Alternately, the ‘donor’ molecule may simply utilize the natural fluorescent energy of tryptophan residues. Labels are chosen that emit different wavelengths of light, such that the ‘acceptor’ molecule label may be differentiated from that of the ‘donor’. Since the efficiency of energy transfer between the labels is related to the distance separating the molecules, the spatial relationship between the molecules can be assessed. In a situation in which binding occurs between the molecules, the fluorescent emission of the ‘acceptor’ molecule label in the assay should be maximal. A FRET binding event can be conveniently measured through standard fluorometric detection means well known in the art (e.g., using a fluorimeter).

In another embodiment, determining the ability of a cancer stem cell biomarker to bind to a target molecule can be accomplished using real-time Biomolecular Interaction Analysis (BIA) (see, e.g., Sjolander and Urbaniczky, Anal. Chem. 63:2338-2345 (1991) and Szabo et al. Curr. Opin. Struct. Biol. 5:699-705 (1995)). “Surface plasmon resonance” or “BIA” detects biospecific interactions in real time, without labeling any of the interactants (e.g., BIAcore). Changes in the mass at the binding surface (e.g., indicative of a binding event) result in alterations of the refractive index of light near the surface (the optical phenomenon of surface plasmon resonance (SPR)), resulting in a detectable signal that can be used as an indication of real-time reactions between biological molecules.

In one embodiment, the target gene product or the test substance is anchored onto a solid phase. The target gene product/test compound complexes anchored on the solid phase can be detected at the end of the reaction. Preferably, the target gene product can be anchored onto a solid surface, and the test compound, that is not anchored, can be labeled, either directly or indirectly, with detectable labels discussed herein.

It may be desirable to immobilize a cancer stem cell biomarker, an anti-cancer stem cell biomarker antibody or its target molecule to facilitate separation of complexed from non-complexed forms of one or both of the molecules, as well as to accommodate automation of the assay. Binding of a test compound to a cancer stem cell biomarker (e.g., protein or nucleic acid), or interaction of a cancer stem cell biomarker with a target molecule in the presence and absence of a candidate compound, can be accomplished in any vessel suitable for containing the reactants. Examples of such vessels include microtiter plates, test tubes, and micro-centrifuge tubes.

For example, in one embodiment, a fusion protein can be provided which adds a domain that allows one or both of the molecules to be bound to a matrix. For example, glutathione-S-transferase-cancer stem cell biomarker fusion proteins or glutathione-S-transferase/target fusion proteins can be adsorbed onto glutathione Sepharose beads (Sigma Chemical, St. Louis, Mo.) or glutathione-derivatized microtiter plates, which are then combined with the test compound or the test compound and either the non-adsorbed target protein or cancer stem cell biomarker, and the mixture incubated under conditions conducive for complex formation (e.g., at physiological conditions for salt and pH). Following incubation, the beads or microtiter plate wells are washed to remove any unbound components, the matrix immobilized in the case of beads, complex determined either directly or indirectly, for example, as described above.

Alternatively, the complexes can be dissociated from the matrix, and the level of cancer biomarkers binding or activity determined using standard techniques. Other techniques for immobilizing either cancer stem cell biomarker molecule (e.g., nucleic acid or protein) or a target molecule on matrices include using conjugation of biotin and streptavidin. Biotinylated cancer biomarker or target molecules can be prepared from biotin-NHS(N-hydroxysuccinimide) using techniques known in the art (e.g., biotinylation kit, Pierce Chemicals, Rockford, EL), and immobilized in the wells of streptavidin-coated 96 well plates (Pierce Chemical).

In order to conduct the assay, the non-immobilized component is added to the coated surface containing the anchored component. After the reaction is complete, unreacted components are removed (e.g., by washing) under conditions such that any complexes formed will remain immobilized on the solid surface. The detection of complexes anchored on the solid surface can be accomplished in a number of ways. Where the previously non-immobilized component is pre-labeled, the detection of label immobilized on the surface indicates that complexes were formed. Where the previously non-immobilized component is not pre-labeled, an indirect label can be used to detect complexes anchored on the surface; e.g., using a labeled antibody specific for the immobilized component (the antibody, in turn, can be directly labeled or indirectly labeled with, e.g., a labeled anti-IgG antibody).

This assay is performed utilizing antibodies reactive with a cancer stem cell biomarker or target molecules but which do not interfere with binding of the cancer stem cell biomarker to its target molecule. Such antibodies can be derivatized to the wells of the plate, and unbound target or cancer stem cell biomarker trapped in the wells by antibody conjugation. Methods for detecting such complexes, in addition to those described above for the GST-immobilized complexes, include immunodetection of complexes using antibodies reactive with the cancer stem cell biomarker or target molecule, as well as enzyme-linked assays which rely on detecting an enzymatic activity associated with the cancer stem cell biomarker or target molecule.

Alternatively, cell free assays can be conducted in a liquid phase. In such an assay, the reaction products are separated from unreacted components, by any of a number of standard techniques, including, but not limited to: differential centrifugation (see, for example, Rivas and Minton, Trends Biochem Sci 18:284-7 (1993)); chromatography (gel filtration chromatography, ion-exchange chromatography); electrophoresis (see, e.g., Ausubel et al., eds. Current Protocols in Molecular Biology 1999, J. Wiley: New York.); and immunoprecipitation (see, for example, Ausubel et al., eds. Current Protocols in Molecular Biology 1999, J. Wiley: New York). Such resins and chromatographic techniques are known to one skilled in the art (See e.g., Heegaard J. Mol. Recognit 11:141-8 (1998); Hageand Tweed J. Chromatogr. Biomed. Sci. Appl 699:499-525 (1997)). Further, fluorescence energy transfer may also be conveniently utilized, as described herein, to detect binding without further purification of the complex from solution.

The assay can include contacting the cancer stem cell biomarker protein, or biologically active portion thereof, or nucleic acid with a known compound that binds the cancer stem cell biomarker to form an assay mixture, contacting the assay mixture with a test compound, and determining the ability of the test compound to interact with a cancer stem cell biomarker, wherein determining the ability of the test compound to interact with a cancer stem cell biomarker includes determining the ability of the test compound to preferentially bind to cancer stem cell biomarker protein, or biologically active portion thereof, or nucleic acid, or to modulate the activity of a target molecule, as compared to the known compound.

To the extent that a cancer stem cell biomarker can, in vivo, interact with one or more cellular or extracellular macromolecules, such as proteins, inhibitors of such an interaction are useful. A homogeneous assay can be used to identify inhibitors.

For example, a preformed complex of the target gene product and the interactive cellular or extracellular binding partner product is prepared such that either the target gene products or their binding partners are labeled, but the signal generated by the label is quenched due to complex formation (see, e.g., U.S. Pat. No. 4,109,496, herein incorporated by reference, that utilizes this approach for immunoassays). The addition of a test substance that competes with and displaces one of the species from the preformed complex will result in the generation of a signal above background. In this way, test substances that disrupt target gene product-binding partner interaction can be identified. Alternatively, a cancer stem cell biomarker can be used as a “bait” in a two-hybrid assay or three-hybrid assay (see, e.g., U.S. Pat. No. 5,283,317; Zervos et al., Cell 72:223-232 (1993); Madura et al., J. Biol. Chem. 268.12046-12054 (1993); Bartel et al., Biotechniques 14:920-924 (1993); Iwabuchi et al., Oncogene 8:1693-1696 (1993); and Brent WO 94/10300; each of which is herein incorporated by reference), to identify proteins that bind to or interact with a cancer stem cell biomarker (“cancer stem cell biomarker-binding proteins” or “cancer stem cell biomarker-bp”) and are involved in cancer stem cell biomarker activity. Such cancer stem cell biomarker-bps can be activators or inhibitors of signals by the cancer stem cell biomarker or targets as, for example, downstream elements of a cancer stem cell biomarker-mediated signaling pathway (e.g. PI3 kinase pathway).

Modulators of cancer stem cell biomarker expression can also be identified. For example, a cell or cell free mixture can be contacted with a candidate compound and the expression of cancer stem cell biomarker nucleic acid (e.g., Pten DNA or mRNA) or protein evaluated relative to the level of expression of cancer stem cell biomarker nucleic acid (e.g., DNA or mRNA) or protein in the absence of the candidate compound. When expression of cancer stem cell biomarker nucleic acid (e.g., DNA or mRNA) or protein is greater in the presence of the candidate compound than in its absence, the candidate compound is identified as a stimulator of cancer stem cell biomarker nucleic acid (e.g., DNA or mRNA) or protein expression. Alternatively, when expression of cancer stem cell biomarker nucleic acid (e.g., DNA or mRNA) or protein is less (i.e., statistically significantly less) in the presence of the candidate compound than in its absence, the candidate compound is identified as an inhibitor of cancer stem cell biomarker nucleic acid (e.g., DNA or mRNA) or protein expression. The level of cancer stem cell biomarker nucleic acid (e.g., DNA or mRNA) or protein expression can be determined by methods described herein for detecting cancer stem cell biomarker nucleic acid (e.g., DNA or mRNA) or protein.

A modulating agent can be identified using a cell-based or a cell free assay, and the ability of the agent to modulate the activity of a cancer stem cell biomarker nucleic acid (e.g., DNA or mRNA) or protein can be confirmed in vivo, e.g., in an animal such as an animal model for a disease (e.g., an animal with cancer or metastatic cancer; or an animal harboring a xenograft of a cancer stem cells from an animal (e.g., human) or cells from a cancer resulting from metastasis of a cancer (e.g., to a lymph node, bone, or liver), or cells from a cancer cell line.

This invention further pertains to novel agents identified by the above-described screening assays. Accordingly, it is within the scope of this invention to further use an agent identified as described herein (e.g., a test compound that: eliminates or inhibits growth of a cancer stem cell while leaving unharmed (e.g., inducing quiescence of) normal stem cells; acts as a cancer stem cell biomarker modulating agent; an antisense cancer stem cell biomarker nucleic acid molecule; a siRNA molecule; a cancer stem cell biomarker specific antibody; or a cancer stem cell biomarker-binding partner) in an appropriate animal model (such as those described herein) to determine the efficacy, toxicity, side effects, or mechanism of action, of treatment with such an agent. Furthermore, novel agents identified by the above-described screening assays can be, e.g., used for treatments as described herein.

It is contemplated that pharmaceutical compositions comprising a successfully identified test compound (e.g., a test compound identified that is capable of altering (e.g., inhibiting growth or eliminating) cancer stem cells while concurrently not harming (e.g., inducing quiescence of) normal HSCs), analogue or mimetic can be administered systemically or locally to alter cancer stem cell growth and induce cancer (e.g., tumor) cell death in cancer patients. It is not intended that the present invention be limited by the particular route of administration. Indeed, a variety of administrative routes are contemplated to be useful in the present invention including, but not limited to, intravenously, intrathecally, intramuscularly, intraperitoneally as well as orally. Moreover, they can be administered alone or in combination with anti-proliferative drugs.

Where combinations are contemplated, it is not intended that the present invention be limited by the particular nature of the combination. The present invention contemplates combinations as simple mixtures as well as chemical hybrids. An example of the latter is where a peptide or drug is covalently linked to a targeting carrier or to an active pharmaceutical. Covalent binding can be accomplished by any one of many commercially available crosslinking compounds.

It is not intended that the present invention be limited by the particular nature of the therapeutic preparation. For example, such compositions can be provided together with physiologically tolerable liquid, gel or solid carriers, diluents, adjuvants and excipients.

These therapeutic preparations can be administered to mammals for veterinary use, such as with domestic animals, and clinical use in humans in a manner similar to other therapeutic agents. In general, the dosage required for therapeutic efficacy will vary according to the type of use and mode of administration, as well as the particularized requirements of individual hosts.

Such compositions are typically prepared as liquid solutions or suspensions, or in solid forms. Oral formulations for cancer usually will include such normally employed additives such as binders, fillers, carriers, preservatives, stabilizing agents, emulsifiers, buffers and excipients as, for example, pharmaceutical grades of mannitol, lactose, starch, magnesium stearate, sodium saccharin, cellulose, magnesium carbonate, and the like. These compositions take the form of solutions, suspensions, tablets, pills, capsules, sustained release formulations, or powders, and typically contain 1%-95% of active ingredient, preferably 2%-70%.

The compositions are also prepared as injectables, either as liquid solutions or suspensions; solid forms suitable for solution in, or suspension in, liquid prior to injection may also be prepared.

The compositions of the present invention are often mixed with diluents or excipients which are physiological tolerable and compatible. Suitable diluents and excipients are, for example, water, saline, dextrose, glycerol, or the like, and combinations thereof. In addition, if desired the compositions may contain minor amounts of auxiliary substances such as wetting or emulsifying agents, stabilizing or pH buffering agents.

Additional formulations which are suitable for other modes of administration, such as topical administration, include salves, tinctures, creams, lotions, and, in some cases, suppositories. For salves and creams, traditional binders, carriers and excipients may include, for example, polyalkylene glycols or triglycerides.

It may be desirable to administer an analogue of a successfully identified test compound (e.g., a test compound identified that is capable of altering (e.g., inhibiting growth or eliminating) cancer stem cells while concurrently not harming (e.g., inducing quiescence of) normal HSCs). A variety of designs for such mimetics are possible. For example, cyclic peptides, in which the necessary conformation for binding is stabilized by nonpeptides, are specifically contemplated. (See, e.g., U.S. Pat. No. 5,192,746 to Lobl et al., U.S. Pat. No. 5,169,862 to Burke, Jr. et al., U.S. Pat. No. 5,539,085 to Bischoff et al., U.S. Pat. No. 5,576,423 to Aversa et al., U.S. Pat. No. 5,051,448 to Shashoua, and U.S. Pat. No. 5,559,103 to Gaeta et al., all hereby incorporated by reference, describe multiple methods for creating such compounds).

Synthesis of nonpeptide compounds that mimic peptide sequences is also known in the art. For example, Eldred et al., J. Med. Chem. 37:3882 (1994), describe nonpeptide antagonists that mimic the Arg-Gly-Asp sequence. Likewise, Ku et al., J. Med. Chem. 38:9 (1995) give further elucidation of the synthesis of a series of such compounds. Such nonpeptide compounds are specifically contemplated by the present invention.

The present invention also contemplates synthetic mimicking compounds that are multimeric compounds that repeat the relevant peptide sequence. As is known in the art, peptides can be synthesized by linking an amino group to a carboxyl group that has been activated by reaction with a coupling agent, such as dicyclohexyl-carbodiimide (DCC). The attack of a free amino group on the activated carboxyl leads to the formation of a peptide bond and the release of dicyclohexylurea. It may be important to protect potentially reactive groups other than the amino and carboxyl groups intended to react (e.g., the x-amino group of the component containing the activated carboxyl group can be blocked with a tertbutyloxycarbonyl group). This protecting group can be subsequently removed by exposing the peptide to dilute acid, which leaves peptide bonds intact.

With this method, peptides can be readily synthesized by a solid phase method by adding amino acids stepwise to a growing peptide chain that is linked to an insoluble matrix, such as polystyrene beads. The carboxyl-terminal amino acid (with an amino protecting group) of the desired peptide sequence is first anchored to the polystyrene beads. The protecting group of the amino acid is then removed. The next amino acid (with the protecting group) is added with the coupling agent. This is followed by a washing cycle. The cycle is repeated as necessary.

The methods of the present invention can be practiced in vitro, ex vivo, or in vivo.

For example, the method of the present invention can be used in vitro to screen for compounds which are potentially useful for combinatorial use with a successfully identified test compound (e.g., a test compound identified that is capable of altering (e.g., inhibiting growth or eliminating) cancer stem cells while concurrently not harming normal HSCs), for treating cancer (e.g., lymphoma, leukemia, prostate, lung, stomach, breast, colon, and/or pancreatic cancer); to evaluate a test compound's efficacy in treating cancer; or to investigate the mechanism by which a test compound combats cancer (e.g., whether it does so by inducing apoptosis, by inducing differentiation, by decreasing proliferation, etc). For example, once a compound has been identified as a compound that works (e.g., a test compound identified that is capable of altering (e.g., inhibiting growth or eliminating) cancer stem cells while concurrently not harming normal HSCs), one skilled in the art can apply the method of the present invention in vitro to evaluate the degree to which the compound induces apoptosis and/or decreases angiogenesis, proliferation of cancer cells; or one skilled in the art can apply the method of the present invention to determine whether the compound operates by inducing apoptosis, by decreasing proliferation and/or angiogenesis, or by a combination of these methods.

Alternatively, a method of the present invention can be used in vivo to treat cancers, (e.g., including, but not limited to, lymphoma, leukemia, prostate cancer, lung cancer, stomach cancer, pancreatic cancer, breast cancer, and colon cancer). In the case where a method of the present invention is carried out in vivo, for example, where the cancer cells are present in a human subject, contacting can be carried out by administering a therapeutically effective amount of the compound to the human subject (e.g., by directly injecting the compound into a tumor or through systemic administration).

The compositions herein may be made up in any suitable form appropriate for the desired use. Examples of suitable dosage forms include oral, parenteral, or topical dosage forms.

Suitable dosage forms for oral use include tablets, dispersible powders, granules, capsules, suspensions, syrups, and elixirs. Inert diluents and carriers for tablets include, for example, calcium carbonate, sodium carbonate, lactose, and talc. Tablets may also contain granulating and disintegrating agents, such as starch and alginic acid; binding agents, such as starch, gelatin, and acacia; and lubricating agents, such as magnesium stearate, stearic acid, and talc. Tablets may be uncoated or may be coated by known techniques to delay disintegration and absorption. Inert diluents and carriers which may be used in capsules include, for example, calcium carbonate, calcium phosphate, and kaolin. Suspensions, syrups, and elixirs may contain conventional excipients, for example, methyl cellulose, tragacanth, sodium alginate; wetting agents, such as lecithin and polyoxyethylene stearate; and preservatives, such as ethyl-p-hydroxybenzoate.

Dosage forms suitable for parenteral administration include solutions, suspensions, dispersions, emulsions, and the like. They may also be manufactured in the form of sterile solid compositions which can be dissolved or suspended in sterile injectable medium immediately before use. They may contain suspending or dispersing agents known in the art. Examples of parenteral administration are intraventricular, intracerebral, intramuscular, intravenous, intraperitoneal, rectal, and subcutaneous administration.

Compositions of the present invention can include active materials, particularly, actives which have been identified as useful in the treatment of cancers (e.g., leukemias, lymphomas, adenocarcinomas, etc.). These actives can be broad-based anti-cancer agents, such that they also are useful in treating more than one type of cancer or they may be more specific (e.g., in a case where the other active material is useful for treating leukemia but not useful for treating adenocarcinoma). The other actives can also have non-anti-cancer pharmacological properties in addition to their anti-cancer properties. For example, the other actives can have anti-inflammatory properties, or, alternatively, they can have no such anti-inflammatory properties.

It will be appreciated that the actual preferred amount of composition comprising a successfully identified test compound (e.g., a test compound identified that is capable of altering (e.g., inhibiting growth or eliminating) cancer stem cells while concurrently not harming (e.g., inducing quiescence of) normal HSCs), to be administered according to the present invention may vary according to the particular composition formulated, and the mode of administration (See, e.g., Example 3). Many factors that may modify the action of the compositions (e.g., body weight, sex, diet, time of administration, route of administration, rate of excretion, condition of the subject, drug combinations, and reaction sensitivities and severities) can be taken into account by those skilled in the art. Administration can be carried out continuously or periodically within the maximum tolerated dose. Optimal administration rates for a given set of conditions can be ascertained by those skilled in the art using conventional dosage administration tests.

Microarrays have become well known and extensively used in the art (See, e.g., Barinaga, Science 253: 1489 (1991); Bains, Bio/Technology 10: 757-758 (1992)). Guidance for the use of microarrays is provided by Wang, E et al., Nature Biotechnology 18; 457-459 (2000); Diehn M et al., Nature Genetics 25: 58-62 (2000).

Polynucleotides, polypeptides, or analogues are attached to a solid support or substrate, which may be made from glass, plastic (e.g., polypropylene, nylon), polyacrylamide, nitrocellulose, or other materials. “Substrate” refers to any suitable rigid or semi-rigid support to which polynucleotides or polypeptides are bound and includes membranes, filters, chips, slides, wafers, fibers, magnetic or nonmagnetic beads, gels, capillaries or other tubing, plates, polymers, and microparticles with a variety of surface forms including wells, trenches, pins, channels and pores. Polynucleotides can be immobilized on a substrate by any method known in the art.

Among the vendors of microarrays and microarray technology useage are Affymetrix, Inc. (USA), NimbleGen Systems, Inc. (Madison, Wis., USA), and Incyte Genomics (USA); Agilent Technologies (USA) and Grafinity Pharmaceutical Design, GmbH (Germany); and CLONTECH Laboratories (Becton Dickinson Bioscience) and BioRobotics, Ltd. (Great Britain) (See, e.g., Gwynne and Heebner G, Science (2001)).

In some embodiments, microarrays are utilized to monitor the expression of genes from cancer stems cells (e.g., to compare expression to normal HSCs). In some embodiments, microarrays are used to monitor the progression of disease. Differences in gene expression between healthy (e.g., normal) HSCs and cancerous tissues can be identified or monitored by analyzing changes in patterns of gene expression compared with cancer stem cells (e.g., from a subject with cancer). In some embodiments, cancer can be diagnosed at earlier stages before the patient is symptomatic. The invention can also be used to monitor the efficacy of treatment. For example, when using a treatment with known side effects, a microarray can be employed to “fine tune” the treatment regimen. A dosage is established that causes a change in genetic expression patterns indicative of successful treatment. Expression patterns associated with undesirable side effects are avoided. This approach may be more sensitive and rapid than waiting for the patient to show inadequate improvement, or to manifest side effects, before altering the course of treatment.

Alternatively, animal models that mimic a disease, rather than patients, can be used to characterize expression profiles associated with a particular disease or condition. This gene expression data may be useful in diagnosing and monitoring the course of disease in a patient, in determining gene targets for intervention, and in testing novel treatment regimens.

Microarrays can be used to rapidly screen large numbers of candidate drug molecules, looking for ones that produce an expression profile similar to those of known therapeutic drugs, with the expectation that molecules with the same expression profile will likely have similar therapeutic effects. Thus, in some embodiments, the invention provides the means to determine the molecular mode of action of a drug.

U.S. Pat. Nos. 6,218,122, 6,165,709, and 6,146,830, each of which is herein incorporated by reference in their entirties, disclose methods for identifying targets of a drug in a cell by comparing (i) the effects of the drug on a wild-type cell, (ii) the effects on a wild-type cell of modifications to a putative target of the drug, and (iii) the effects of the drug on a wild-type cell which has had the putative target modified of the drug. In various embodiments, the effects on the cell can be determined by measuring gene expression, protein abundances, protein activities, or a combination of such measurements. In various embodiments, modifications to a putative target in the cell can be made by modifications to the genes encoding the target, modification to abundances of RNAs encoding the target, modifications to abundances of target proteins, or modifications to activities of the target proteins. The present invention provides an improvement to these methods of drug discovery by providing cancer stem cells, for a more precise drug discovery program.

An “expression profile” comprises measurement of a plurality of cellular constituents that indicate aspects of the biological state of a cell. Such measurements may include, e.g., RNA or protein abundances or activity levels. Aspects of the biological state of a cell of a subject, for example, the transcriptional state, the translational state, or the activity state, are measured. The collection of these measurements, optionally graphically represented, is called the “diagnostic profile”. Aspects of the biological state of a cell which are similar to those measured in the diagnostic profile (e.g., the transcriptional state) can be measured in an analogous subject or subjects in response to a known correlated disease state or, if therapeutic efficacy is being monitored, in response to a known, correlated effect of a therapy. The collection of these measurements, optionally graphically represented, is called herein the “response profile”. The response profiles are interpolated to predict response profiles for all levels of protein activity within the range of protein activity measured. In cases where therapeutic efficacy is to be monitored, the response profile may be correlated to a beneficial effect, an adverse effect, such as a toxic effect, or to both beneficial and adverse effects.

In some embodiments, cDNAs from two different cells or two different populations of cells (one being the cancer stem cells of the invention) are hybridized to a microarray. In the case of therapeutic efficacy (e.g., in response to drugs) a cell or population of cells is exposed to a test compound and another cell or population of cells of the same type is not exposed to the therapy. In the case of disease states one cell exhibits a particular level of disease state and another cell of the same type does not exhibit the disease state (or the level thereof). In some embodiments, the cDNA derived from each of the two cell types are differently labeled so that they can be distinguished. For example, in some embodiments, cDNA from a cell treated with a test compound (or exposed to a pathway perturbation) is synthesized using a fluorescein-labeled dNTP, and cDNA from a second cell, not drug-exposed, is synthesized using a rhodamine-labeled dNTP. When the two cDNAs are mixed and hybridized to the microarray, the relative intensity of signal from each cDNA set is determined for each site on the array, and any relative difference in abundance of a particular mRNA detected. The use of a two-color fluorescence labeling and detection scheme to define alterations in gene expression has been described (See, e.g., Shena et al., Science 270:467-470 (1995)). An advantage of using cDNA labeled with two different fluorophores is that a direct and internally controlled comparison of the mRNA levels corresponding to each arrayed gene in two cell states can be made, and variations due to minor differences in experimental conditions (e.g., hybridization conditions) will not affect subsequent analyses.

U.S. Pat. No. 6,194,158, herein incorporated by reference, describes a diagnostic assay for cancer with a DNA chip of specific sequences for measuring expression levels of certain sequences within a cancer cell to determine whether expression is up- or down-regulated. The DNA chip comprising nucleotide sequences capable of hybridizing to one or more members of a panel of DNA sequences may be synthesized using commonly available techniques. mRNA is isolated from a normal, non-cancer cell and a cancer cell and hybridized to the DNA chip comprising one of more of the sequences from the panel. Hybridization is then detected by any of the available methods. In a similar manner, mRNA from a cancer stem cell that has been contacted with a compound may be hybridized to sequences on the DNA chip to determine whether that compound alters (e.g., increases or decreases) expression of a particular sequence. The present invention provides an improvement over this method, in that the “cancer cell” from which mRNA can be isolated is a cancer stem cell of the invention (e.g., isolated according to methods described in Example 1).

Gene expression profiles of purified stem cells provide insights regarding the molecular mechanisms of stem cell behavior. Terskikh A V et al. (Proc Natl Acad Sci USA 98(14): 7934-7939 (2001)) analyzed hematopoietic stem cells (HSC)-enriched cells by comparison with normal tissue and mouse neurospheres (a population greatly enriched for neural progenitor cells) by comparison with terminally differentiated neural cells, using cDNA microarray techniques and in situ hybridization, thus identifying potential regulatory gene candidates. The present invention provides an improved method of drug discovery over the methods of Terskikh, in that the use of cancer stem cells of the present invention provide a distinct set of drug targets (e.g., cancer stem cell biomarkers) when compared with a patient's normal tissue (e.g., from the area of a solid tumor) or compared with the other populations of cells obtained from the solid tumor.

Several other methods for utilizing DNA chips are known, including the methods described in U.S. Pat. Nos. 5,744,305; 5,733,729; 5,710,000; 5,631,734; 5,599,695; 5,593,839; 5,578,832; 5,556,752; 5,770,722; 5,770,456; 5,753,788; 5,688,648; 5,753,439; 5,744,306 (each of which is incorporated by reference herein in its entirety).

In some embodiments, the present invention provides high throughput screening of test compounds. For example, in some embodiments, large numbers of different test compounds (e.g., from a test compound library, described above) are provided (e.g. attached to or synthesized) on a solid substrate. Test compounds can be reacted with cancer stem cells, or portions thereof, and washed. Bound cancer stem cells are then detected by methods well known in the art, using commercially available machinery and methods (e.g., the Automated Assay Optimization (AAO) software platforms (Beckman, USA) that interface with liquid handlers to enable direct statistical analysis that optimizes the assays; modular systems from CRS Robotics Corp. Burlington, Ontario), liquid handling systems, readers, and incubators, from various companies using POLARA (CRS), an open architecture laboratory automation software for a Ultra High Throughput Screening System; 3P (Plug&Play Peripherals) technology, which is designed to allow the user to reconfigure the automation platform by plugging in new instruments (ROBOCON, Vienna, Austria); the Allegro system or STACCATO workstation (Zymark), which enables a wide range of discovery applications, including HTS, ultra HTS, and high-speed plate preparation; MICROLAB Vector software (Hamilton Co., Reno, Nev., USA) for laboratory automation programming and integration; and others).

In some embodiments, assays measure a response the target cells (cancer stem cells or genetically modified cancer stem cells) provide (e.g., detectable evidence that a test compound may be efficacious). In some embodiments, the detectable signal is compared to control cells and the detectable signal identified by subtraction analysis. The relative abundance of the differences between the “targeted” and “untargeted” aliquots can be simultaneously compared (e.g., using a “subtraction” analysis (differential analysis) technique such as differential display, representational difference analysis (RDA), GEM-Gene Expression Microarrays (U.S. Pat. No. 5,545,531), suppressive subtraction hybridization (SSH) and direct sequencing (PCT patent application WO 96/17957). The subtraction analysis can include the methods of differential display, representational differential analysis (RDA), suppressive subtraction hybridization (SSH), serial analysis of gene expression (SAGE), gene expression microarray (GEM), nucleic acid chip technology, or direct sequencing).

A cancer stem cell of the present invention is particularly useful in the drug development process because cancer stem cells provide a limited and enriched set of targets for drug development. For example, a genetically modified stem cell may contain polynucleotide with a promoter operably linked to a polynucleotide encoding a reporter polypeptide. The reporter polypeptide may be expressed in a cancer stem cell after a receptor of the cancer stem cell is activated by binding to a test compound or inactivated by binding to a test compound. Such a detectable signal makes the genetically modified cancer stem cell appropriate for use in high throughput screening (HTS).

A detectable signal can be the result of a positive selection or a negative selection. A positive selection includes manipulations that test the ability of cells to survive under specific culture conditions, ability to express a specific factor, changes in cell structure, or differential gene expression.

### EXPERIMENTAL

The following examples are provided in order to demonstrate and further illustrate certain preferred embodiments and aspects of the present invention and are not to be construed as limiting the scope thereof.

### Example 1

### Materials and Methods

Mice. All mice used in the development of the present invention were housed in the Unit for Laboratory Animal Medicine at the University of Michigan. Pten^{fl/+} mice were backcrossed for 8 generations onto the C57BL/Ka-CD45.2:Thy-1.1 background, and Mx-1-Cre mice were backcrossed for 6 generations onto the C57BL/Ka-CD45.2:Thy-1.1 background. Recipient mice in reconstitution assays were adult C57BL/Ka-CD45.1:Thy-1.2 mice.

Flow cytometry and the isolation of hematopoietic stem cells (HSCs). Bone marrow cells were flushed from long bones with Hank's buffered salt solution without calcium or magnesium, supplemented with 2% heat-inactivated calf serum (GIBCO, Grand Island, N.Y.; HBSS⁺). Cells were triturated and filtered through a nylon screen (45 μm, Sefar America, Kansas City, Mo.) to obtain a single cell suspension. Flk2⁻Sca-1⁺ Lineage⁻ c-kit⁺ CD48⁻ HSCs and Thy1.1^{low} Sca-1⁺ Mac-1^{low} CD4^{low} B220 MPPs were isolated as previously described (See, e.g., Christensen and Weissman, Proc Natl Acad Sci USA 98, 14541-6 (2001); Kiel et al., Cell 121, 1109-21 (2005); Morrison and Weissman, Immunity 1, 661-673 (1994)). For isolation of Flk2⁻Sca-1⁺ Lineage c-kit⁺ CD48⁻ HSCs, whole bone marrow cells were incubated with unconjugated monoclonal antibodies to lineage markers including B220 (6B2), CD3 (KT31.1), CD4 (GK1.5), CD5 (53-7.3), CD8 (53-6.7), Gr-1 (8C5), Mac-1 (M1/70) and Terl19. Following dilution, pelleted cells were resuspended in anti-rat IgG-specific F(ab)₂ conjugated to phycoerythrin (PE; Jackson ImmunoResearch, West Grove, Pa.). Cells were then stained with directly conjugated antibodies to Sca-1 (Ly6A/E-PC), c-kit (2B8biotin), Flk2 (A2F10-PE; eBioscience, San Diego, Calif.), and CD48 (HM48-1-FITC; BD PharMingen, San Diego, Calif.). When CD45.2⁺ HSCs were analyzed, CD45.2 (104-FITC; BD PharMingen) and CD48 (HM48-1-PE, eBioscience) were used. HSCs were often enriched by pre-selecting for c-kit+ cells using paramagnetic microbeads and autoMACS (Miltenyi Biotec, Auburn, Calif.). For isolation of Thy1.1^{low} Sca-1⁺Mac-1^{low} CD4^{low} B220 MPPs, the directly conjugated antibodies described above were combined with anti-B220-Tricolor (6B2, Caltag, Burlingame, Calif.).

Long-term Competitive Reconstitution Assays. Adult recipient mice were irradiated with an Orthovoltage X-ray source delivering approximately 300 rad/min. Recipient mice received two doses of 540 rad each, delivered 3 hours apart. When HSCs were tested for reconstituting potential, the donor (CD45.2⁺) cells were sorted and then resorted (to ensure purity) into individual wells of a 96-well plate containing 200,000 CD45.1⁺ whole bone marrow cells in HBSS⁺. The contents of individual wells were injected into the retroorbital venous sinus of irradiated CD45.1⁺ recipient mice. When whole bone marrow (WBM) cells or splenocytes were tested for reconstituting potential, the indicated dose of donor CD45.2⁺ cells was injected along with the indicated dose of CD45.1⁺ WBM into lethally irradiated CD45.1⁺ recipient mice. For at least 22 weeks after transplantation, blood was obtained from the tail veins of recipient mice, subjected to ammonium-chloride potassium red cell lysis, and stained with directly conjugated antibodies to CD45.2 (104-FITC), B220 (6B2), Mac-1 (M1/70), CD3 (KT31.1), and Gr-1 (8C5) to assess donor cell engraftment.

Cell cycle analysis. BrdU incorporation was measured by flow-cytometry (BD PharMingen). Mice were given an intraperitoneal injection of 1 mg of BrdU per 6 g of body mass in Dulbecco's phosphate buffered saline (DPBS, GIBCO) and maintained on 1 mg/ml of BrdU (Sigma, St. Louis, Mo.) in their drinking water for 19 hours (See, e.g., Cheshier et al., Proc Natl Acad Sci USA 96, 3120-3125 (1999)). For Pyronin Y/Hoechst staining, HSCs were sorted into 100% ethanol and kept on ice for 18 hours. Pelleted cells were incubated in 1 ml of Phosphate buffered saline (PBS) that contained 0.02 mg/ml of Hoechst33342 (Molecular Probes) and 0.02 mg/ml of Pyronin Y (Sigma). After 30 minutes of incubation, the pelleted cells were washed and resuspended in PBS, then analyzed by flow-cytometry.

Administration of polyinosine-polycytidine (pIpC) to induce Mx-1-Cre expression. pIpC (Sigma P-0913) was resuspended with DPBS at a concentration of 2 mg/ml and passed through a 0.22 uM filter (See, e.g., Mikkola et al., Nature 421, 54751 (2003)). Mice received 25 ug of pIpC/g of body mass every other day for 2 weeks.

Administration of Rapamycin. Rapamycin (Calbiochem and LC Laboratories) was administered by i.p. injection at the indicated doses. It was reconstituted in absolute ethanol at 10 mg/ml or 1 mg/ml and diluted in 5% Tween80 (Sigma) and 5% PEG-400 (Hampton Research) before injection.

Histopathology. Spleen, liver, and thymus samples were fixed in 10% neutral buffered formalin and paraffin embedded. Thin sections (5 μm) were cut on a microtome and stained with hematoxylin and eosin using standard protocols. Chloroacetate esterase staining was performed using a Leder stain kit (Sigma).

Annexin V and Caspase 3 staining. Annexin V was detected by flow-cytometry using Annexin V FITC antibody (BD Pharmingen) and Annexin V Binding Buffer (BD Pharmingen) as described by the manufacturer. Active caspase-3 was assessed by flow-cytometry in fixed and permeablized cells using the caspase-3 FITC-Mab apoptosis kit (BD Pharmingen).

Terminal deoxynucleotide Transferase (TdT) staining. Paraffin sections were cut on a microtome and heated for 20 minutes at 65° C. Slides were deparaffinized in xylene (3 changes of 2 minutes each) and then rehydrated through graduated ethanol treatments of 2 minutes each, ending in distilled water (100% alcohol, 95% alcohol, 70% alcohol, then water). Slides were then placed in buffer until performing immunohistochemistry. Antigen retrieval was performed by microwaving for 10 minutes in pH 6.0 citrate buffer, followed by 10 minutes cooling, and 15 minutes running water wash. Endogenous peroxidases were blocked with a 5 minute incubation in 3% hydrogen peroxide diluted in distilled water, and then rinsed in TBS-Tween (DAKO) buffer twice. Slides were then incubated for 60 minutets with TdT (polyclonal, DAKO) antibody at a 1:50 dilution. The LSAB+ kit (DAKO) was used for detection. Briefly, slides were washed with TBS-Tween buffer after incubating with primary antibody, and then incubated for 30 min with biotinylated secondary antibody (Link). Slides were washed with TBS-Tween, and then incubated for 30 min with streptavidin-HRP (Label). After this step, the slides were washed again with TBS-Tween, and then incubated with diaminobenzidine (DAB) chromagen for 5 minutes. Slides were then rinsed with water, and counterstained with hematoxylin for 1 second. Slides were dehydrated in three steps (2 minutes each step): 70% ethanol, 95% ethanol, and 100% ethanol and then treated with xylene (3 changes of 2 minutes each) and coverslips applied.

Colony-forming assay of whole bone marrow cells and HSCs. Unfractionated bone marrow cells or single flow-cytometrically sorted HSCs were plated in wells of 96-well plates (Corning, Corning, NY) containing 100 μl of complete methylcellulose medium (M3434, Stem Cell Technologies, Vancouver, BC; containing 15% FBS, 50 ng/ml rmSCF, 10 ng/ml rmIL-3, 10 ng/ml rhIL-6, 3 u/ml rhEPO). This medium was supplemented with 10 ng/ml Flt-3 (R&D Systems) and 10 ng/ml thrombopoietin (Tpo) (R&D Systems). Colonies were maintained at 37° C. in humidified chambers containing 6% CO₂. Colony formation was scored after 12-14 days of culture.

Colony-forming assay for leukemic blast cells. Fresh AML blasts from leukemic mice or cultured AML blasts were sorted into complete methylcellulose medium (M3434 Stem Cell Technologies; containing 15% FBS, 50 ng/ml rmSCF, 10 ng/ml rmIL-3, 10 ng/ml rhIL-6, 3 u/ml rhEPO) supplemented with 30 ng/ml G-CSF (Amgen, Thousand Oaks, Calif.), 10 ng/ml GM-CSF (R&D Systems), 10 ng/ml TPO, 10 ng/ml Flt3, 1% penicillin/streptomycin (Gibco). Cultured myeloid blasts were also sorted into minimal medium that contained 1% base methylcellulose (M3130, Stem Cell Technologies) supplemented with 0.1% fetal bovine serum, 1% N2 supplement (Gibco), 1% penicillin/streptomycin (Gibco), 1% BSA (Sigma, St. Louis, Mo.), 2 mM L-glutamine (Gibco), and 0.05 mM 2-mercaptoethanol. Rapamycin in absolute ethanol vehicle was added to the cultures at the indicated concentrations (vehicle, 1 nM, 10 nM, and 100 nM) in a way that ensured that all cultures were supplemented with the same amount of ethanol.

### Example 2

### Pten Deletion Leads to Myeloproliferative Disease then Leukemia

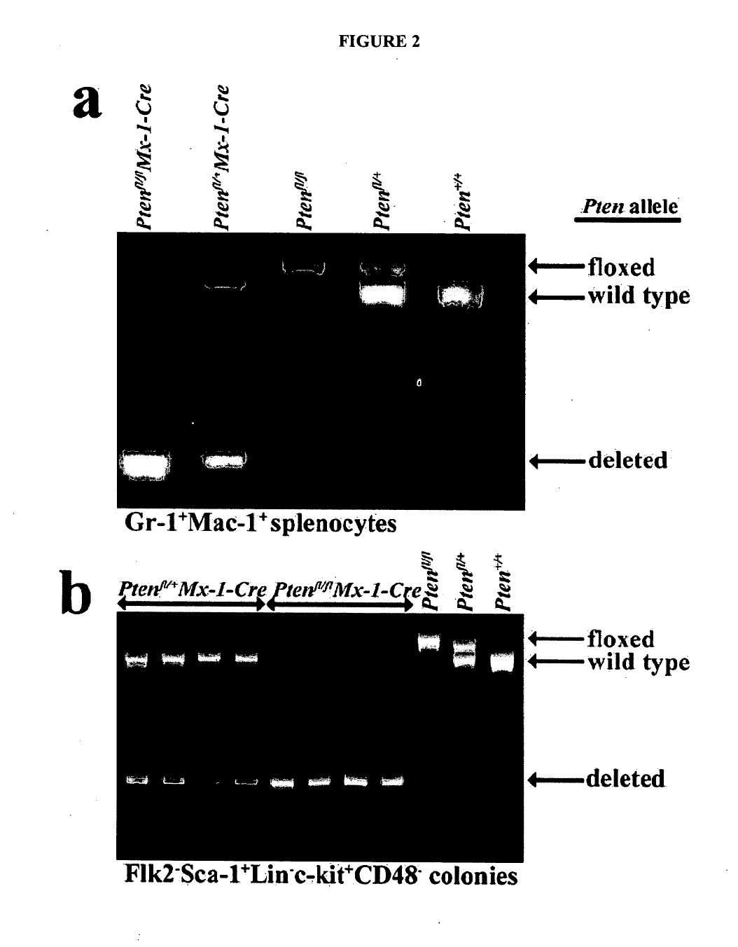

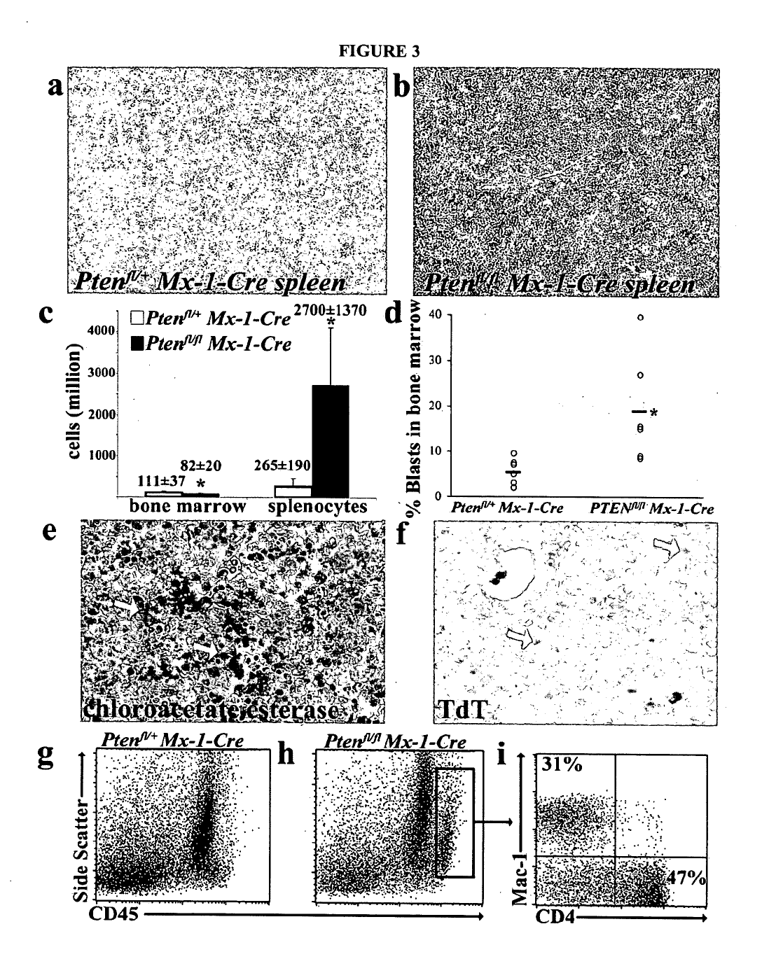

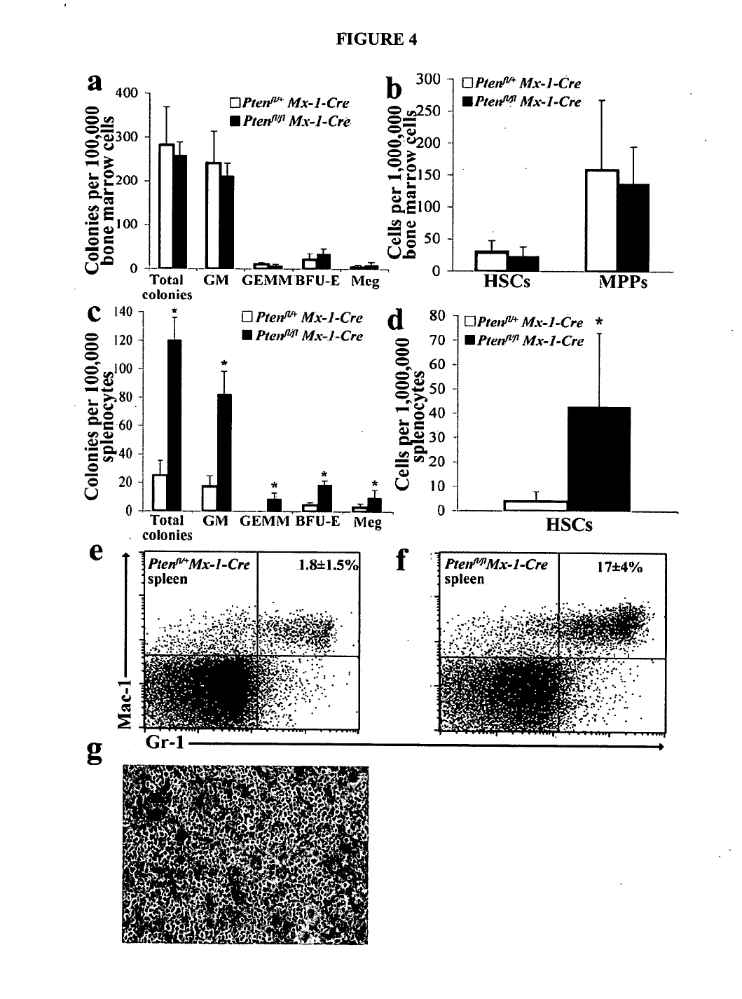

Pten was conditionally deleted from 6-8 week old Pten^{fl/fl} Mx-1-Cre mice by administering 7 doses of pIpC over a 14 day period. pIpC induces Cre expression in Mx-1-Cre mice. After 14 days, Pten appeared to be completely deleted from HSCs and other hematopoietic cells (See FIG. 2). Pten^{fl/fl} Mx-1-Cre mice, as well as littermate Pten^{fl/+} Mx-1-Cre controls, were analyzed five days after pIpC treatment. Pten^{fl/fl} Mx-1-Cre mice (17 of 19 analyzed) exhibited myeloproliferative disease marked by a 10-fold increase in spleen cellularity (See FIG. 3c), complete effacement of the splenic architecture (See FIG. 3b), a reduction in bone marrow cellularity (See FIG. 3c), a moderate increase in the frequency of blast cells in the bone marrow (See FIG. 3d), and onset of extramedullary hematopoiesis (See FIGS. 4c and 4d). In contrast, zero of 20 Pten^{fl/+} Mx-1-Cre littermates exhibited these changes after pIpC treatment. The dramatic increase in spleen cellularity in Pten^{fl/fl} Mx-1-Cre mice was largely attributable to a dramatic expansion of immature myeloid cells (See FIGS. 4e, 4f and 4g).

Although the Pten^{fl/fl} Mx-1-Cre mice exhibited a significantly increased frequency of blasts cells in their bone marrow and spleen, 5 days after pIpC treatment only 2 of 6 mice had greater than 20% blast cells in bone marrow (See FIG. 3d), a criterion that is used to distinguish myeloproliferative disease from acute myeloid leukemia (AML) (See, e.g., Kogan et al., Blood 100, 238-245 (2002)) However, the Pten^{fl/fl} Mx-1-Cre mice were clearly progressing toward both AML and acute lymphoblastic leukemia (ALL) as one of the mice that had greater than 20% blast cells five days after pIpC treatment had chloroacetate esterase (e.g., a marker of myeloid leukemia) positive blast cells in the spleen (See FIG. 3e) and terminal deoxynucleotide transferase (TdT) positive blast cells in the thymus, which was also effaced and enlarged (e.g., markers of ALL, See FIG. 3f). Two distinct blast populations were present in the bone marrow of this mouse (See FIG. 3h), one expressing myeloid antigens and another expressing lymphoid markers (See FIG. 3i). More extensive analysis revealed that the myeloid blasts were Mac-1⁺ Gr-1^{low} CD4⁻ (e.g., consistent with AML), and the lymphoid blasts were CD4⁺ CD8⁺ CD3⁺ Mac-1⁻ (e.g., consistent with ALL). Although only a minority of Pten^{fl/fl} Mx-1-Cre mice showed large blast cell populations within days of pIpC treatment, the proportion of mice that showed these signs of AML and/or ALL increased with time after Pten deletion. The criteria used to diagnose myeloproliferative disease, AML and ALL, are shown in Table 1, below.

TABLE 1

| | Gross and Laboratory | | |
|---|---|---|---|
| | Features | Morphology | Ancillary Studies |
| Myeloproliferative | Enlarged spleen with | H&E sections showing partial or | Immature mononuclear |
| disease | increased weight | subtotal effacement of splenic | cells show evidence of |
| | relative to animal body | architecture by myeloid predominant | myeloid differentiation |
| | weight. No | EMH. Myelopoiesis shifted toward | by virtue of |
| | lymphadenopathy or | immaturity (“left shift”) with | cytoplasmic granularity |
| | thymic enlargement. | increased number of mononuclear | in Wright-stained |
| | Increased peripheral | cells and persistent maturation to | cytospin smears, |
| | blood counts with rare | segmented neutrophils. Several foci of | chloroacetate esterase |
| | circulating blasts | myeloid predominant EMH in | (Leder) positivity in |
| | (variable finding). | liver. Fewer than 20% blasts in | formalin-fixed tissue |
| | Variable behavior, but | spleen, bone marrow, or peripheral | sections, and/or |
| | non-aggressive | blood. Absence of convincing | myeloid antigen |
| | (compared to acute | dysplasia in cytospin and peripheral | expression by flow |
| | myeloid leukemia). | blood smears. | cytometry. |
| Acute myeloid | Enlarged spleen with | H&E sections showing | Immature mononuclear |
| leukemia | increased weight | monomorphous sheets or large | cells show evidence of |
| | relative to animal | clusters of immature mononuclear | myeloid differentiation |
| | weight. No | cells, with or without persistent | by virtue of |
| | lymphadenopathy or | myeloid maturation and admixed | cytoplasmic granularity |
| | thymic enlargement. | erythroid precursors and | in Wright-stained |
| | Variable peripheral | megakaryocytes, often resulting in | cytospin smears, |
| | blood counts, usually | complete or subtotal effacement of | chloroacetate esterase |
| | with at least one | splenic architecture (including loss of | (Leder) positivity in |
| | cytopenia and variable | white pulp). Dissemination to liver | formalin-fixed tissue |
| | number of circulating | with clusters of immature | sections, and/or |
| | blasts. Aggressive | mononuclear cells with evidence of | myeloid antigen |
| | behavior. | myeloid differentiation in a | expression by flow |
| | Transplantable to | perivascular, periportal, parenchymal, | cytometry. |
| | recipient mice. | or sinusoidal distribution. | |
| | | Alternatively, greater than 20% blasts | |
| | | in Wright-stained cytospin smears of | |
| | | spleen or bone marrow. | |
| | | Lymphocytes excluded from spleen | |
| | | blast counts. | |
| Precursor T-cell | Markedly enlarged | H&E sections show complete | Evidence of T-cell |
| acute | thymus with either | effacement of thymus by malignant | lineage documented by |
| lymphoblastic | local or generalized | infiltrate composed of intermediate- | flow cytometry and |
| leukemia | lymphadenopathy. | to-large mononuclear cells. Complete | immaturity confirmed |
| | Increased spleen and | or subtotal effacement of spleen by | by either dual expression |
| | liver size (due to | similar infiltrate. Minimal or | of CD4 and |
| | dissemination). | displaced extramedullary | CD8 by flow cytometry |
| | Variable peripheral | hematopoiesis in spleen. | or nuclear terminal |
| | blood counts, usually | Alternatively, greater than 20% blasts | deoxynucleotidyl |
| | with at least one | in Wright-stained cytospin smears of | transferase (TdT) |
| | cytopenia and variable | spleen or bone marrow. | positivity by tissue |
| | number of circulating | | section |
| | blasts. Aggressive | | immunohistochemistry. |
| | behavior. | | |

### Example 3

### Pten-Deficient Neoplasms are Transplantable

To test whether the neoplasms in Pten^{fl/fl} Mx-1-Cre mice were transplantable, whole bone marrow cells, whole splenocytes, Flk-2⁻Sca-1⁺Lin⁻CD48⁻ckit⁺ HSCs (See, e.g., Christensen and Weissman, Proc Natl Acad Sci USA 98, 14541-6 (2001); Kiel et al., Cell 121, 1109-21 (2005); Yilmaz et al., Blood (2005)), Mac-1⁺B220⁻CD3⁻myeloid cells, or CD3⁺Mac-1⁻/B220⁺Mac-1⁻ lymphoid cells were isolated from 3 independent^{fl/fl} Mx-1-Cre donor mice that were euthanized due to illness. The CD45.2⁺ donor cells were transplanted into irradiated CD45.1⁺ recipient mice along with 200,000 recipient (CD45.1⁺) whole bone marrow cells. Every recipient of 2×10⁶ Pten^{fl/fl} Mx-1-Cre donor bone marrow cells (See FIG. 5a) or splenocytes (See FIG. 5c) died within four weeks of transplantation (e.g., exhibiting AML and often exhibiting ALL as well). In contrast, only a minority of the recipients of 3×10⁵ donor bone marrow cells died, with 2 of 14 exhibiting AML and another 2 of 14 exhibiting ALL (all died 12 to 16 weeks after transplantation; See FIG. 5b). Thus, the present invention demonstrates that AML-initiating cells and ALL-initiating cells in Pten-deficient bone marrow are rare, providing that, in some embodiments, a secondary mutation causes rare Pten-deficient cells to progress beyond myeloproliferative disease to AML or ALL. Recipients of bone marrow cells (n=20), splenocytes (n=7), or HSCs (n=17) from Pten^{fl/+} Mx-1-Cre control mice did not exhibit hematopoietic malignancies.

To test whether the leukemia initiating cells co-purify with HSCs, 10 to 15 Pten^{fl/fl} Mx-1-Cre Flk-2⁻Sca-1⁺Lin⁻CD48⁻ckit⁺ cells were transplanted into irradiated recipient mice. Flk-2⁻Sca-1⁺Lin⁻CD48⁻ckit⁺ cells represent only 0.005% of bone marrow cells and are highly enriched for HSC activity (See, e.g., Christensen and Weissman, Proc Natl Acad Sci USA 98, 14541-6 (2001); Kiel et al., Cell 121, 1109-21 (2005); Yilmaz et al., Blood (2005)). Out of 25 such transplants, no recipients developed ALL or myeloproliferative disease and only 4 of the recipients developed AML (these mice died within 4 weeks after transplantation; See FIG. 5d). Based on limit dilution statistics (See, e.g., Smith et al., Proc Natl Acad Sci USA 88, 2788-92 (1991), the present invention provides that 1 out of every 93 cells in this population was capable of initiating AML. Thus, AML-initiating cells were enriched within the HSC population, though the vast majority of these cells (92/93=99%) were not capable of transferring disease and ALL-initiating cells did not appear to co-purify with HSCs.

To test whether other cell populations were also capable of transferring disease, Mac-+1⁺B220⁻CD3⁻ myeloid cells or CD3⁺Mac-1⁻/B220⁺Mac-1⁻ lymphoid cells were transplanted. Recipients of myeloid cells sometimes died with AML (2/9) by 4 weeks after transplantation, or AML and ALL (2/9) by 9 weeks after transplantation (See FIG. 5e). Recipients of lymphoid cells sometimes died with both AML and ALL (3/7) within 4 to 9 weeks after transplantation (See FIG. 3f). In all cases, the leukemic cells in recipient mice were of donor (CD45.2⁺) origin. AML-initiating and ALL-initiating cells appeared to be enriched within these populations expressing mature myeloid and lymphoid markers, as compared to whole bone marrow. Thus, a variety of Pten-deficient cell populations are capable of transplanting leukemias to recipient mice, though recipients of cells expressing mature myeloid or lymphoid markers may sometimes develop disease more slowly than recipients of cells that expressed HSC markers.

### Example 4

### HSCs Proliferate after Pten Deletion, then Become Depleted

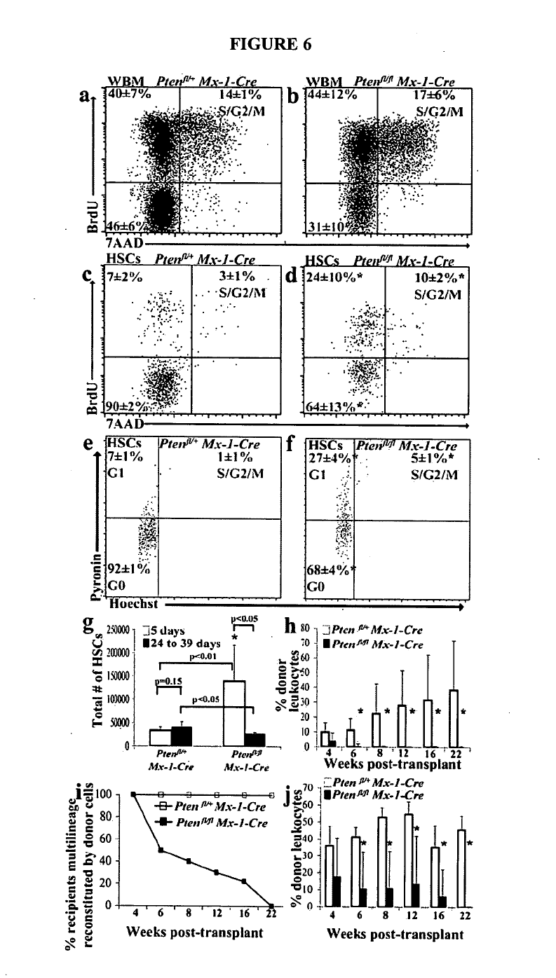

Five days after completing pIpC administration the cell cycle status of whole bone marrow cells and HSCs was examined. There was no significant effect of Pten deletion on the cell cycle distribution of whole bone marrow cells (See FIGS. 6a and 6b). In contrast, there was a 3 to 4-fold increase in the percentage of Flk-2⁻Sca-1⁺Lin⁻CD48⁻ckit⁺ HSCs in S/G2/M phase of the cell cycle, and in the percentage that incorporated the nucleotide analogue BrdU over a 19 hour period (See FIGS. 6c and 6d). Consistent with this, there was a significant decline in the frequency of Flk-2⁻Sca-1⁺Lin⁻CD48⁻ckit⁺ HSCs in G0 phase of the cell cycle and a 4-fold increase in the frequency of cells in G1 phase of the cell cycle after Pten deletion (See FIG. 6e and 6f). These data provide that Pten promotes quiescence in HSCs, and that in the absence of Pten HSCs are driven into cycle.

Consistent with the proliferation of HSCs after Pten deletion, the absolute number of Flk-2⁻Sca-1⁺Lin⁻CD48⁻ckit⁺ HSCs per Pten^{fl/fl} Mx-1-Cre mouse increased by approximately 3-fold within 5 days of pIpC treatment (See FIG. 6g). The number of Flk-2⁻Sca-1⁺Lin⁻CD48⁻ckit⁺ cells per mouse was calculated based on the observed frequency of this population and overall cellularity in the spleen and long bones, and by assuming that 15% of all bone marrow is contained within the long bones (See, e.g., Smith and Clayton, Experimental Hematology 20, 82-86 (1970)). In wild-type mice the blood and other tissues do not contribute significantly to the overall size of the HSC pool. Interestingly, when Pten^{fl/fl} Mx-1-Cre mice were examined 24 to 39 days after pIpC treatment, the number of Flk-2⁻Sca-1⁺Lin⁻CD48⁻c-kit⁺ cells in the spleen and bone marrow declined significantly, and became significantly less numerous than in Pten^{fl/+}Mx-1-Cre control mice (See FIG. 6g). Thus, the present invention provides that HSCs transiently expanded in number after Pten deletion, but were unable to maintain themselves and became depleted.

In order to test the function of Pten-deficient HSCs, 15 donor-type Flk2⁻Sca-1⁺Lineage⁻c-kit⁺ CD48 HSCs from Pten^{fl/fl} Mx-1-Cre mice or littermate controls (5 days after pIpC treatment) were transplanted into irradiated recipient mice along with 200,000 recipient-type bone marrow cells (See FIG. 6h). Whereas control cells gave high levels of multilineage reconstitution in all recipients, Pten-deficient cells initially gave multilineage reconstitution at 4 to 6 weeks after transplantation but by 8 weeks after transplantation none of the recipients were multilineage reconstituted and none of these recipients developed AML or ALL. Similar results were observed when 300,000 donor-type bone marrow cells from Pten^{fl/fl} Mx-1-Cre mice or littermate controls were transplanted into irradiated recipients along with 200,000 recipient-type bone marrow cells. Whereas all recipients of control cells became long-term multilineage reconstituted (See FIG. 6i) with high levels of donor cells (See FIG. 6j), the percentage of recipients that were multilineage reconstituted and the levels of reconstitution in recipients of Pten^{fl/fl} Mx-1-Cre cells declined over time. These results demonstrate that Pten deficient HSCs are initially capable of multilineage reconstituting irradiated mice, but they are unable to maintain themselves over the long-term. Nonetheless, 3 out of 10 recipients of Pten^{fl/fl} Mx-1-Cre bone marrow cells died between 12 and 16 weeks after transplantation with AML or ALL.

### Example 5

### Pten is Required Cell-Autonomously for HSC Maintenance

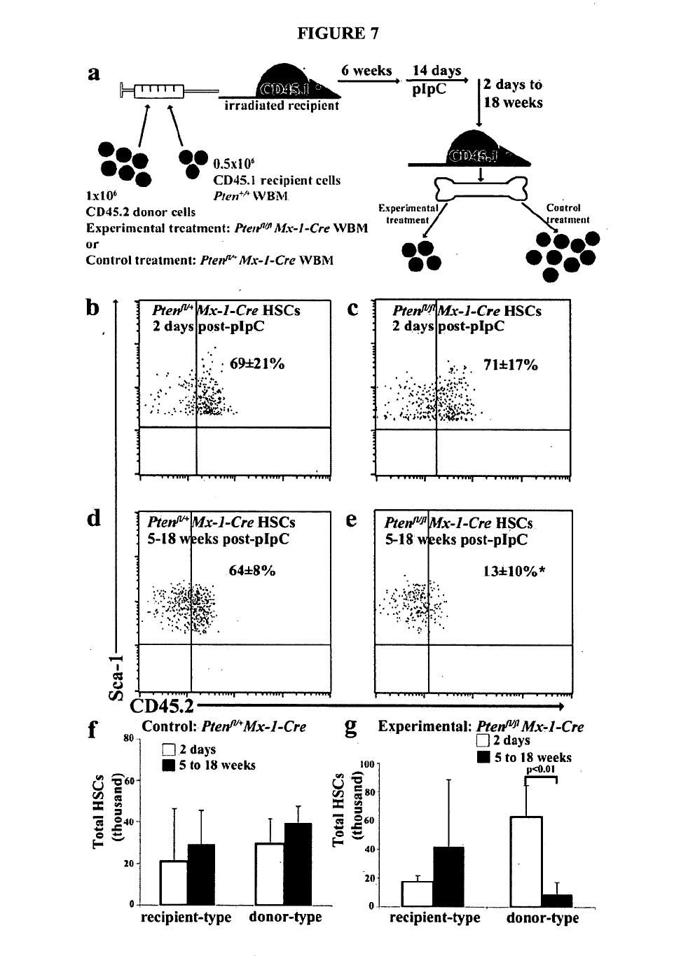

It remained possible that a few days exposure to the myeloproliferative disease in donor mice might have irreversibly damaged the Pten-deficient HSCs prior to transplantation. To test whether the depletion of HSCs in Pten^{fl/fl}Mx-1-Cre mice was an indirect consequence of neoplasms/altered hematopoietic environment, or whether Pten is cell-autonomously required for the maintenance of HSCs, Pten^{fl/fl} Mx-1-Cre bone marrow cells or control bone marrow cells (both CD45.2⁺) were transplanted into recipient mice (CD45.1⁺) along with half as many recipient bone marrow cells (FIG. 7a). Six weeks after transplantation when these mice exhibited stable chimerism Pten was deleted and the relative frequencies of donor and recipient HSCs were monitored over time. Two days after pIpC treatment donor cells accounted for roughly two thirds of HSCs in the bone marrow irrespective of whether they were control (FIG. 7b) or Pten-deficient (FIG. 7c).

Consistent with a cell-autonomous requirement for Pten in HSCs, the number of Pten-deficient HSCs declined over time and the number of wild-type recipient HSCs in the same mice increased. By 5 to 20 weeks after pIpC administration, control donor cells still accounted for 64% of bone marrow Flk2⁻Sca-1⁺Lin⁻c-kit⁺CD48⁻ cells (FIG. 7d), but Pten^{fl/fl}Mx-1-Cre donor cells accounted for only 15% of bone marrow Flk2⁻Sca-1⁺Lin⁻c-kit⁺CD48⁻ cells (FIG. 7e; *, p<0.05). The total number of control donor HSCs was stable over time (FIG. 7f). In contrast Pten^{fl/fl}Mx-1-Cre donor HSCs initially dominated the HSC pool, but by 5 to 20 weeks after pIpC treatment recipient HSCs outnumbered Pten-deficient donor HSCs by 6.4-fold (FIG. 7g). To functionally confirm the depletion of donor HSCs 106 bone marrow cells or 100 Flk2⁻Sca-1⁺Lin⁻c-kit⁺CD48⁻ cells were transplanted into irradiated mice. All recipients of bone marrow cells from control mice (from FIG. 7d) became long-term multilineage reconstituted by donor cells. However, recipients of Pten-deficient donor (from FIG. 7e) bone marrow cells or Flk2⁻Sca-1⁺Lin⁻c-kit⁺CD48⁻ cells never exhibited multilineage donor cell reconstitution. Since Pten-deficient HSCs were depleted while control HSCs expanded within the same mice, the present invention provides that Pten is required cell-autonomously for the maintenance of HSCs.

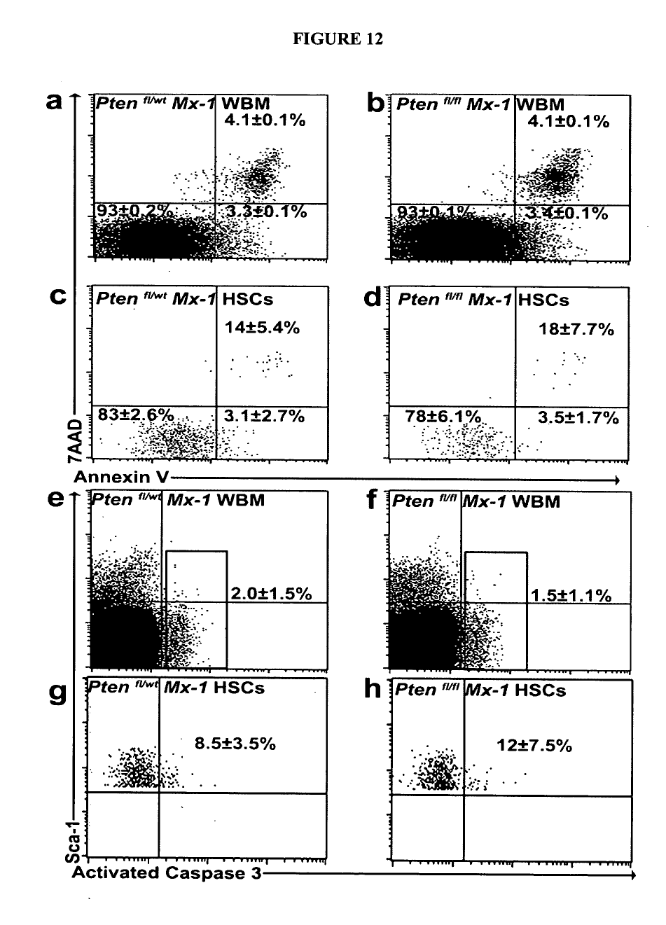

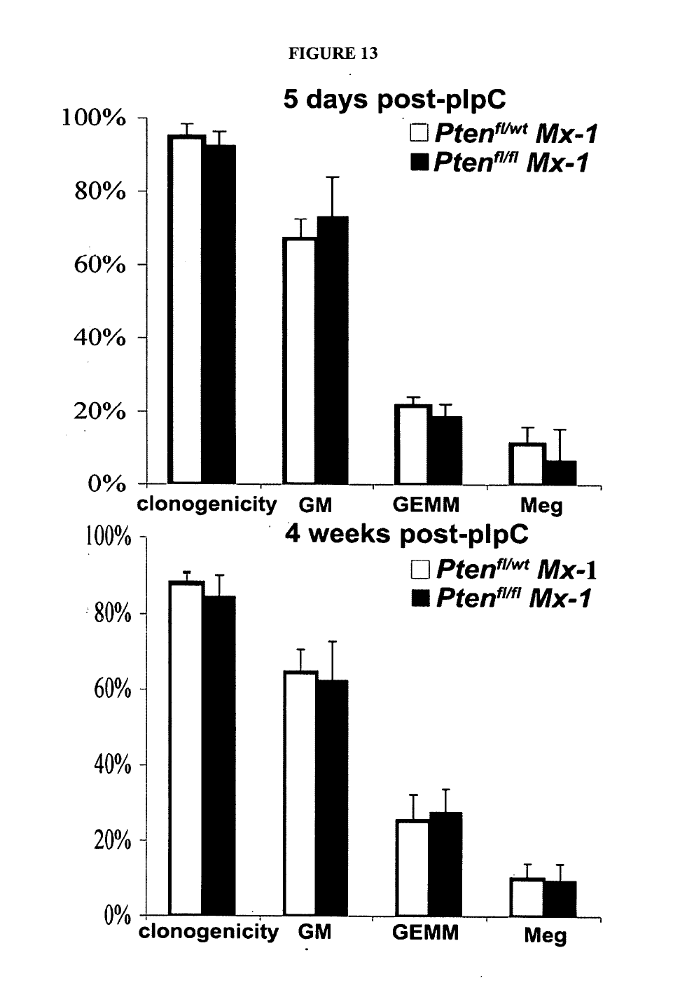

Pten deletion appeared to deplete HSCs by inhibiting self-renewal rather than by promoting cell death. An increase in cell death by Annexin V or activated caspase-3 staining was not detected in either whole bone marrow cells or Flk2⁻Sca-1⁺Lin⁻c-kit⁺CD48⁻ cells from Pten^{fl/fl}Mx-1-Cre mice four weeks after pIpC treatment (FIG. 12). Moreover, approximately 90% of single Flk2⁻Sca-1⁺Lin⁻c-kit⁺CD48⁻ cells from either Pten-deleted mice or control mice formed colonies in methylcellulose whether they were isolated 5 days or 4 weeks after pIpC treatment (FIG. 13). If HSCs were destined to undergo cell death or rapid terminal differentiation after Pten deletion then Flk2⁻Sca-1⁺Lin⁻c-kit⁺CD48⁻ cells from Pten-deleted mice should have formed fewer colonies in methylcellulose. Along with the ability of Pten-deficient HSCs to efficiently engraft and transiently reconstitute irradiated mice, the present invention provides that HSCs exhibit less self-renewal potential after Pten deletion.

### Example 6

### Rapamycin Depletes Leukemia-Initiating Cells

The observation that Pten deletion leads to the depletion of normal HSCs while promoting the generation of leukemia-initiating cells provides a rare distinction between the mechanisms that regulate the maintenance of normal stem cells as compared to leukemia-initiating cells. The PI-3 kinase pathway is highly branched, but activates the mammalian Target of rapamycin (mTor) among other downstream effectors (See, e.g., Majumder et al., Nat Med 10, 594-601 (2004); Inoki et al., Nat Genet 37, 19-24 (2005)). mTor kinase activity is inhibited by the drug rapamycin (See, e.g., Podsypanina et al., Proc Natl Acad Sci USA 98, 10320-5 (2001); Neshat et al., Proc Natl Acad Sci USA 98, 10314-9 (2001)) and human AML and ALL cells are sensitive to rapamycin (See, e.g., Recher, et al. Blood 105, 2527-34 (2005); Avellino, et al. Blood 106, 1400-6 (2005); Teachey, et al. Blood 107, 1149-55 (2006)). Thus, rapamycin was administered to Pten^{fl/fl}Mx-1-Cre mice to test whether it depleted leukemia-initiating cells or rescued normal HSC function.

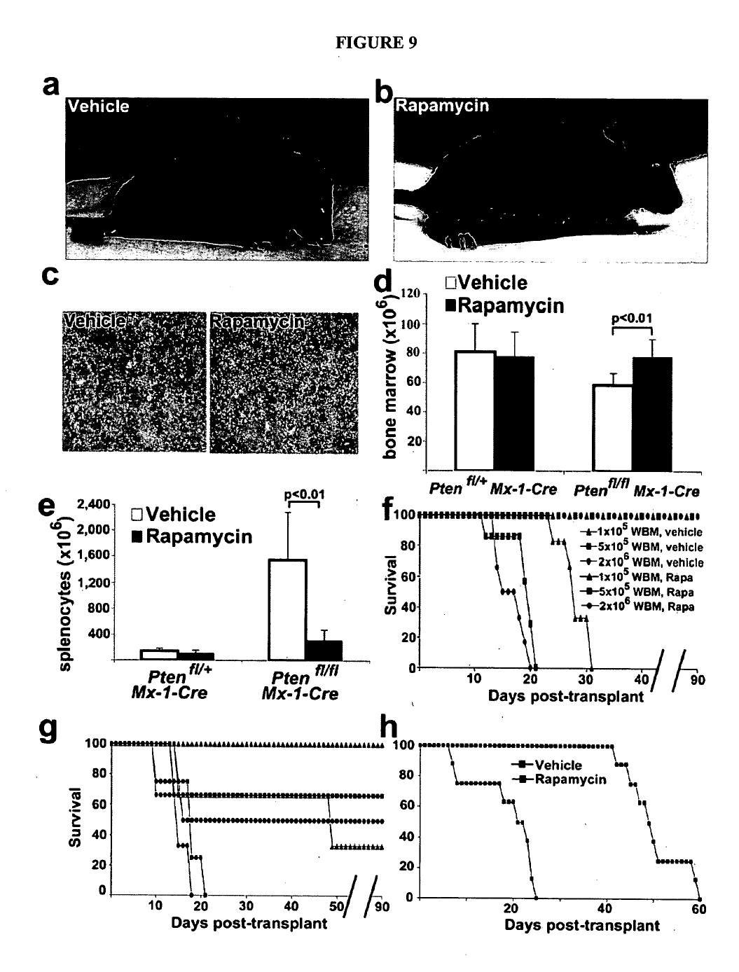

Pten^{fl/fl} Mx-1-Cre mice became overtly ill after pIpC treatment as they developed leukemias, exhibiting lethargy, ruffling of fur, and hunched posture (FIG. 9a). All 3 such mice in this experiment died within 3-4 weeks of pIpC treatment, with AML and ALL (FIG. 9c). In contrast, three mice that were maintained on daily injections of 4 mg/kg rapamycin remained healthy and active 4 weeks after pIpC treatment (FIG. 9b). These rapamycin-treated mice did not show even histological evidence of neoplasm, as the spleens had normal architecture, with only focal areas of erythroid predominant hematopoiesis (FIG. 9c). Daily injections of rapamycin for 7 days after pIpC treatment also prevented the decrease in bone marrow cellularity (FIG. 9d) and the increase in spleen cellularity (FIG. 9e) observed in Pten^{fl/fl}Mx-1-Cre mice, without significantly affecting these parameters in control mice. Mice maintained on rapamycin immediately after Pten deletion therefore did not develop signs of hematopoietic malignancy.

To determine whether rapamycin eliminated leukemia-initiating cells, Pten-deleted mice were treated with vehicle or rapamycin for 6 weeks and then graded doses of whole bone marrow cells were transplanted into irradiated mice (that no longer received rapamycin). Recipients of bone marrow cells from vehicle-treated mice all died in a dose dependent manner within 20 to 31 days of transplantation (FIG. 9f). In contrast, recipients of bone marrow from rapamycin-treated mice remained healthy and never exhibited signs of leukemia, irrespective of the dose of cells transplanted (FIG. 9f). Thus, the present invention demonstrates that rapamycin inhibits the generation or maintenance of leukemia-initiating cells.

To test if rapamycin was effective against established leukemias, mice that had been transplanted with Pten^{fl/fl} Mx-1-Cre bone marrow cells were treated with daily injections of vehicle or rapamycin, beginning 15 weeks after pIpC. While all 3 vehicle-treated mice died with ALL and/or AML within 5 weeks, all 3 rapamycin-treated mice remained overtly healthy (See Table 2).

TABLE 2

| | mice sacrificed, | Pathology | Bone marrow |
|---|---|---|---|
| | weeks after | when | HSCs that were |
| Treatment | stopping pIpC | sacrificed | donor type |
| Vehicle | 15 weeks | AML and ALL | 14% |
| | 18 weeks | AML and ALL | 28% |
| | 20 weeks | AML | 15% |
| | | average | 19 ± 8% |
| Rapamycin | 20 weeks | MPD | 35% |
| | 30 weeks | MPD | 45% |
| | 30 weeks | AML and ALL | 36% |
| | | average | 39 ± 6% |

Mice that had been transplanted with 1×10⁶ Pten^{fl/fl} Mx-1-Cre donor (CD45.2⁺) bone marrow cells along with 0.5×10⁶ control (CD45.1⁺) bone marrow cells were treated with daily injections of vehicle or rapamycin (4 mg/kg), starting 15 weeks after pIpC treatment. Recipients that were not treated with rapamycin became severely ill by 20 weeks after stopping pIpC and exhibited AML and ALL. In contrast, recipients that received rapamycin remained healthy in appearance, though pathological analysis after sacrifice revealed that one of the mice had AML and ALL (though the spleen was not enlarged) and two mice had myeloproliferative disease. The frequency of Pten-deficient donor HSCs was significantly (p<0.05) higher in the mice treated with rapamycin. This indicates that rapamycin is only partially effective in treating leukemia and rescuing HSCs when initiated after the onset of leukemia, weeks after pIpC treatment.

Almost all recipients of bone marrow cells from a vehicle-treated mouse died in a dose dependent manner (FIG. 9g). In contrast, most recipients of bone marrow cells from rapamycin-treated mice survived (FIG. 9g). Rapamycin thus reduced the frequency of leukemia-initiating cells even when treatment was initiated after the onset of frank leukemia. The two rapamycin-treated mice that were not sacrificed for transplantation were treated with daily injections of rapamycin for 15 weeks. Although these mice appeared overtly healthy, with normal size spleens and thymuses, one exhibited histologic evidence of myeloproliferative disease and the other showed signs of AML and ALL.

Rapamycin treatment was also initiated after the transplantation of 2×10⁶ bone marrow cells from a Pten-deficient mouse with AML and ALL into irradiated recipients. Vehicle-treated recipients all died within 25 days of transplantation (FIG. 9h). In contrast, rapamycin-treated recipients died 40 to 60 days after transplantation (FIG. 9h). When initiated after the onset of leukemia, rapamycin was effective in prolonging the life of mice.

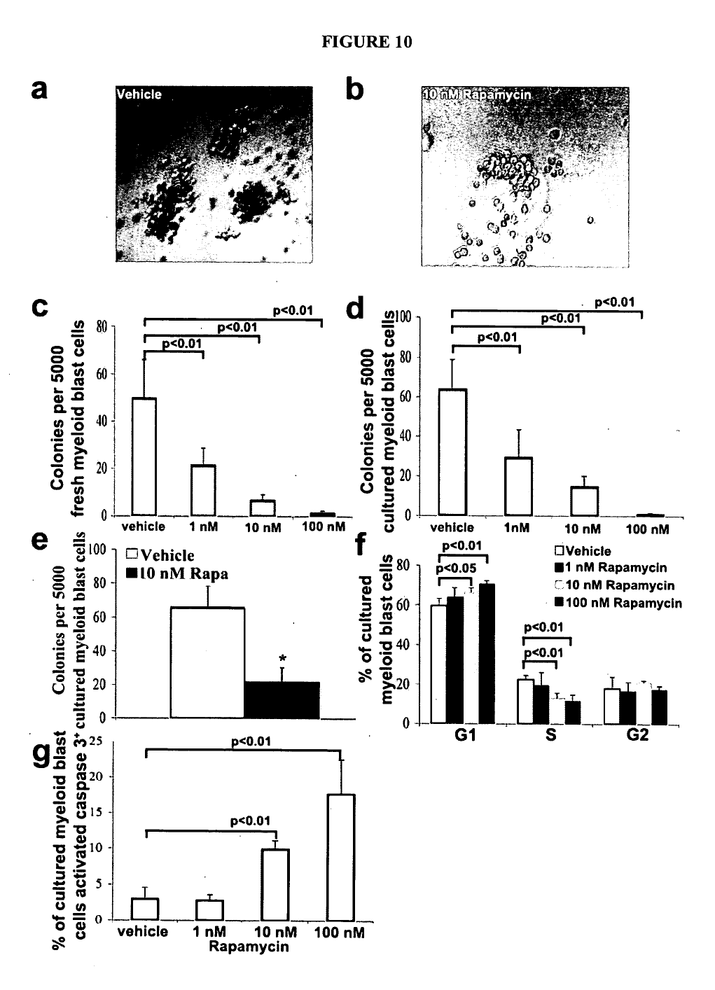

Rapamycin inhibited the survival and proliferation of clonogenic leukemia cells in culture. Freshly isolated or cultured myeloid blast cells from Pten^{fl/fl}Mx-1-Cre mice with AML were sorted into methylcellulose. Rapamycin significantly reduced the percentage of blast cells that formed colonies as well as colony size in a dose-dependent manner (FIGS. 10a-10e). Rapamycin also significantly reduced the percentage of myeloid blasts in S phase of the cell cycle and increased the percentage of cells expressing activated caspase-3 (FIGS. 10f and 10g).

Freshly isolated CD45^{hi}Mac-1⁺CD4^{-/flow} myeloid blasts (FIGS. 10a, 10b, and 10c) and cultured myeloid blasts (FIG. 10d) from Pten^{fl/fl} Mx-1-Cre mice with AML were sorted into complete methylcellulose medium with increasing concentrations of rapamycin (vehicle, 1, 10, and 100 nM). Colonies that contained at least 5 cells were counted after 14 days in culture. Rapamycin inhibited the formation of myeloid blast cell colonies from both freshly isolated (FIG. 10c; all error bars represent standard deviation) and cultured samples (FIG. 10d) in a dose-dependent manner. Myeloid blast cells were also capable of forming colonies in minimal medium (methylcellulose that contained only 0.1% fetal bovine serum and 1% N2 supplement, and no other growth factors), and rapamycin also significantly (p<0.01) inhibited colony formation in this medium (FIG. 10e). Exposure of myeloid blast cells to rapamycin for only 24 hours in liquid culture significantly decreased the frequency of blast cells in S phase of the cell cycle (FIG. 10f). Activated caspase-3 staining, assessed by flow cytometry, increased in a dose-dependent manner in AML blasts that were cultured in the presence of rapamycin for 24 hours (n=3). Thus, rapamycin inhibited the survival and the proliferation of leukemic blast cells.

In some embodiments, the present invention provides methods whereby the presence of or amount of HSCs and/or leukemia cells is assessed prior to, during, or following treatment of a subject (e.g., an animal) with rapamycin or other compounds (e.g., other compounds that influence mTor kinase activity or related pathways; co-administered anti-cancer compounds; etc.). In some embodiments, rapamycin or related compounds are co-administered with another cancer therapy or intervention (e.g., leukemia therapies (e.g., autologous stem cell transplant, chemotherapy (e.g., fractionated dose chemotherapy), allogeneic bone marrow transplant, antibody therapy (e.g., Gemtuzumab ozogamicin (GO; Mylotarg, Wyeth-Ayerst, St Davids, Pa.))), radiation, surgery, etc).

### Example 7

### Rapamycin Rescues Pten Deficient HSCs

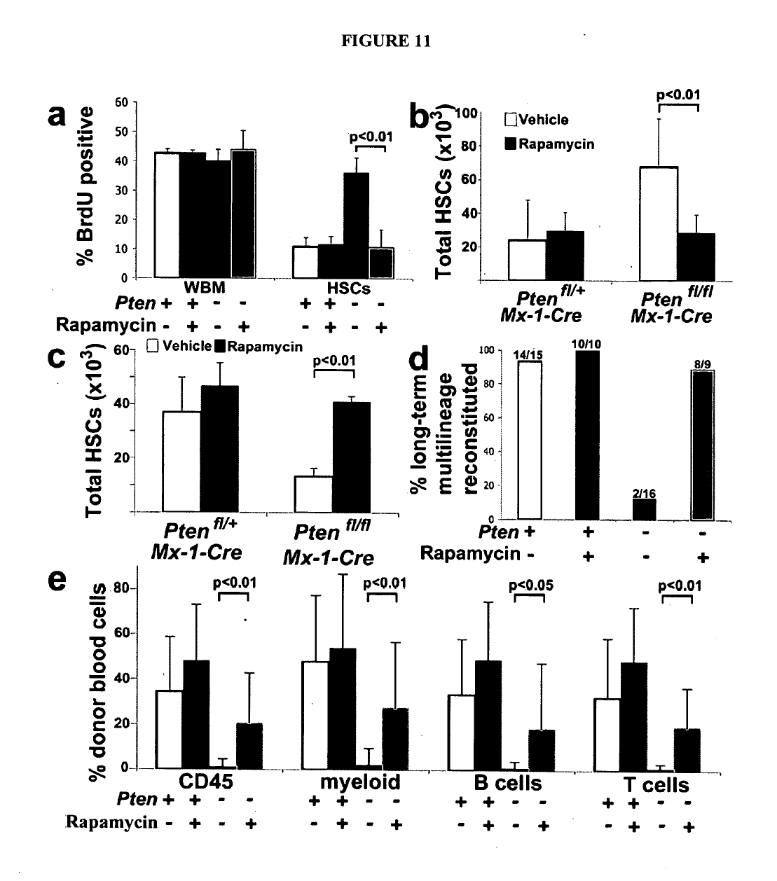

Rapamycin also restored the capacity of Pten-deficient HSCs to long-term multilineage reconstitute irradiated mice. Daily injections of rapamycin for 7 days after pIpC administration did not affect the overall rate of proliferation in bone marrow but did normalize the cell cycle distribution of Flk2⁻Sca-1⁺Lin⁻c-kit⁺CD48⁻ cells in Pten^{fl/fl}Mx-1-Cre mice, without affecting the proliferation of HSCs from control littermates (FIG. 11a). Rapamycin also eliminated the HSC expansion observed 7 days after pIpC treatment (FIG. 11b) and the HSC depletion observed after 4 weeks in Pten^{fl/fl}Mx-1-Cre mice (FIG. 11c), without affecting HSC numbers in control mice. Importantly, rapamycin restored the long-term multilineage reconstituting potential of Flk2⁻Sca-1⁺Lin⁻c-kit⁺CD48⁻ cells isolated from Pten^{fl/fl}Mx-1-Cre mice 7 days after pIpC treatment (FIG. 11d and 11e). This confirms that Flk2⁻Sca-1⁺Lin⁻c-kit⁺CD48⁻ cells from Pten^{fl/fl}Mx-1-Cre mice are HSCs and that rapamycin restores normal function to these cells. Thus, the present invention provides that compounds that promote stem cell quiescence have different effects on normal stem cells and cancer stem cells. Furthermore, by comparing the mechanisms that regulate the maintenance of normal stem cells and cancer stem cells, the present invention provides methods to identify and to design new therapies and to more effectively use existing therapies to treat cancer.

All publications and patents mentioned in the above specification are herein incorporated by reference. Various modifications and variations of the described compositions and methods of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the present invention.

What is claimed is:

1. A method of identifying a test compound useful for treating cancer comprising:
a) providing cancer cells and normal stem cells;
b) administering said test compound to said cancer cells and normal stem cells;
c) monitoring the response of said cells to said test compound; and
d) identifying a test compound that alters said cancer cells without harming said normal stem cells.

2. The method of claim 1, wherein altering said cancer cells comprises inhibiting proliferation of said cancer cells.

3. The method of claim 1, wherein altering said cancer cells comprises inhibiting survival of said cancer cells.

4. The method of claim 1, wherein said monitoring the response of said cells is selected from the group consisting of monitoring the proliferation of said cells; monitoring the survival of said cells; monitoring the cell cycle status of said cells; monitoring gene expression in said cells; monitoring protein expression and/or activity in said cells; and monitoring cellular pathways.

5. The method of claim 4, wherein said monitoring gene expression identifies a cancer stem cell biomarker.

6. The method of claim 4, wherein said monitoring gene expression comprises use of a microarray.

7. The method of claim 4, wherein said monitoring gene expression comprises measuring mRNA.

8. The method of claim 4, wherein said monitoring cellular pathways comprises measuring the activity of said pathways.

9. The method of claim 1, wherein said cancer cells are tumorigenic cancer cells.

10. The method of claim 1, wherein said cancer cells are leukemogenic cancer cells.

11. The method of claim 1, wherein said cancer cells are cancer stem cells.

12. The method of claim 1, wherein said test compound is selected from a test compound library comprising a plurality of test compounds.

13. The method of claim 12, wherein said test compound library is selected from a test compound library comprising carbohydrates, monosaccharides, oligosaccharides, polysaccharides, amino acids, peptides, oligopeptides, polypeptides, proteins, nucleosides, nucleotides, oligonucleotides, polynucleotides, lipids, retinoids, drugs, antibodies, prodrugs, steroids, glycopeptides, glycoproteins, proteoglycans, and synthetic small molecule organic compounds.

14. The method of claim 1, wherein said cancer cells and said normal stem cells are present within the same tissue.

15. A method of identifying a test compound useful for treating cancer comprising:
a) providing cancer stem cells and normal stem cells;
b) administering said test compound to said cancer stem cells and normal stem cells;
c) monitoring the response of said cells to said test compound; and
d) identifying a test compound that alters cancer stem cells without harming normal stem cells.

16. A method of identifying a test compound useful for treating cancer comprising:
a) providing normal adult stem cells;
b) administering said test compound to said normal adult stem cells;
c) monitoring the response of said cells to said test compound; and
d) identifying a test compound that inhibits the ability of said adult stem cells to exit G0 phase of the cell cycle.

17. The method of claim 16, wherein said test compound also inhibits the proliferation and/or survival of cancer stem cells.

18. The method of claim 16, wherein said test compound inhibits signaling through a mitogenic pathway

19. The method of claim 16, wherein said test compound inhibits signaling through the PI-3 kinase pathway.

20. The method of claim 16, wherein said test compound inhibits signaling by mTor.

21. The method of claim 16, wherein said test compound is rapamycin or a rapmycin analogue.
